(19) United States
(12) Patent Application Publication
(10) Pub. No.: US 2012/0005273 A1
(43) Pub. Date: Jan. 5, 2012

(54) SYSTEM, METHOD, COMPUTER PROGRAM PRODUCTS, STANDARDS, SOA INFRASTRUCTURE, SEARCH ALGORITHM AND A BUSINESS METHOD TEHREOF FOR AI ENABLED INFORMATION COMMUNICATION AND COMPUTATION (ICC) FRAMEWORK (NEWALTER) OPERATED BY NETALTER OPERATING SYSTEM (NOS) IN TERMS OF NETALTER SERVICE BROWSER (NSB) TO DEVICE ALTERNATIVE TO INTERNET AND ENTERPRISE & SOCIAL COMMUNICATION FRAMEWORK ENGROSSING UNIVERSALLY DISTRIBUTED GRID SUPERCOMPUTING AND PEER TO PEER FRAMEWORK

(75) Inventors: Yogesh Chunilal RATHOD, Mumbai (IN); Rajesh Chunilal Rathod, Mumbai (IN)

(73) Assignee: NETALTER SOFTWARE LIMITED, Mumbai (IN)

(21) Appl. No.: 13/229,471

(22) Filed: Sep. 9, 2011

Related U.S. Application Data
(63) Continuation of application No. 11/171,520, filed on Jul. 1, 2005.

(30) Foreign Application Priority Data
Nov. 30, 2004 (IN) 1279/MUM/20004

(51) Int. Cl. G06F 15/16

(52) U.S. Cl. 709/204

(57) ABSTRACT

A communication system, method and standards for convergence solution to prevailing communication technologies & concepts includes rich client enabled, service oriented distributed information computation and communication (ICC) framework. The distributed network comprises of plurality of clients at specified level of operation in the framework architecture essentially following TFHL networking standards for secured information management identified as NetAlter framework and said distributed framework (NetAlter) comprising of the Service Browser Application for accessing the ICC framework contents in plurality of ways including peer to peer, offline, online etc. irrespective of operating system in use and location parameter. The business method under proposition thereof is essentially based on the browser software following the clustering logic involved therein comprising the explorer for administrative functions and information management assuring secure, piracy free and faster application for communication which forms computational grid wherein connected member to utilize the frameworks' computational resources to the supercomputing extent.

### CROSS-REFERENCE TO RELATED APPLICATIONS

This application is a continuation of U.S. patent application Ser. No. 11/171,520, filed on Jul. 1, 2005, which claims priority from Indian Provisional Application No. 1279/MUM/2004, filed on Nov. 30, 2004, the disclosure of both of which applications are incorporated herein in its entirety by reference.

### COPYRIGHTS INFORMATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention relates to system and method for universal distributed information computation & communication and more specifically to the service browser application, SOA infrastructure, internet alternate, grid computing infrastructure, peer to peer communication, search algorithm, internet wide operating system, application management, developers development platform and an on demand application, information, service & computing resources and its method of implementation.

### BACKGROUND OF THE INVENTION

The rapid growth in information technology and the emergence of the Internet and World Wide Web over the last several years have changed the ways and means of communication in broader aspect. At present there are world over around 815 million internet users enjoying services of internet framework and increasing at the rate of 125% a year. On the retrospective & rational viewpoint internet is another kind of communication framework wherein information is made available at the user terminal by means of browser software and sources from any of the connected server in the framework traced successfully by means of DNS servers, routers and similar other technologically advance electronic intelligent gadgets. Thus, internet framework essentially follows highly technically equipped rather unorganized kind of client server model.

The Internet was designed to hold smaller networks together, turning then into one big network. The major limitations with internet framework is disability at user end to cross check the accuracy, currency, authority, reliability, objectivity and truthfulness of its contents. Further virus and spamming attacks to the connected network users put users at risk making internet itself a hazardous product being offered to users violating all laws with customers' been privileged with. Likewise, IPR being meant for protection tool to inventor, via internet IP that worth billions of dollars is infringed in terms of copyright infringement and circulation of the same into the grey market hosted online, causing piracy of product that has come out of intellect of inventor, demeaning of the respect towards science and creativity.

This enormous growth of internet till date has generated around 60 to 100 billion of publicly available web pages all over the world to search for and simultaneously another estimated 20 billion intranet pages to that matter. Using this mean of internet framework huge amount of information is being thrown on the servers in roughly unorganized manner.

Plurality of search engines have been designed to Similarly to track and find out desired information hosted at plurality of internet servers wherein Google do manage to index at the most around 8.0 billion web pages which means 60% of web contents are not searchable by this means.

Unfortunately, end users are often overwhelmed. They spend most of their time searching, navigating & sorting through the data, spending less time interpreting, and even less time actually doing something about what they find.

To curtail above stated shortcoming of internet framework since its inception always steps have been taken to overcome this unorganized format of communication. In the continuous efforts to do so various standards e.g. TCP/IP, HTTP, Port 80 and XML are being adopted to enable standardized and uniform communication and further actions in this regard are still under study with Internet Task force and other concerned bodies.

Furthermore, the Internet is Protocol based network. A protocol is an agreement about how things work together. This protocol does not specify what people can do with the network. So in the backdrop of other services being offered keeping user in the context likewise other telecommunication facilities has converged to offer user centric services. This has not been the case with Internet wherein users are always been conferred with limited actionable ability over network.

To organize and make the present system of internet more functional continuous efforts are being carried out, which resulted in similar other technologies recovered of one or the other problem of internet. Thus, taking into consideration privacy and security of operations in concern peer-to-peer (P2P) has been put to use, which with few advantages has limitations on account of its bandwidth availability, IP address translation, port 80 pollution, packet filtering, regulation, copyright infringement, barriers to entry, ability to trust the system and other users, security, complex architecture and difficult maintenance, poisoning attacks, denial of service attacks, defection attacks, viruses, filtering, identity attacks, spamming. Additionally the tendency of computers at the edge of the network to fade in and out of availability and accountability of the actions of network participants further devaluate security and system management.

There are now at least 10 million people actively using P2P file-sharing technology at any time. As if now Client-server was one-way, the Web was two-way, and now peer-to-peer is multi-level. The privacy & security are still been major grounds specifically for B2B operations which are not been addressed fully and asks for expensive solutions for the same.

Peer-to-Peer (P2P) Methods & concepts known to the computing world, Gartner Group describes P2P computing as: “a set of computing nodes that treat each other as equals (peers) and supply processing power, content or applications to other nodes in a distributed manner, with no presumptions about a hierarchy of control”.

Thus, successful implementation of P2P requires overcoming of above stated shortcomings, which in turn ask for expensive solutions to configuration and implementation of the same, hence keeping it out of reach of common user at large.

Even though being decentralized & distributed P2P architectures are vulnerable to security not being sturdy enough to peer identification and authorization because of unavailability of trust, security, mechanism, and management wherein it demands balancing privacy, identity and trust of the users by means of enhanced bandwidth at much higher cost. Also regulation of P2P framework always raises question on its regulating authority and credibility of the same, P2P networks are known to be maliciously efficient in infringement of intellectual property rights specifically copyrights infringement that demands automated technical solution irrespective of regulating authority and same is not available.

Whereas focus on nonfunctional characteristics such as security, scalability, performance, fairness, and resource management is still not up to the mark and same need to be addressed for actualization of peer to peer distributed framework to work in tandem with internet framework.

Similarly the architectural design decisions and infrastructure technologies in terms of their distributed object location and routing mechanisms adopted by current peer-to-peer systems including their approach to content replication, caching and migration, their support for encryption, access control, authentication and identity, anonymity, deniability, accountability and reputation, and their use of resource trading and management schemes are still not up to the mark.

In an another preferred technical and methodological aspect in the similar lines of distributed methodologies is catching eyes of the inventors around the world wherein efforts are being carried out to put distributed system of communication to prove as a computing tool referred as “Distributed Grid Computing”.

Further advancement in network communication employs grid formulation to share resources wherein Grid technology enables a large scale sharing of computer resources located at remote locations. Computational grids are networks of many computers, often numbering in the thousands, that all have the ability to participate in a solving a single problem simultaneously.

Grid computing, which is sometimes referred to as distributed processing computing, has been proposed and explored as a means for bringing together a large number of computers of wide ranging locations and often disparate types for the purpose of utilizing idle computer processor time and/or unused memory by those needing processing or storage beyond their capabilities. While the development of public networks such as the Internet has facilitated communication between a wide range of computers all over the world, grid computing aims to facilitate not only communication between computers by also to coordinate processing by the computers in a useful manner. Typically, jobs are submitted to a managing entity of the grid system, and the job is executed by one or more of the computers on the grid.

Unlike conventional computer networks that focus on communication among users, grid computing is directed at harnessing unused processing cycles of all the computers within the grid to solve problems that require more computing resources than could be provided on any single machine.

A well-known example of a computational grid is the Search for Extraterrestrial Intelligence (SETI) project. SETI shares the unused processor cycles of thousands of computers to perform the vast amount of processing that is performed upon radio signals received from outer space in the search for intelligent life.

Though there exist substantial advantages in using computational grids, access to existing grids is limited. In order to access information or computer resources contained within a computational grid, a user needs to have access to a computer that is contained within the grid. Such a device is referred to as a grid member. Any computer device that is not a part of the computational grid is referred to as a non-member device. Enabling the non members to access Grid resources in a flexible way as per convenience along with ample choice to chose from hasn't been addressed properly in technically sounding way.

Limited access to grid resources poses a significant obstacle to the expansion of the use of computational grids. Currently, it is not possible for a non-member device to obtain access to a computational grid. Computational grids require member devices to be capable of communicating with the grid. Protocols such as Grid Information Protocol (GRIP) and Grid Registration Protocol (GRRP) have been developed to allow member devices to access information contained within the grid. However, it is not possible for non-member devices that are not capable of communicating in accordance with the grid protocols to access and use the grid resources. As a result, a user who desires to access a computational grid must do so via a member device, which might not be located nearby to the user's location. Thus, present grid framework are designed inherently to be location specific, hence restrictive in approach.

Keeping in view the communication & computation demand the need for larger computing power is not decreasing. For example, complex differential equations, neural network simulations and other design tasks at big entities such as GM or NASA certainly have strong demands for huge computing power. One way to fulfill those demands is a supercomputer that is 10 to 100 times faster than a desktop PC. However, the expense is so high that it is normally beyond the budget. Another good solution is distributed computing. However, traditional distributed computing has some inherent limits that are not easy to overcome for exploiting the supercomputing advantage out of it.

Since there exist much more idle CPU power worldwide, if we can develop a method to utilize it, we can save a lot of wasted processing power. The present invention discloses a new method a global NetAlter Service Manager (Multi Scale, Multi Purpose) distributed computing method to achieve that goal.

However, there are plurality of shortcomings with the existing efforts of grid actualization including specified fixed maximum number of computers in a group, PVM (Parallel virtual Machine) sets a maximum number of computers at 4095. further generally grid formation is employed in respect of local networks and specified territorial computational resource utilization view point, unfortunately with communication facilities being available to connect every terminal in the world universal grid formation still not a reality.

Another prominent dissatisfying shortcoming is accessing to each participating computer not being automated for dynamic selection. For example, in PVM, if a user wants 1000 computers to work together, he/she has to physically locate them and obtain accounts from each node. It also limits the scalability wherein no idle computer in the world is allowed to join the distributed computing group freely.

However, while the concept of grid computing holds great promise, the execution of the concept has not been without its challenges. One challenge associated with grid computing is the efficient organization and management of the highly diverse resources available on the grid system so that jobs submitted to the grid receive handling that is appropriate to each of the particular jobs.

Much of the development effort in grid computing has focused on defining a uniform interface and protocol for the computers of the grid so that jobs submitted to the grid may be performed by one, two, or even hundreds of computers in a coordinated fashion. The computers of the grid system are part of a general population of computers from which the managing entity of the grid system chooses one or more computers to process a job.

Another aspect of grid computing that has received some attention is the development of systems and methods for secure communication between computers of the grid system that may be remotely located with respect to each other. To encourage use of the grid system, potential customers must be confident of the security of the information included in jobs being submitted to the grid for processing or storage. Often jobs that have significant processing requirements or storage needs (and thus are probably the most suitable for processing on a grid system) are submitted by entities that require a high degree of security for their projects because they involve highly sensitive information.

One illustrative example of the grid systems previously proposed is disclosed in U.S. Pat. No. 6,463,457, which describes a fee-for-service system in which fees increase incrementally based upon an increased level of reliability of service and an increased level of security. As appears to be common in the security implementations of known grid systems, the security measures are primarily directed to maintaining the integrity of message transmissions, and message encryption is employed to secure the message transmission aspect of the grid system operation. The security measures of the grid system often end when the message transmission of the job ends, as the grid system typically lacks any significant ability to control security measures on the individual computers of the grid and typically are unaware of any security measures that have been taken for the compute, especially in larger grids.

In view of the foregoing, it is believed that there is a need for a system for gathering and using information about relevant aspects of the computers of a grid for providing users of the grid with the option to select between various levels of computer security, performance, and availability (among other characteristics) in performing jobs submitted to the grid. In these efforts augmentation in the present concept of the grid is necessary by means of avoiding use of client-server topology for restricting use of grid for specified computational work assigned by server.

Again in an another view of the foregoing, there is need to over come the existing barriers to grid computing wherein non technical issues related to grid computing need to be solved in highly and precisely technical manner.

The existing communication means though integrates all communicating devices and technologies enabled through operation it lacks unavailability of convergence of all such communication and computation means to manage operations securely, distributedly and in faster way.

The integration of mobile wireless consumer devices into the Grid initially seems unlikely due to the inherent limitations typical of mobile devices, such as reduced CPU performance, small secondary storage, heightened battery consumption sensitivity, and unreliable low-bandwidth communication. However, the millions of laptops and PDAs delivered annually suggest that this untapped abundance should not be prematurely dismissed. Given that the benefits of combining the resources of mobile devices with the computational grid are potentially enormous, so issue of compensating the inherent limitations of these devices in order to successfully utilize them in the Grid is still under researched which needs much simpler and universal software application to exploit enormous information and computational resources and unfortunately the such universal application is not available.

Further advancements in the existing information communication and computation procedures and frameworks are proposed in terms of more organized and flexible system, framework model than Internet framework and defined as “web services”, an emerging trend in information technology in general, which proposes decentralized networks operations of the type provided by network service providers. This trend is evidenced by the level of investment in so-called “web services” and in the adoption of a number of open industry standards supporting web services. In general, the term “web service” refers to an interface that describes a collection of network-accessible operations. Web services technology is a mechanism for distributed application integration, also commonly referred to as the “service-oriented architecture” for distributed computing. Web services fulfill a specific task or a set of tasks. They may work with one or more other web services in an interoperable manner to carry out their part of a complex workflow or a business transaction by providing a standard means of interoperating between different software applications, running on a variety of platforms and/or frameworks.

A Web service is a software system designed to support interoperable machine-to-machine interaction over a network. It has an interface described in a machine-processable format (specifically WSDL). Other systems interact with the Web service in a manner prescribed by its description using SOAP messages, typically conveyed using HTTP with an XML serialization in conjunction with other Web-related standards. The Web services architecture is an interoperability architecture, it identifies those global elements of the global Web services network that are required in order to ensure interoperability between Web services such a typical web service design pattern and structured methodology is illustrated and described in US patent application no 20050044197 by Lai et al

The distributed application integration and organization has been defined and governed by open industry standards to facilitate web services includes HTTP (Hypertext Transfer Protocol), SOAP (Simple Object Access Protocol) and/or XML (Extensible markup Language) Protocol, WSDL (Web Services Description Language), and UDDI (Universal, Description, discovery, and Integration). HTTP is commonly used to exchange massages over TCP/IP (Transmission Control Protocol/Internet Protocol) networks such as Internet. SOAP is XML based protocol used to invoke methods in distributed environment. XML protocol is an evolving specification of the World Wide Web Consortium (W3C) for an application layer transfer protocol that will enable application to application massaging. XML Protocol may converge with SOAP. WSDL is an XML format for describing distributed network services. Hitherto, http is wel known and widely used protocol of information transfer, SOAP still in the growing stage hasn't been utilized to greater extent, also SOAP utilization has been restricted to very specific applications and unfortunately not explored further, being believed to be useful for distributed business application, leaving it underutilized.

UDDI is an XML-based registry technique with which businesses may list their services and with which service requesters may find businesses providing particular services. Just-in-time application integration is possible by issuing UDDI requests to locate distributed services through a UDDI registry, and dynamically binding the requester to a located service using service information that is conveyed in a platform-neutral WSDL format using SOAP/XML Protocol and HTTP messages.

Thus, using these above said components, web services deemed to provide requesters with transparent access to program components that may reside in one or more remote locations, even though those components might run on different operating systems and be written in different programming languages than those of the requester. (For more information on SOAP, refer to http://www.w3.org/TR/2000/NOTE-SOAP-20000508, titled “Simple Object Access Protocol (SOAP) 1.1, W3C Note 8 May 2000”. See http://www.w3.org/2000/xp for more information on XML Protocol. More information on WSDL may be find at http://www.w3.org/TR/2001/NOTE-wsd1-20010315, titled “Web Services Description Language (WSDL) 1.1, W3C Note 15 Mar. 2001”. For more information on UDDI, refer to http://www.uddi.org/specification.html”. HTTP is described in Request For Comments (“RFC”) 2616 from the Internet Engineering Task Force, titled “Hypertext Transfer Protocol—HTTP/1.1” (June 1999).)

Such a web service application is illustrated in very primary form comprising of client-server application for information access in US patent application no. 20040221001 by Anagol-Subbarao, Anjali; et al. wherein the interface module, implementation module and fulfillment module are hosted on the server computer and users are requesting the resources by means of XML, SOAP, UDDI & WSDL to constitute web service. Herein illustration of web service is at very basic level as a universal client server architecture that allows disparate systems to communicate with each other, without using proprietary client libraries. A web services architecture simplifies the development process typically associated with client/server applications by effectively eliminating code or programming dependencies between client and server. No custom connectors or enterprise application integration (EAI) is required. Server interface information is disclosed to the client via a configuration file encoded in a standard format, such as by use of a WSDL file. Doing so allows the server to publish a single file for all target client platforms, such as in a UDDI registry

With increased use of collaborative networking, efficient techniques for resource sharing has become critical. Resource sharing is complicated in conventional distributed or decentralized networks by the heterogeneity that exists when using technologies such as web services.

In recent years, the academic and scientific communities cooperated to develop the concept of “grid technology” for sharing their resources. As defined by IBM at http://www-1.ibm.com/grid/about_grid/what_is.shtml.

A grid is “a collection of distributed computing resources available over a local or wide area networks that appear to an end user or application as one large virtual computing system. The vision of grid computing is to create virtual dynamic organizations through secure, coordinated resource sharing among individuals, institutions and resources. Grid computing is an approach to distributed computing that spans not only locations but also organizations, machine architectures and software boundaries to provide unlimited power, collaboration and information access to everyone connected to a Grid”.

Grid technology allows enterprises to share resources as they form “virtual organizations”—that is, the enterprises share their resources and services (which may be in geographically-widespread locations and which may have heterogeneous computing platforms) to form virtual computing services. (See “Grid Services for Distributed System Integration”, I. Foster et al., Computer, 35(6), 2002, for more information about grid technology. This paper is also available on the Internet at http://www.globus.org/research/papersheee-cs-2.pdf.)

Today, an architecture referred to as “Open Grid Services” is being developed by academic and scientific communities, along with commercial enterprising entities such as International Business Machines Corporation (IBM), SUN JAVA, and MICROSOFT TECHNOLOGIES, as an evolution of grid technology. Wherein estimated billions of dollars of industry capital is being invested to explore the opportunities to make the above said vision a success. This Open Grid Services Architecture (“OGSA”) enables a grid to provide enterprises with an extensible set of services that can be aggregated by the virtual organizations.

According to OGSA, all computational resources, storage resources, networks, programs, databases, and so forth are modeled as services, providing a service-oriented view. OGSA leverages web services technology as well as grid technology.

Refer http://www.globus.org/ogsa and to “The Physiology of the Grid: An Open Grid Services Architecture for Distributed Systems Integration”, I. Foster et al, available on the Internet at http://www.globus.org/research/papers/ogsa.pdf, for more information on the OGSA. A document titled “Grid Service Specification (Draft 3, Jul. 17, 2002)”.

The OGSA work effort includes an evolution of a programmer's toolkit referred to as the “Globus Toolkit”, which is designed to make creation of grid-based applications easier. The Globus Toolkit defines a “grid runtime” as a set of services. This set of services includes: (1) a Grid Resource Allocation and Management (“GRAM”) protocol and “gatekeeper” service, designed to provide secure, reliable service creation and management; (2) a Monitoring and Discovery Service (“MDS-T”) for information discovery; and (3) a Grid Security Infrastructure for single sign-on, delegation, and credential mapping.

In accordance with queries demystified in patent no. US 20040139144 it provides solution as to a method, system, and computer program product for allowing a non-member device to access a computational grid. A set of web services is created to provide a port through which a user can access a computational grid using a non-member device. The web services are created using an XML based workflow definition language, such as Web Services Flow Language (WSFL) to provide access to one or more computational grids. A server accepts a user request via a web browser, uses the XML based workflow definition language such as WSFL to create a web service to identify the correct grid or grids that would provided the requested resource, identify an available member of the chosen grid, and create a request that can be processed by the grid member operating within the grid protocols. Once the grid member has obtained the requested solution, the solution is returned to the web service and then supplied to the non-member device.

Another emerging technology in the similar line is autonomic computing, which reduces the maintenance and administrative complexity inherent in information technology (“IT”) systems and networks by employing algorithms that allow the systems and networks to monitor and manage themselves. An autonomic system is defined as one which displays one or more of the following characteristics: (1) self-defining; (2) self-configuring; (3) self-optimizing; (4) self-healing; (5) self-protecting; (6) anticipatory; and (7) contextually aware in a heterogeneous environment. These concepts are already well known in the art and used as instruments to create and build solutions for framework to achieve above stated characteristics.

In the purview of growing Service Oriented Architecture (SOA) development efforts to overcome vexing problem inherent with prevailing frameworks namely internet framework, peer-to-peer framework, distributed and grid framework, convergence of all these legacy technologies in this field hasn't been achieved yet on a single operating platform. The convergence being a demand of an hour since we are using these technologies and conceptual models attached to it over a substantial period of time, lot many resources, computational as well as economic are getting wasted on solutions and technologies with shorter life span, adding obsolenscy of the same.

Though internet framework, peer-to-peer framework, distributed and grid framework and other communication & computation technologies seems different aspects with out of phase purposes, but significantly liked with the similar substrate to grow on i.e. secure communication with efficient data transfer philosophy impregnated with automation. We are employing different means to enable the same with each of the above stated purposes.

Since the time we are using internet and telecommunication technologies, and integration of telecommunication with internet is on through rapidly developing hardware sophistication, already been host of applications been migrating from across the sectors of technologies, further simplifying the communication protocols and standards to extend & generalize its applicability to other related fields.

While many may understand the notion of SOA by now, very few have any idea how to get there. There is no hard and fast rule how one builds a Service Oriented Architecture in your organization. However, common patterns are emerging which may help us understand how to use SOA organization.

The method disclosed herein describes a convergence operating software platform to run on plurality of hardware platforms to carry out plurality of operations related to communication, computation and information search and retrieval for social communication and business applications.

### SUMMARY OF THE INVENTION

The internet itself is becoming a giant software platform. As with standalone computer we need operating platform to run and manage stored resources, the internet with such abundancy of software storage needs operating system i.e. operating system for internet. Such an operating system unlike PC operating systems is expected to work as a translator between software applications, peripheral devices, and the PC's hardware, which further translates databases on the net. With these futuristic views of the art of computer science and information technology. NetAlter provides such an operating system to manage information communication and computation (ICC) inherently following specific methodology therein to form NetAlter ICC framework. With reference to limitations of existing framework (infrastructures) recited in the prior art, instead of development of such an operating system for unorganized internet network, NetAlter proposes a logical, clustered, flexible, auto-trusted ICC network development approach, wherein the said operating system for resource management is extended to form a browser application with active explorer for communication and computation operating platform.

In a significant embodiment of the present invention of NetAlter, service browser software application forms a universal tool essentially supporting NetAlter's distributed, clustered and layered model philosophy wherein the said browser application being installed on every channel nodal members (users) in the NetAlter framework providing means for information communication and computation. The said service browser application installed therein stand alone machine providing management & tool for related information therein.

The said NetAlter service browser application providing plurality of functionalities for information communication and computation comprising of information & entity searching & matching, communication tools, multi-client operations, multi-users operations, multi devices hosting, multitasking operations, multi-language support etc.

In an essential embodiment of the present invention is a convergence solution to the concurrent communication technologies and methods, the NetAlter framework is a method and system for alternative ICC framework creation engrossing computational grid and peer to peer communication capability forming truly democratic, federal, service oriented, and heterogeneous user centric distributed infrastructure.

In accordance with the present invention, a standardized set of methodologies has been devised to overcome the limitations recited in the prior art as existing in the presently practiced frameworks architectures, wherein specifically thin client applications are in practice, NetAlter formulate solution to foster multi client like rich client applications, bestowing user with impeccable amount power at its terminal for the same.

In a preferred embodiment of the present invention matter a set of web services is created through which a user can access a computational grid using a subscriber device functional via ports. The web services are created using an XML based workflow definition language, such as Web Services Flow Language (WSFL) to provide access to one or more computational grids. A server accepts a user request via a service browser application, uses the XML based workflow definition language such as WSFL to create a web service to identify the designated portion of the NetAlter framework that would provide the requested resource, identify an available subscriber of the chosen portion of the framework, and create a request that can be processed by the NetAlter subscriber operating within the specified portion of the framework. Once the NetAlter subscriber has obtained the requested solution, the solution is returned to the web service and then supplied to the non-subscriber device. Alternatively, the web service can inform the subscriber device of the location of the non-subscriber device as part of the request, and the subscriber device can then communicate directly with the non-subscriber device. Furthermore, once the web service has been created using WSFL, subsequent similar requests can invoke the previously created web service, thus eliminating the need to create a new web service for a specific request.

In an another preferred embodiment of the present invention the NetAlter utilizes a web service by means of service browser application that accepts requests for a information communication and computation in HTTP Post format and creates a request that can be sent to a NetAlter subscriber in the form of a SOAP envelope. The web service determines the location of the requested solution with one or more portions of the NetAlter framework, and sends the SOAP envelope to the appropriate NetAlter subscriber, in accordance with WSFL. The SOAP envelope can be processed by the subscriber and the solution is returned to the web service via a second SOAP envelope. The web service reads the returned SOAP envelope and returns the results to the non-subscriber device via an HTTP command.

It is being gauged that ensembles of distributed & heterogeneous resources for use of disparate, heterogeneously distributed users for ICC activities, have emerged as popular platforms for deploying large-scale and resource-intensive applications. Large collaborative efforts are currently underway to provide the necessary software infrastructure for enabling this into reality framework.

The security being the major concern the world over with present communicational and computational infrastructure being impeachable to said concern further does not provides appropriate to Grid computing challenging issues in many areas of computer science, and especially in the area of distributed computing, as Computational Grids cover increasingly large networks and span many organizations, major stress being laid on issues concerning the dissemination and retrieval of information and data on Computational Grid platforms. The present invention matter resolves these issues and points to preliminary ideas, work, and results in the Grid framework and the distributed computing framework.

In the view of foregoing, the present invention disclosure of NetAlter system and method provides predefined user centric framework creation methodology for information communication and computation till the implementation level in terms of software product of NetAlter service browser based on the communication and computation infrastructure creation methodology rendered by business method involved therein.

### OBJECT OF INVENTION

An object of the invention is to fulfill the needs referred to above. In accordance with the principles of the present invention, broadest object is to build holistic framework meant for convergence of prevailing communication and computation technologies for faster, reliable, secure and personalized, customizable Information Computation & Communication (ICC) framework.

Another significant object of the present invention is to devise a universal operating system software application preferably identifies as NetAlter service browser for management and functioning of the said ICC framework preferably identified as NetAlter framework.

Another significant object of the present invention is to devise a system and method to implement Artificial Intelligence into the said NetAlter operating system supplementing the automation part.

Yet another significant object of the present invention is to make use of idle computing resources (CPU Cycles, HDD Storage, Attached devices like printer, Web Camera etc.) on the distributed computers while being acceptable to the public.

Another object of the present invention is to engross service-oriented feature into said ICC framework whereby users are put at front for every service being offered whereby offering people oriented system and framework.

Yet another object of the present invention is to build up a democratically federated ICC framework.

Yet another object of the present invention is to build up an information management & dissemination framework for related universal resource planning keeping global information explosion in perspective.

Yet another object of the present invention is to form a grid framework engrossed with supercomputing abilities functional at dynamic users' terminals in the form of distributed supercomputing Information Computation & Communication (ICC) framework.

Yet another object of the present invention is to exploit and enjoy existing all functionalities of peer-to-peer network.

Yet another object of the present invention is to build a recurring framework comprising of networks' network forming aggregation of networks.

Yet another object of the present invention is to devise a system to exploit the cascading advantages where each one functionality does supports and add value to other every related functionality.

Yet another object of the present invention is to devise a universally uniform interface for user-friendly operations to connect right people, at right time for right information maintaining uniformity of services.

Yet another object of the present invention is to bring into reality the visionary concept of semantic network framework development whereby causing automatic data retrieval more intelligently.

Yet another object of the present invention is to devise a fully interoperable system, which is functional in every network irrespective of location, and subject matter.

Another significant object of the present invention is to support user centric framework creation wherein privacy of user in all contexts is preserved therein.

Yet another object of present invention is to devise a searching solution to locate peers and required information on the network at much faster speed with improved precision level from variety of multiple sources.

Yet another object of present invention is to build an ICC framework wherein security aspect of users and framework itself at large should be taken care of by means of virus deterrent, spam & piracy free accountable framework.

Yet another object of present invention is to devise an ICC framework wherein all parties involved are identified on the network by means of universal unique id.

Yet another object of present invention is to devise a system wherein all operations irrespective of time, location and connected member's attribute in the system is recorded & maintained in the form of inventory for reference for future queries if any.

Yet another object of present invention is achieving duplication deterrence of content along with maintaining excellent data currency

Yet another object of present invention is to automate business process by means of business logic provided at user terminals in addition, to create B2B exchanges.

Yet another object of present invention is to devise protocols to enable collaborative and syndicative network operation within the ICC framework acting as user owned system at large.

Yet another object of present invention is to create dynamically synchronized ICC services, which reflect current and updated information content and status of all variables in an automated manner.

Still another object of present invention is to foster networked community development with user-friendly system so as to foster information usage at the grass root level irrespective of digital equipment of the user.

Yet another object of the present invention is to devise a digital license based system in terms of encrypted keys for ensuring security standards and faster mobility of operations.

Still another object of an invention is to provide automatic clustering on the back end, combined operating system (OS) with database and on demand application along with lowering TCO.

Still another objective is development of devising means for local resources utilization while connected, processing power, RDBMS usage, multi users, clients devices, remote users, multiple source of information for one category, updated data, save time & economic.

Yet another important object of present invention is to transform read only, partially informed internet framework to full feature NetAlter framework.

Yet another object of present invention is to devise an exclusive operating environment for NetAlter Operating System, aimed at People oriented autonomic capabilities involved therein.

Yet another object of present invention is to empower user with enormous capabilities to manage own data & information content over a distributed framework with regard to personal customizable portal & server thereof.

Yet another object of present invention is to fostering the use of personal portal via personal server for creation of personal network so as to define a interested peers personal network.

Yet another significant object of present invention is to remove most of the existing limitations of internet framework including its browser capabilities, ways & means of performing, e-commerce transactions, search techniques.

Yet another object is to devise system enabled with Rich Client techniques & concepts.

Yet another significant object of present invention is form automatically provisioned NetAlter framework having following characteristics: standardization, specialization, large number of module & services, portability, normalization, scalability, transformational, everywhere, every device, automation, secured, current data, duplication deterrent, low maintenance, low development cost, ready to use, each step comparison, matching, easy availability, ranking, built groups for information sharing ability.

Yet another object of present invention is to build up framework wherein there is no flashy & wacky advertisements, no proprietary search engines as well as domain name free network whereby reducing the hype being made on IPR of domain name registration and protection of the same like trademark.

Yet another object of present invention is to devise a smart system and method for information collection, organization, integration, collaboration and Distribution for development of networked community by secure means of trusted layered networking.

Yet another object of present invention is to devise a business application framework wherein e-commerce is possible in visual, voice enabled and automated mode.

Yet another object of present invention is to devise a means to identify each of the active nodes in the network. Thus, to ensure security and accountability.

Yet another objective of the present invention is to foster the e-commerce operations within the framework supported with automated marketing of the same.

Further aspects and advantages of the present invention will become apparent from the ensuring description, which is given by way of example only.

### Working of Invention

The present invention devises a universal distributed computation and communication software solution, standards, in terms of service browser application. No other methods to date can make use of idle CPU resources on the Internet while being acceptable to the public.

The ability to integrate disparate computing resources, such as computer applications & databases and web-accessible services in local to global manner of distribution topology, remains a daunting task. To further illustrate this, computer software continues to be developed by numerous independent companies across many platforms, using a variety of ever-changing computer languages, and without widespread adoption of standards, norms, or protocols that would enable seamless integration of such computer resources. Although integration of a plurality of computer resources within an enterprise or between selected business partners is possible, albeit expensive, on a case-by-case basis, there currently does not exist a system or methodologies for enabling distributed technologies to communicate in a meaningful manner on a large scale or scalable basis, having global reach to cover & connect every computing terminal in the world.

Numerous attempts have been made and will continue further to improve the prospects for integration of and communication between all types of computer resources herein referred to as “Convergence to communication infrastructures”. For example, in the Internet arena, “web services” represent an emerging set of standards that enable to provide web-accessible software functions to users or business partners through structured interaction and non-proprietary standards. Technically, a web service is a programmatic interface, which is network-addressable through a universal resource identifier (e.g., a URL), and which is transported, routed, and packaged over network protocols, such as Hypertext Transport Protocol (HTTP) or TCP/IP. This standards-based interface is enabled through the use of the eXtensible Mark-up Language (XML). XML is an increasingly adopted standard for describing data format and syntax using a mark-up format. XML is used in the web service's programmatic interface to define Remote Procedure Calls (RPC) for accessing legacy systems. A generally accepted standard for defining web service interfaces is the Web Service Description Language (WSDL). The WSDL standard provides a standardized, XML-based format for describing the interfaces, their operations, and inputs/outputs. In a typical web services scenario, a business application sends a request to an Internet accessible application at a given URL using the Simple Object Access Protocol (SOAP) over HTTP. The request is formatted based on a WSDL specification. The application receives the request, processes it, and returns a response based on the formatted WSDL specification.

While web services have the potential to revolutionize the way business is conducted on the web, there are numerous obstacles that must be overcome. Some of the obstacles include finding ways to describe web services, the operations, and inputs/outputs, finding ways of finding those web services based on these descriptions, and executing a web service, or a sequence of web services based on those descriptions. As companies begin deployment of services, or as application vendors begin creating web service interfaces to their applications, companies will face problems in finding web services especially if there are multiple services that can perform competing functions the company desires. Meaningful access to competing web services is difficult because each web service uses its own terminology and typically identifies its input and output variables and its functional methods differently. XML, as the standard for describing web services, provides no structure for creating definitions of these web service functions. With the complexities inherent in the English language, as well as any other language, developers typically describe similar functions, tasks, or operations in a wide variety of manners. As a result, two applications may have two very different ways of describing and invoking applications to return essentially the same information. Even with standards for such naming functions, discrepancies in applying the standards make it difficult for widespread access and use of such web services. Further, forcing each web service to conform to a standard naming convention may not make logical or semantic sense based on the “non-standard” terminology that already exists in any particular business industry. Most importantly, standards are seldom universally adopted, so there will always be complexities in understanding or translating function descriptions.

Thus, there is a need for effective categorization and description of services based on the various service descriptors. Effective description and categorization of services would resolve a number of problems related to discovery, invocation, interoperation, composition and execution monitoring. In order to discover and execute web services, and in order to compose execution flows of disparate web service flows, however, it will be necessary to perform searches and queries based on properties and attributes. Even if a web service is discovered, in order for data about the web service to be understood, the context of that data must be understood. If the entity's “context,” such as how it was developed, who developed it, and what it is used for cannot be understood, then it will remain difficult to interact effectively with the service. Without technologies for structuring and managing data and meta-data, web services will remain undiscoverable or misunderstood. The ability to attribute Meta data to services, and then run queries based on that Meta data is, therefore, central to the purpose of service registration, publication, and discovery at both design time and run time. Absent technologies for service description and classification, web services will not be adopted in a comprehensive manner.

Thus, there is a need for effective data abstractions within the field of computer science that will translate across different data definitions and formats. There is a need for data abstraction for the purposes of classification and description to provide for dynamic translation and discovery. Dynamic data management and representation technologies will engender a dynamic configuration methodology to web services.

For these and many other reasons, there is a general need for system and methods for enabling businesses to create, manage, and share complicated descriptions of system & data resources. In order to create, manage and share these resources, whether data stored in a database, or a web service interface to a software application, systems and methods are necessary to create, maintain, and utilize descriptions of those resources based on abstract definitions that are in a format that is simultaneously computer interpretable and human understandable. When a computer resource is described in a human understandable form, it defines the resource in terms of business operations or certain specific operations and definitions. As a result these resources can be categorized, indexed, and discovered based on certain business or specific operation contexts. In parallel, a computer resource is computer interpretable when it can be discovered, invoked, interoperate with other computer resources, and monitored despite disparate formats and descriptions.

Thus, there is a need for systems and methods to enable users to describe computer resources in native terminologies that are computer interpretable and support cross-terminology discovery and interoperation. In order to create these terminologies for describing these resources and based on abstractions of what a resource is and does, system and methods are required for creating, managing, and using terminology models that can provide a high-level description of the resource and its provider, including a specification of the functionalities provided by the computer resource, the resources functional attributes, including its requirements and capabilities. Such descriptions can be used for designing use of computer resources or invoking computer resources either during a software design phase or during actual execution. Dynamic discovery and invocation of resources and the creation of resource composites in which disparate resources are able to interoperate is dependent on the robustness of resource descriptions and the richness of the resource's Meta data.

The present invention meets more or less all of the above referenced needs as described herein in detail.

To achieve the foregoing objects, and in accordance with the purpose of the invention as broadly described herein, the present invention provides methods and systems whereby the present invention chalks out a convergence solution and standards to organize the information communication & computation (ICC) access modality of users, concomitant with information rights of user with best exploitation of prevailing technologies in terms of system and method to build a universally distributed application in an organized & standardized way that engrosses supercomputing capabilities into the framework, forming a computing grid along with peer to peer communication infrastructure. Such a convergence solution being referred to as NetAlter communication & computation framework. The said NetAlter framework comprising of disparate universally distributed computer systems enabling formation of communication & computation networks and an effective means for alternative ways to utilize presently unorganized internet framework.

According to one aspect, the distributed network comprises of multiple clients disparate in nature placed at specified level of operation in the network architecture that essentially follows Trusted Flexible Hierarchical Layer (TFHL) networking standards devised to establish alternative communication methodology to internet as well as enterprise communication framework wherein said TFHL defines the predetermined specified relational administrative rights of all software powered channel node members in the framework.

In a significant aspect of NetAlter framework distributed methodology, the users of the framework at various level hereinafter referred to as channel node members (CNM) comprise of a central control in the form of NetAlter, plurality of service module developers, plurality of service and module providers, plurality of service & module publishers & distributors and at the end of the NetAlter framework hierarchy are plurality of subscribers.

The software for administration of framework provided to channel node members is browser application for NetAlter operations management at specified hierarchical level in the framework.

In a constructional aspect of NetAlter framework, Trusted Flexible Hierarchical Layer (TFHL) networking standards is a means for framework building revels relationship aspects of the parties involved therein, and signifies that a all relationships in the framework are trusted by technically provisioned tool to identify the operational party (CNM) in the framework which is inherently being kept flexible as per administrative rights and same being hierarchically placed therein the AlterNet framework.

In an another aspect of the present invention, the layered methodology for framework organization is followed therein comprises of plurality of framework levels based on plurality of rationale segregating the framework in an identified parts thereof. The concentric circular model in proposition in FIG. 24 illustrates NetAlter framework as a whole in terms of global perspective, which further comprises of plurality of fields, locations, networks, domains, sub-domains, entities and their attributes. Further each field represented in plurality of location, with each location comprising of plurality of networks, with still further networks comprising of plurality of domains with still further domains comprising of plurality of sub-domains, wherein still further essentially plurality of entities defining sub-domains at large having plurality of attributes thereof.

Further such segregation improves searching feature of the NetAlter, by means of logically interrelated layered model couching each CNM with reference to anyone or combinations of layers thereof to map the path.

With reference to prior art, a look at Client-Server topology in the nutshell revel certain flaws involved therein as to servers been loaded to hardship extent. In the pretext of presently available computing standards available with computers, each machine is configured to act like server within itself; the same principle is applied while designing an NetAlter framework. Retrospective analysis depicted as below supports this premise.

As the Internet is growing hotter, more computers are continuously connecting into the network. In 1993, there were 2,152,000 hosts on the Internet and it is estimated to have 100,000,000 in 1998. Together with the invention and development of many new tools and technologies such as WWW, CGI, JAVA, CORBA and so on, Internet services are also becoming common to users. In principle, any host that offers some service can be regarded as a server, like a web server, gopher server, news server, chat server or game server.

Most network servers are designed on a Client-Server basis in which clients connect to a server, begin a conversation to get information or perform an operation. This conversation is also called a transaction or session. Usually, the server is the information provider and the client is the receiver. The goal of the service provider is to attract as many users (clients) as possible.

Because of the infinite size of the Internet, popular servers have many clients. For example, very hot web servers such as the Yahoo search engine could be accessed nearly 10,000 to 1,000,000 times daily. It is also common that at a given time, a game server could have thousands of clients implementing a fighting or mud game for hours per day. Statistics show that during the games between Deep Blue and Kasparov last year, the news web page of IBM's Deep Blue was accessed more than 1 million times per day.

Here we can see that good servers entice many users to access, thus there is an opportunity for the server to distribute tasks to them (user computer) during conversations so as to power a host machine as a server within itself. This is the basis of the present invention of NetAlter supercomputing framework creation system & method including standards & business method devised to implement framework thereof.

Since most computers on the Internet have quite huge amounts of idle CPU time, it is natural that the server can use it for parallel computing. The only limit is that the tasks the client can perform should not influence the overall performance of the client computer, nor should it take too much time (longer than normal conversation). The client might need to transfer back results to the server. Therefore by assigning different tasks to different clients, the server can acquire huge amounts of computer time since the number of clients can be very large (more than 1 million per day in some cases).

In an another aspect of present invention, the software application hereinafter referred to as service browser is truly devised for distributed operations, wherein the activity rights in the NetAlter framework is bestowed upon user through its attributes and the same being controlled in terms of digitized keys bearing the administrative rights descriptors and communicated across in the plurality of ways of communication.

The service browser application installed therein the users' device forming universally uniform active interface for information communication and computation (ICC) comprising of flexibly adjustable two separating panes namely explorer and viewer portion thereof, explorer showing active links with reference to related channel node members and viewer being displaying the same for further operations.

In NetAlter framework, the relationship between the connected CNM is reversible in the process of computing. For NetAlter, any CNM performing some task for the sourcing computer may be regarded as a dynamic client (dynamic peer) since it serves as a “computing CNM”. There can be N no. of dynamic computing CNMs at any particular instant of time depending upon the tasks size and complexity.

In summary, NetAlter distributed computing, any peer can ask other dynamically assigned peers to work for it at the same time the source peer provides the computing peers with some task to perform. Source peer node gain access to the service and in return, it pay back with part of its idle computing resource. It is the computing power contributed by all connected peers in the NetAlter framework that makes presently distributed system a supercomputing grid.

No other methods to date can make use of idle CPU resources on the Internet while being acceptable to the public. Other distributed computing methods either require direct access to client machines or special setup. Normally, it consists of a lot of static nodes and each node runs some daemon dedicated to computing. In other words, all nodes are full-time contributors. The aforementioned scenario is unlike NetAlter framework, which only contributes one's free idle CPU resources when it connects to get service from the server and vice a versa. Therefore, the present invention is a, mutually beneficial procedure for all connected members.

In an another important embodiment of the invention the distributed network communication is made possible by means of NetAlter browsers operating platform and same can be used to operate the network activities and computation in plurality of ways like peer-to-peer, offline, online etc. The service browser helps to manage the network operation and is the means to administrative functions and information management. The invention overcomes vexing flaws in presently available internet framework and grid computing.

The present invention defines ICC (Information Computation & Communication) framework for leveraging present internet infrastructure, grid, peer-to-peer and web services related technologies, standards, and concepts to foster democratically provisioned ICC facilities. Thus building a convergence operating platform through the methodology and software application i.e. service browser thereof.

The basic inventive feature of the present invention lies in its methodology of logical organization of framework in the layered manner, business concept building supported by means of software application and adjudging the same in light of reality.

In an another important embodiment of the invention the distributed network communication is made possible by means of NetAlter Service browser providing a tool to access the network contents in multiple ways like peer to peer, offline, online etc. Also the data management of the accessed information is facilitated by means of in-build customized support. The explorer helps manage the network operation and is the means to administrative functions and information management, which is TFHL level specific, hence secure means for communication.

In the significant embodying feature of said invention matter wherein a system and method comprising of distributed proactive methodology to devise value added alternate information framework (NetAlter Framework) intended to devise an alternate to internet framework, social networking, digital marketing, current business practices and other digital communication methodologies for end to end Network Automation which is means to create and manage, as per Network Topology and Models being automatically provisioned, one or more reliable, secure, credible, standardize, scalable, unified, interoperable, modular & researched, service specific, self contained, federal, collaborative and syndicative social, business and internet alternate Networks and/or other networks in each specific field or area in particular location, which comprises Universal framework Manager meant for central certifying and administering authority provided with NetAlter functionality and disparate CNMs with their respective functionalities.

The system and method comprising of distributedly proactive automated framework to devise a universally distributed application in an organized way that engrosses supercomputing capabilities into the framework which form a computing grid comprising of disparate universally distributed computer systems enabling formation of communication & computation networks to bestow proportional computational capabilities at user end.

The logical layers in the NetAlter framework comprises of multiple Providers meant for serving single domain as well as network which are followed by Domain further which has one or more optional Sub-Domains or N number of sub-sub-domains in multiple locations owned, controlled by same or different owners, each with multi administration level functionality defined as per TFHL which consist of one or more Entities known or linked directly or indirectly to the user via its Attribute Information.

In the constitutional and constructional featuring embodiment of present invention the NetAlter system Framework essentially comprises of four main CNMs namely

### (1) NetAlter

### (2) NetAlter Service Module Developer

### (3) NetAlter Service Provider &

(4) NetAlter Service Subscriber and optionally four supplementary nodes namely

### (5) NetAlter Service Module Publisher (NSMP),

### (6) NetAlter Service Module Distributor (NSMDI),

### (7) NetAlter Service Publisher (NSP) &

### (8) NetAlter Service Distributor (NSD)

All NetAlter CNMs being bestowed with respective NetAlter service Browser application, thereby acting as a network and information management tool as per administration rights granted. Thus, every CNM in the NetAlter framework are identified and accordingly provided with required functionality acting as core security mechanism to control any kind of mal operation or unauthorized activity into the system irrespective of its location and digital equipment to break the wall.

In an another preferred embodiment NetAlter Framework means one broad unique, standard platform to build social business, interne alternate network or other types of network wherein System provides End to End Network Automation to successfully build, manage, and collaborate by means of licensing certificates and permissions protocols established therein between network's and connected domain's browsers.

In another significant visionary embodiment of the NetAlter framework is to devise a method of communication to address a information requirement involving access to and use of computer information resources, where more than one resource is capable of addressing the information requirement (multiplicity of sources), wherein plurality of computer information resources has been represented using service modules, thereby obtaining descriptions of the resources in the browser's explorer; arranging the descriptions in one or more semantic ontology; accessing one or more of the ontology to select a particular one of the plural information resources as available and/or qualified for addressing the information requirement. The semantic ontology is necessarily domain specific and responsibility of ontology development lies with NetAlter Service Module Developer.

Herewith in the present NetAlter invention, the vexing problems with the internet are achieved to cover following breakthrough properties of NetAlter to be part of it.

(1) indexing and retrieving information
(2) meta data
(3) annotation
(4) interoperable database infrastructure
(5) machine retrieval of data (background search)
(6) discovery services

The system and components of NetAlter Framework essentially acts as central repository of all the identity proofs and record of all activities being performed over any node in the said framework so as to establish NetAlter as a central organizing authority meant for monitoring & brokering of NetAlter services.

Also, the NetAlter acts as a central means to control & monitor the data related to identification proof of channel node members, browsers' licensing, peer to peer coordination & discovery services, synchronization & updates, quality control & assurance of the same, reports & analysis, AMA & search engine management, user complaints, user feedbacks, action, supports, lock & unlock system, communication, marketing & advertising, e-commerce, data mart, resource offering inventory, consulting and security concerns at large.

In an another significant embodiment of NetAlter invention, the control & monitoring functionality is devised for members' service browser licensing management wherein NetAlter monitor and control distribution of service browser's product key to users as a tool to globally identify the node analogous to its equivalent counterpart i.e. IP address in internet framework. Also, monitor & control the port address and computational resource offering services within the Framework globally along with keeping track of wide-ranging attributes of the said nodes along with Administrative functionalities conferred to it so as to keep check of resource utilization based on that.

In an another significant embodiment of the present invention, the NetAlter monitoring functionality is devised for peer-to-peer coordination & discovery services management wherein NetAlter monitor and maintains all attributes of every CNM and helps identify the same by means of look up server referred to as NetAlter layered peer-to peer distributed cluster wise supercomputing, Wherein NetAlter is offering the discovery services by means of discovery server whereby the requested peers in the network are identified by the NetAlter and the discovery services reserved for private utilization.

Further the coordination services are being offered by NetAlter by means of coordination server wherein the coordination activity is made available at public utilization, resultant output on the user's part depends upon the amount of computing resources being offered whereby coordination server helps track the searched item in the network by means of segregating of whole of the network into fields, locations, networks, domains, sub domains, entities, and attributes which is instrumental at resource tracking and same can be worked out by means of name space to look up data in the granularity.

In another embodiment of the present invention, the discovery and coordination server functions are interchangeably and/or dynamically shared with distributed peer controller i.e. hub acting as means for routing and/or resolving the search criterion whereby saving the computational resources on the discovery & coordination server's part.

In an another embodiment of the present invention, the NetAlter's monitoring functionality carry out synchronization & updates management wherein NetAlter monitor every piece of alteration over the network by means of NetAlter layered peer-to-peer distributed cluster wise supercomputing.

In an another significant embodiment defining the quality standards, the NetAlter's monitoring functionality is devised for quality control & assurance of the same wherein NetAlter monitor and control quality standard defined by means of NetAlter factory standards and controls the same by means of supreme control of NetAlter i.e. application not at par are out rightly rejected.

In addition, the NetAlter's monitoring functionality is devised for locking unlocking operation management wherein NetAlter monitor and control the activities being carried out in the network at large so as to lock operation and/or disable Active Functionality of any connected node in the network similarly can unlock and/or unable the same thence.

In addition, the NetAlter's monitoring functionality is devised for ensuring security of operations wherein NetAlter monitor and control activities related to unauthorized & malicious contents, piracy as minimum as zero percent (0.00%) as the information container it uniform and being controlled to data with respect to file extensions transfer detection. Piracy is been causing billion dollar loss to world business and creative industry, the secure means for access of the same is the dripping demand since long. The IPR protection as to copyright violation and similarly piracy detection is carried out by means of duplication detection and piracy detection function wherein potential piracy prone data & files are being flagged as per the requirement of the resource provider having commercial value within it, are continuously detected and monitored so as to look for any of the unauthorized data transfer activity and inventory of these transactions is maintained for further reference.

Also, further action in this regards provides view only contents wherein downloads being prohibited, printing deterrence being maintained wherein print screen being prohibited at all levels of control bestowed by NetAlter to Providers.

In an another significant embodiment ensuring security of user resources and NetAlter framework at large, the system is devised to have virus proof operation with regard to data transfer operation as major source of viruses in prevailing interne framework. In a NetAlter framework virus deterrent operations are maintained by means of execution of full featured application at host side and data being only transferred into the system that avoids viruses to enter into the system.

Security insurance is guaranteed by means of proprietary and hence accountable nature of the NetAlter framework, virus and spam deterrence in a distributed processing of data is maintained wherein presentation, validation, and processing of data being carried at the host computing platform (client side computing) whereas the data which is being only source to viruses & spam transmitted essentially in an encrypted form.

In another important embodiment of invention of NetAlter Framework employs distributed domain operation irrespective of location which further comprises of Networks with system application both having inbuilt Scalability to grow, reduce, separate and collaborate in all possible means and ways.

Similarly scalability feature been looked as positive as well as negative growth in horizontal, vertical, unidirectional, bidirectional, time bound along with full data filtration and maintaining service specificity at large with any existing network or domains or third party services. The regeneration of the networks is possible with not essentially the similar entities and attributes.

The horizontal scalability of system applications and network comprise any of the new service entry, attached utilities as well as vertically (no of entry, no of users). It again generate multiple connected or separate meaningful networks from existing one or more Networks with one or more services via smart auto match (explained in later section) based on one or multiple criteria.

The NetAlter framework meant for smart information processing system with internet alternate network following are some of the important features underlining the invention describe the method in the nutshell.

(1) Highly organized,
(2) Differentiation via providing security,
(3) Reliability, trust,

### (4) Specialization,

### (5) Standardization,

### (6) Scalability,

(7) Unified & standardized interface,
(8) Self contained,
(9) On demand Service and Service Module,
(10) Usable ready (Ready to use at any instant),
(11) Easily accessible,
(12) Federation and collaboration as opposed to integration,
(13) Independent of consumer background,
(14) New service combined with existing service,
(15) Lower cost of ownership,
(16) Loosely coupled,
(17) Uniformity of interface through out all levels of operation,
(18) Much lower setup time, installation, implementation,
(19) training, maintenance,
(20) Scalable & effective usage of resources, provision,
(21) Billed on usage,

### (22) Grid Computing/Parallelism,

(23) Exchange between peer to peer,

### (24) Asynchronous,

### (25) Concurrency,

(26) Licensing and deployment model,
(27) Service from other server (if fail on one server),
(28) People and service oriented,
(29) Coordination oriented,
(30) Build to change, incrementally built and deployed,

### (31) Abstraction,

(32) Message oriented,
(33) Local resources utilization,
(34) Domain specific ontology.

In another functional features of NetAlter framework it carries out are Multi threading, multitasking and multiprocessing operations with data synchronization from multiple domains wherein the background search and time schedule search are made possible also the functionality is extended to the following important features includes e.g. Comparing, Ranking, Matching, Routing, Tracking, Searching, Sorting, Filtering, Applying, transacting, Merging, Extracting, Using, Analyzing, Finding, Correlating, Historically analyzing, Relationally Linking, etc. of data is achieved.

In an yet another preferential embodiment of present invention, the NetAlter is a Universal distributed and service based communication framework with intelligent automated browser acting as central control to other browsers by means of NetAlter Active Administrative rights being communicated via not essentially Web server or peer to peer communication facility.

The NetAlter Active administrative rights conferred with services bestowed on to it by means of NetAlter Service browser with NetAlter Active functionality as mentioned herein
i. Global Service Module Catalogue & Services
ii. Global Service Module Developer Catalogue & Services
iii. Global Service Module Publisher Catalogue & Services
iv. Global Service Module Distributor Catalogue & Services
v. Global Service Catalogue
vi. Global Service Provider Catalogue & Services
vii. Global Service Publisher Catalogue & Services
viii. Global Service Distributor Catalogue & Services
ix. Global Subscriber Public Information
x. NetAlter Service Browser for developer, provider, publisher, distributor and subscriber along with communication and management utilities.
xi. Browser licensing
xii. synchronization & updates
xiii. Global AMA, Search, Brokering, Payment, Identity & Monitor Services
xiv. Standards, Specialization, Certification & Licenses
xv. Centralize upgrades, updates, new browser version & utilities
xvi. Reports & analysis,
xvii. User complaints & feedbacks, supports.
xviii. Lock & unlock system, communication, marketing & advertising, e-commerce, data mart, consulting
xix. Framework security maintenance.
xx. Other administrative functionality required to manage operation

In an another preferentially important control mechanism of NetAlter framework the scalability of the system and network operation is possible by means of fully centralize and secured feature of product and package keys Distribution protocols being communicated across in encrypted form.

The standards building mechanism is regulated and governed wholly by master controller NetAlter essentially for module development at three essentially interlinked data organizing services that devises service modules standard, XML data structure standard, and information service standard being maintained uniformly throughout the information framework.

The system confer NetAlter Service Module Developer (NSMD) development rights of Full features multi client enabled service modules like Offline, Online, & mobile, as per service modules standard, XML data structure standard, and information service standard via one or more authorized and certified expert developer in a given field or area. One or more NSMD combined together and develop one or more service modules fully or partially and exchange reusable module component library. Service Modules being tailor-made, developed as per demands, request, situation wherein new networks created e.g. Domain specific, Social and Business networks specific.

The Service Module needs publication to build a user centric system to foster access of new tools into the system, this task being accomplished by NetAlter Service Module Publisher (NSMP) being certified by NetAlter Developer (NSMD) to ensure user's equipment in uniform and standardized manner, wherein NSMD enjoys collaboration opportunities with other two or more than two related NSMDs' with prior permission from NetAlter, where permission always refers to request and subsequent license grant from NetAlter. The collaboration is aimed at upgrading existing module being subjected to service modules standards for better resource planning and utilization thereof, also ensuring Service Compatibility, Scalability, Interoperability, service Specialized, Standardized and duplicate development deterrent as per NetAlter Service Module Factory Standards.

In an another constructional embodiment of the present invention the system comprises of NetAlter Service Provider (NSP) acts as a means to formulate logical as well as physical grid framework in terms of development of Domains or Networks or Network Layers & Levels as per Network Topology and Models by means of Network Factory Service Module Standards output whereby attain Network Automation to manage life cycle of network.

The NSP is responsible for delivery of package keys and weighted service data to NetAlter Service Subscriber (NSS) i.e. user of NetAlter services wherein NSP does maintain multiple relationship with other channel node members in the TFHL model by means of information access and subsequent rights granted in the form of package keys, in the same relation the services are provided by means of service module developed by NSMDs the same being accessed by NSP in the form of product keys from the NSMD. All the control functionality imparted to NSP in the form of Provider Active NetAlter Service browser being licensed from NetAlter by means of browser product key.

The NSP consist of active control functionalities comprising of NSMD List tracking and management of the same also keep track & control of publisher and Distributors of related & interested services, issue package keys to NetAlter Service Publishers (NSPB) & NetAlter Service Subscriber (NSS), collaboration permission grant, multiple network or domain management in the grid with varied field specificity and location specificity, and keep in touch with NetAlter upgraded facilities in all regard to enjoy new versions of browsers, attach utilities and related upgrades and updates brought into the system by NetAlter also alters discrepancies and/or quality, standards devaluation of NetAlter.

The Provider active functionality consist of NSMD List Tracking and Management carried out by means of download of required Service Modules, utilities, upgrades, updates and new versions from desired NSMDs and same being communicated via set protocols for requests of product keys as well as to carry out network or domain expansion demands in the grid for licensing on NSMD side from NSP. The product key is also put on request in case of collaboration is planned by all involved parties in the venture of distributed grid formation.

The Provider active functionalities consists of tracking tool for NetAlter Service Publishers (NSPB) and NetAlter Service Distributor (NSD) of related & interested services, issue of package keys to NSPB & NSS and rank or weight data to easing accessibility of NetAlter Service Subscriber and all involved therein and the same is communicated by all possible communication means comprising printed format, in the digital format, email, SMS, MMS, telephonic means, fax, paging services and voice mail.

In an another significant NetAlter specific embodiment of present invention, the active functionality of collaboration foster the venturing efforts by means of collaboration permission grant by means of set protocol to see grid framework to grow in desired way for the same all parties need to grant permission to collaborate in all possible ways. e.g. consider a global case where in there exists two distant providers with similar interests and areas (subjects) of providers in any location in the world needs to exchange their services to better prospects, the same being made possible by means of grant of permission in terms of license key from NetAlter. Similarly such other collaboration efforts are being fostered at all level of operation including Subscribers, Developers and other channel members. For this matter of fact, the controlling authority is always the one which reports to its superior control in the TFHL model. Thus, insuring scalability as well as network relationship alterations track.

Again in another respect of present invention to control scalability of network, the Provider active functionality tool for framework development consist of network life cycle Managers (providers), provide regularity and management feature for regulation and growth of the same by means of multiple network or domain management in the grid with varied field specificity comprising all the potential information rich subject areas of interest also location specificity is managed by means of collaboration, syndication, merger, reduction and/or division of the same and/or formation of new network to expand or reduce field specificity by means of set protocols.

The information management at NetAlter Service Subscriber end consists of NetAlter Service Subscriber tool referred to as NetAlter Service browser with subscribe active functionality (Subscriber Active), this management tool enable performing activity as per available Attributes in the network, for the same Subscriber does obtain product key from NetAlter along with identity registration for maintenance of democratic environment of the NetAlter Framework wherein the same tool comprised of multi administration support irrespective of user's multiplicity.

Again in similar aspect of scalability of present invention matter of NetAlter framework NetAlter Service Subscriber been put at advantage to grow its own relationship network preserving all relationship contexts for the management of the same and also managing of expansion with other prevailing relationship network in same or other domains along with deserving every right to keep relationships within its private custody i.e. can block others from learning its relationship so as to maintain secure, personalized and trustworthy operations as a part of grid at large.

Accordingly the NetAlter Service Subscriber can manage its own Personal portal being managed by means of effective defragmentation of Administrative rights to manage user personal network relations and data whereby additionally provided with full personal customization facility referred to as personal portal and management of the same by means of personal server.

The Subscriber Active Rights aimed at sole feature of community and plurality of interactive group development activity keeping view of all possible relationship dynamics arising out of human factor at large to develop plurality of personal network by means of Subscriber (explorer) and/or Personal Portal & Personal Network Creation Wizard. e.g. consider a case wherein a certain individual being subscriber of NetAlter services has opted for Job and dating services offered by one or more Providers, thus can manage all related to its attributes i.e. job & dating into the network also enjoys active interaction with other peers in the network, can manage data, join desired interested community, form circle, join other circles, can share and exchange data with other peers in the network. Similarly such an individual can be a part of scientific community can manage its research and share and exchange views and data with other peers, also identification and searching and matching of peers and data is made possible by NetAlter Service browser.

Thus as apart of initialization effort to enjoy NetAlter Services the NetAlter Service Subscriber starts its activities over the NetAlter grid alternatively with the guided tool of Personal Portal & Personal Network Creation Wizard which help personalize the portal wherein the wizard adopts step by step approach to personalize the portal in which broadly nine (9 nos.) steps are carried out the first one being registration of the NetAlter Service Subscriber with NetAlter, the second asks for filling up of survey form which includes Subscriber's preferences and personal information, the third step provides the holistic view for the selection of the available Subscriber active both trial & registered service modules, applications & utilities in the categorized list format sourcing from multiple NetAlter Service Developers and their respective NetAlter Service Distributors which ultimately based on the search & filtration being carried out and also asks for product configuration details e.g. no. of system users opted for, no. of browser's members opted for etc., the fourth step provides the categorized list of services from multiple NetAlter Service Providers and their NetAlter Service Distributors, the fifth step ask to choose amongst the already established personal network or circles to join as per Subscribers interests, the sixth one inform the Subscriber regarding the usefulness of the resources offering for peer to peer file sharing, data sharing & synchronization and communication and the same being asked to choose from according to dynamic resource requirement of the Subscribers, the seventh step providing option for computational resource offering for background search and other program execution wherein the same being asked to choose from according to dynamic computational resource requirement of the subscriber, the eighth step ask to choose from various exclusive NetAlter Services like auto-matching, searching, identifying, and brokering services and the ninth one instruct the Subscriber to set up the browser as per suitable requirements for fully personalized operations.

NetAlter grid Framework is fully customizable at all levels wherein every opportunity is being provided to build customized service portals & networks and management of the same by means of functional rights bestowed therein and/or by means of service portal & network creation wizard.

The NetAlter Service Providers can create service portal by selective identification of NetAlter wide NetAlter Service Subscribers of the same so as to institute a network irrespective of location of the NetAlter Service Subscriber wherein the intended provider being guided to choose from the presented parameters to so as to customize the service portal & network thence adopts step by step approach to create the service portal in wherein plurality of broadly eight (8 nos.) steps are carried out the first one being registration of the intended NetAlter Service Provider with NetAlter, the second asks for filling up of survey form which includes NetAlter Service Provider's preferences, the third step provides the holistic view for the selection of the available admin active service modules, applications & utilities in the categorized list format sourcing from multiple NetAlter Service Developers and their respective NetAlter Service Module Distributors which ultimately based on the search & filtration being carried out and also asks for product configuration details e.g. no. of sub domains, no. of branches, no. of users opted for, etc., the fourth step provides the categorized list of related NetAlter Service Providers from multiple networks for collaboration request, the fifth one inform the NetAlter Service Provider regarding the usefulness of the resources offering for peer to peer file sharing, data sharing & synchronization and communication and the same being asked to choose from according to dynamic resource requirement of the NetAlter Service Provider, the sixth step providing option for computational resource offering for background search and other program execution wherein the same being asked to choose from according to dynamic computational resource requirement of the provider, the seventh step prompts for selective searching & filtering of the NetAlter Service Publishers and same being communicated across and the eighth one instruct the NetAlter Service Subscriber to set up the browser as per suitable requirements for fully personalized & customized service portal operations.

The Subscriber maintains direct relationship with NetAlter so as to globally publish its content via NetAlter being laid to NetAlter's desertion/approval. Also the NetAlter Service Subscriber has active interaction with NetAlter Service Module Distributor and NetAlter Service Provider as well as NetAlter Service Distributors and NetAlter Service Providers for information newly available, alert services, new modules arrival, free/trial services etc. broadly speaking subsection channel node member has multiple access points to avail services.

In an another preferred embodiment of the present invention, the NetAlter Service Module Publisher (NSMP) being certified by NetAlter module developers maintains list of NetAlter Service module Distributors (NSMDI), NetAlter Service module Developers, NetAlter Service Providers and NetAlter Service Subscribers to help manage the operations at both the ends of information supply chain and has been conferred with control over network being targeted to foster information utilization till the node where information being consumed.

In the developmental aspect of NetAlter framework the NetAlter Service & Service Module Distributors (NSD & NSMDI) are being certified by the respective NetAlter Service Publisher wherein the NetAlter Service Distributor is instrumental at Distribution of the services at NetAlter Service Subscribers' end and means for supply of information products in terms of NetAlter Services to the NetAlter Services Providers and/or to the NetAlter Service Subscribers along with Distribution of the same by means of package key whereas the NetAlter Service Module Distributor are means for Distribution of NetAlter Service Modules to the NetAlter Service Provider and/or to the NetAlter Service Subscriber along with Distribution of the same by means of product key.

The data management aspect of all NetAlter Framework's channel nodes at large is carried out in the form of peer-to-peer data sharing & synchronization, files sharing and communication which are centrally being controlled by NetAlter coordination and discovery server services and referred to as constant interaction defined by “Direct Approach”.

In an another significant aspect of the present invention, the trust and security is guaranteed for visualizing the feasibility of data exchange and to maintain democratic information Distribution, seeking & computational environment all NetAlter Framework's channel nodes are entitled to sign an agreement with NetAlter coordination and discovery server services for computing resources offerings so as to enable interaction and communication between nodal members in as secure manner by attaining end to end automation for data exchange in fully encrypted format and all operation performed by browsers being monitored and kept under check by means of identity check by NetAlter.

The NetAlter Framework renders complete end to end automation essentially means to manage the Network Development Life Cycle (NDLC) refers to any sort of alteration in the NetAlter network at any channel nodal member in an unattended mode of operation i.e. automatic and the said automated operation being governed by the Distribution of product and package key on the basis of predetermined criterions like nature of agreement, associations, relationships, etc.

Accordingly, the complete automated operations of NetAlter Framework is instrumental at performance of certain essential functions deemed to carry out in unattended mode e.g. means for duplication detection, synchronizing of data, updates, upgrades, error reports, log reports, name space resolving and building, system level connection parameters, etc.

In another preferential embodiment of present invention, the NetAlter system enables its functionality in the form of Rich client and Connected System operability. NetAlter framework is being designed to take into consideration the future technologies and the present requirements of the users to have information services as per their comfort i.e. service oriented architecture along with all taking into consideration all possible variations.

In the continuous efforts to overcome major flaws with prevailing networks framework whereby present web framework fails to give access to personal & private databases or information likewise data from multiple sources, compatible services, one single interface, and data delivery platforms. Peer to peer and grid computing do overcome one or the other flaw but in a restricted format. On the other hand prevailing frameworks lack of immediacy, Transaction, Localization, and Disconnectedness, Continuous synchronization for real time.

The solution to this is proposed in terms of rich client enabled technology by means of NetAlter system which enjoys features like visual interface, local processor & memory usage, device attachment, multiple application integration, faster refresh rate, operating system benefits etc.

Rich client applications deliver the best of both worlds, combining the reach of the remote computing with the power of local computing hardware. Likewise performs background multi tasking, queuing task, mass processing, Responsive, Flexible, High developer productivity due to mass development and languages for rich clients, Voice enabled application, Security level customization as per requirements, multiple version of application for the choice of rich client, operational functionality with variety of smart targeting specific device, application auto updating. Also rich client provided with Interactive, Multimedia, 3D, fewer user error, Auto complete, and Combo navigation.

Rich client being conferred better user experience with disconnected operability along with multi user functionality wherein data is continues synchronizing even after source is interrupted service mode (down) for some reason. Similarly rich client is provided with Undo, Redo, Context sensitive help, heavy data entry, act, Plan, Analyzer, Visualize, Explorer, Complexity functionalities.

Finally, the advent of Service Oriented Architectures (SOA) means that there are huge opportunities for client applications to be presented in standard way, which provides huge benefits in terms of interoperability, developer tool support, and the ease with which new features can be built into the rich client application. Though it is more of a concept than a real technology, NetAlter enables rich client to enjoy user specific architecture devised on service oriented manner.

Rich client enabled distributed grid computing confers following exclusive functionalities to users including

(1) Local Resource Utilization: Hardware to software resources. A rich client may take advantage of the local CPU, local memory or disk, or any local devices connected to the client, such as a telephone, bar-code/RFID reader, and so on. But it may also take advantage of local software, such as Microsoft Office applications, or any installed line-of-business (LOB) applications that interact with it.
(2) Connected: Rich client applications are never standalone and always form part of a larger distributed solution. This could mean that the application interacts with a number of Web services that provide access to data or an LOB application. Very often, the application has access to specific services that help maintain the application and provide deployment and update services.
(3) Offline Capable: Because they are running on the local machine, one of the key benefits that rich client applications offer is that they can be made to work even when the user is not connected. For applications running in occasional or intermittent connectivity situations, such as those used by traveling workers or even those running on laptops, tablets, PDA's, and so on, where connectivity cannot be guaranteed at all times, being able to work while disconnected is essential. Even when the client is connected, the rich client application can improve performance and usability by caching data and managing the connection in an intelligent way.
(4) Intelligent Install and Update: Rich client applications manage their deployment and update in a much more intelligent way than traditional rich client applications. Applications can be updated while running and can be deployed on demand by clicking on a URL.
(5) Client Device Flexibility: Today we live in an information-based economy. In order to thrive in this hyper-competitive market, users must access and borrow information from many sources, including customers, partners, and suppliers. In addition, users are now demanding more from their applications, they want to be empowered to act, plan, analyze, visualize, and explore the data, not just to read it.

This vexing concern is looked in by way of proposition of Service Oriented Architecture (SOA), for that matter a physical condition should be conducive to conceive and implement probable solution for that reason, herein in the present invention of NetAlter, this methodology is being addressed in terms of physically feasible logical framework creation for rich client Technology to work on this. As a matter of fact, herein efforts are being made with respect to restructure the framework than the repairing the existing component. This can be analyzed this way like if road is not good enough, the initial approach to troubleshoot this problem of transportation is to construction of better roads not to design better vehicle.

Similar problem is existing with present network based communication models, as mentioned in prior art the bug is into the communication infrastructure than the technologies to tackle them. Thus, NetAlter provides better infrastructure to make rich client a reality.

In an yet another preferred embodiment of present invention, the error report generation is being automated by means of error detection algorithm in case of any bugs and/or functional level error and same being reported in terms of error report to respective developers.

In an yet another preferred embodiment of present invention, the log report generation is being automated by means of updating the usage data of one TFHL level of operation to its respective higher level in terms of log report and same being generated for activities performed, date, levels and user status.

In an yet another preferred embodiment of present invention, the name space resolving and building is being automated by an instrument of name space developer and resolver and the same being made available to detect the desired sources.

In an yet another significant embodiment of the present invention, automation into the network operation has been extended so as to automate all application & operations in end to end manner, as NetAlter being based on concept of SOA, simulates the present most successful model of SOA i.e. basic telecommunication network wherein service is being made available only on request. On the contrary telecommunication network being physically laid hence fixed in nature and takes awesome efforts to any kind of change in connection, this lacuna in telecommunication system is successfully overcome in an NetAlter system by means of end to end, secured full automation whereby any change in connection (joining, disjoining) is automated within few clicks of mouse.

Following are advantages accomplished by embedding a directory service within SOA
(1) Scalability of services; you can add services incrementally.
(2) Decouples users from providers.
(3) Allows for updates of services.
(4) Provides a look-up service for users.
(5) Allows users to choose between providers at runtime rather than hard coding a single provider.

Managing SOA includes many functions, including:
(1) Security: Authorization of the request, encryption & decryption as required, validation, etc.
(2) Deployment: Allowing the service to be redeployed (moved) around the network for performance, redundancy for availability, or other reasons
(3) Logging: For auditing, metering, etc.
(4) Dynamic rerouting: For fail over or load balancing
(5) Maintenance: Management of new versions of the service

NetAlter is an architectural style whose goal is to achieve loose coupling among interacting connected members in the framework. A service is a unit of work done by a service provider to achieve desired end results for a service user. Both provider and user are roles played by browsers on behalf of their owners

A Service Network is an application level network that leverages a Service Oriented Architecture. The Service Network is composed of a number of Service Network Participants and many Services.

A Service is a callable routine that is made available over a network. Services have well defined interfaces (inbound & outbound) which further provides.
(1) User Interaction: Being able to provide a single source, interactive user experience
(2) Application Connectivity: Communications layer that underlies all of the architecture
(3) Process Integration: Choreographs applications and services
(4) Information Integration: Federates and moves the enterprise data
(5) Build to Integrate: Builds & deploys new applications and services.

Also the NDLC being automated for unattained and secured management of any sort of the procedural changes being carried out at two independent stages of operations defining NDLC at large. In the first stage scalability of network e.g. development (growth) and/or reduction is being carried out whereas the second stage refers to the management stage of NDLC essentially meant for running maintenance of NetAlter wherein management functionalities refers to all sort management of all parameters related to all NetAlter members e.g. record keeping, changes and/or alterations management, security management, keys management etc.

With respect to Metcalfe's Law of statistics related to network growth and reduction, wherein it is perceived that total value of a communication network grows with the square of the number of devices or people it connect. Thus, in an another preferred embodiment of present invention, the communication network is being crafted in such a logical manner as to improving upon person to person interaction at larger extent also enabling of advance digital gadgets into the communication channel with respect to service oriented architecture and embedded applications enabled smart devices into the said communication network of NetAlter also in an another aspect of the present invention, group forming capability due to clustering approach of this distributed network wherein the connectivity and relationships into the network grows in an exponentially defined manner, hence the value of communication network determination by Metcalfe's law is validated by NetAlter framework.

In an another prevailing problem with the present communication networks wherein according to Metcalfe's reverse Law the clustering of the presently widely grown network do stage a risk of demeaning the value of the network by 1/Nth of the network with N no. of connected nodes in the network. According to system & method of communication network development, this problem won't arise in the present invention wherein the infrastructure being formed in distributedly integrated manner, it is uniformly available through out the world, forming greater interconnections in spite of distributed environment operations.

In an another important embodiment of the present invention, the control mechanism to made NetAlter networks scalable and let every member of it exploit it to their convenience and advantage is worked out by an instrument of “control keys” namely product and package keys wherein the authority to regulate and deliver respective keys has been conferred on concerned parties.

The horizontal scalability in this regard essentially refers to major alterations in the network and/or domains like collaboration, merger, acquisition, division and shifting with relation to horizontal alteration into the networks being essentially NetAlter Service Provider specific functionalities to perform the said operations by means of an instrument of product keys whose Distribution being controlled by NetAlter Service Developer.

Similarly, the vertical scalability essentially refers to alterations in the networks domains, sub-domains and any further branch like and/or nodal level changes in the intended areas of operations. Likewise, the vertical alterations being controlled by means of an instrument of product as well as package keys wherein all functional NetAlter nodal parties being NetAlter Service Provider, NetAlter Service Subscriber and/or user of the same. e.g. Simulation of Scalability: NetAlter being aimed at global community development for all possible purposes, in an global perspective consider a situation wherein there are people interested in certain specific subject lets say politics in different part of the world, in the nutshell people generally keep in touch at local level, this activity is made possible by NetAlter local network creation by means of Subscriber, in the same local network is scalable wherein anybody with NetAlter Service Subscriber join the network or get out of the network to join some other network of choice. Likewise, such networks around the world can be joined by user, wherein if specifically any user is interested in any particular subject can form own network. Thus, there can be various sub networks like British politics, Federal politics, international politics, local politics, etc.

Subsequently down the line, there can be a person who is holding useful information contents, would rather be enjoying the usability of NetAlter Service Provider to further the scalability operation. Similarly, there can be multiple providers, which can merge, collaborate or share data of interest thus defining horizontal scalability under master control of NetAlter wherein all of the above stated act can optionally be one way or two ways, for limited period, and with or without horizontal and/or vertical data filtering. In addition, any of the horizontal alterations essentially needs to obtain permission in terms of product keys from the respective developers.

The NetAlter network realizes SOA wherein the services are accessed by end user with the help of NetAlter Service Subscriber. Service modules are availed by users/subscribers in an unlimited manner, also Provision for a product keys are made wherein the single product key represents a multiple set of related service modules to form a bundle from multiple independent NetAlter Service Developer transacted syndicatively to respective NetAlter Service Developers.

In addition, services are made available by means of NetAlter Service Providers wherein users thereof subscribes to services on the basis certain criterions as to no. of entries, duration and services involved therein.

In addition, services are made available by means of NetAlter Service developers wherein users thereof subscribes to services modules on the basis certain criterions as to No. of system users, no. of entries, no. of languages, no. of service module clients e.g. online, offline, mobile etc., no. of members and volume licensing parameters involved therein.

In an another important embodiment of present invention, SOA takes care of delivery of services as per requirements, essentially affordability and needs are determined by no. of entries, which is the essentially a NetAlter Service Provider specific tool wherein access permission has been granted by NetAlter Service Providers is based on the requirements of the NetAlter Service Subscribers in terms of volume of data contents wherein for the same matter variety access levels has been defined by the NetAlter Service Providers.

In an another significant and essential embodiment of the present invention, with reference to prior are NetAlter framework realizes distributed network concept wherein integrity of distributed entities is visualized in terms of robust and logically segregated divisions known as clusters which ensures a framework with highly organized distributed networks i.e. networks' network. Wherein all the connected nodes works in distributed environment in an organized manner and seek & keep tracking information distributedly on the module basis.

The distributed organization impregnated with logical clustering add granularity in searching and matching approach by carrying out distributed searching & matching to carry out real time and active as well as background searching through distributed networks individually as well as through centralized NetAlter server.

The granularity in searching approach is enabled by four tier searching with the help of depth based searching on four tier searching wherein requirement of the user along with affordability defines the depth of search wherein user searches and/or matches through personal network as first granular level, searches and/or matches through local network as second granular level, searches and/or matches through desired distributed Providers as third granular level, and searches and/or matches through global NetAlter Auto-match Architecture (AMA) & search engine as fourth level of granularity.

Hitherto, it has been a contesting issue as to devise best method of searching. In an another significant proposition NetAlter conceptualizes that prevailing issues in searching essentially related with internet talks of searching something through in highly unorganized format of data. On the contrary better organization of the similar information helps utilize and optimize existing searching tools wherein search solution is generated by means of already indexed data into the distributed systems wherein the same provides real time, reliable as searching & matching results comes from like-minded peers over distributed network.

In addition, such an organization insures secure searching and matching by means of identity maintenance of every connected channel node whereby searchers can always get to know about root source of the information thence in terms of namespace a feature analogous to domain name. The data through out the NetAlter framework is relationally arranged, searching experience is as good as local database searching, wherein command based search is made possible and referred to as power searching which confers freedom to carry out granular search by means of searching in any of the identified part of the NetAlter framework.

In an another aspect of search capabilities of NetAlter framework searching & matching is carried through by means of cache searching wherein similar searched and/or matched results if any prevailing in the searched and/or matched member's system is provided at in real time for quick results whereby again saving on the computational power of the NetAlter distributed framework.

In an another aspect of search capability of NetAlter, four granular level searching is meant to conduct global search with distributed NetAlter Service Providers and the same being delivered over NetAlter framework by means of metadata of the searcher.

In an another aspect of search capabilities of NetAlter framework, the search & match methodologies are devised to improves upon the relevance level of the searched and/or matched queries up to highest possible relevance level by means of processing the keyword, range, and natural language queries in duly specified locations based on the modules wise segregation of the data contents which restricts the unnecessary searching efforts.

In an another embodiment of present invention, the objective of global community development is achieved, though keeping distributed environment divided in terms of clusters and contents being segregated on the basis of modules provides enough possibilities to identify peers of interest in much simpler and faster way whereby achieve social community development through NetAlter Framework.

In an another significant aspect of search capability of NetAlter framework the searching and matching are carried out by means of background search where in the searching & matching algorithm works as a auxiliary threads on the host computing platform being working in multithreading and multitasking environment over the distributed NetAlter network whereby conferring time schedule for information resources as well as save back ground computing resources at large. This tool enables user to schedule the operations and keep updated about any of the changes taking place in desired subject of interest.

In an another significant aspect of search capability of NetAlter framework the matching mechanism termed as Auto Match Architecture (AMA) is bestowed at user functionality to add yet another significant searching feature wherein matching is carried out at local i.e. personal network, local network, global as well as intended network unilaterally as well as bilaterally to match the queries.

A unilateral AMA is the means to match the query in one direction only wherein queried criterions of searcher are essentially matched with the existing data in the network with desired granularity i.e. personal network, global or desired network locations. Whereas bilateral AMA is the means to match the query in bi directions wherein queried criterions of searcher essentially matches its own data specification i.e. attributes identified on the network with the existing data specifications throughout the network with desired granularity i.e. personal network, global or desired network locations. In an essence of social community development, this again acts as a significant searching tool to reach up to desired peers, or the information of interest if any.

In an another significant embodiment of the present invention, the interactive digital media is being formulated and automated to provide direct approach interaction wherein interactive parties are always in close proximity to each other by an instrument of service explorer wherein searching & matching methodologies are being provided at both the ends in the form of distributed searching in peer to peer environment.

The direct approach concept applied herein refers to the facility of communication conferred by NetAlter with its users whereby seekers can always keep track of suppliers and likewise suppliers can keep track of potential seekers so that seeker are always presented with variety of sources which is essentially acts as means to curb monopoly into the NetAlter Framework.

Extending to this fact that grid is a promising e-Science infrastructure that promotes and facilitates the sharing and collaboration in the use of distributed heterogeneous resources through Virtual Organization (VO). A critical factor to the overall utility of Grid is a scalable, flexible and robust registry (inventory) mechanism. Although it provides some mechanisms to store and access metadata for publishing and discovering resources, such as MCS (Metadata Catalog Service).

To enhance these very critical factors, grid systems needs revision in terms of its constitutional construction, present invention of NetAlter architecture enhances the use of registry approach in which registry of every connected node and relates logs are being maintained.

The NetAlter framework works in distributed environment wherein large number of computers of wide ranging locations and often disparate natured computers are deemed to utilize computer processor time and/or unused storage for dynamically needy user by mean of demanding contributions of local computer system's computing resources to carry out functionalities it has been conferred with whereby the distributed computing resources acts in distributed grid computing environment to form collectively distributed supercomputing platform.

The computing resource contribution by each connected node in the NetAlter grid has been determined to be a function of that specific node's information and other related requirement, which ultimately takes care of affordability of each user. Thus, computing resource offering dynamics defines relation of per percentage contribution to reception of the same services in that regard.

The resource offering dynamics has got significant role to play to define global computing capability of NetAlter supercomputing framework deemed to work in distributed environment. The local contribution as per cluster segregation provides equal computing characteristic feature.

With regard to grid supercomputing mentioned in the art, processing power or per cycle power of idle distributed processors utilization has been practiced, wherein the flaw in the earlier system in relation to contracting systems for dedicated operations (mostly scientific) is overcome by means of default marginal resource offering by an every connected system as per its own information requirements. Thus allowing every member to access to NetAlter supercomputing capabilities in all regard.

The distributed grid supercomputing is achieved by means of uniform applications running in distributedly layered manner wherein collective computing resources allocation by all connected channel node members in grid increases with increases in layer status e.g. field, location, network, domain, sub-domain, entity and attribute and the same being mapped with respect to usage at large. e.g. considering 100 nodes offering its resources at personal network layer in 10 different areas lets say 10% per area so at global level at any particular point of time total resource offering of the same user in the specified area will be accordingly be some fraction of contributed percentage.

The distributed grid supercomputing logic works on multiple cluster formation of users on the individual computer system with regard to data devoted to variety of fields wherein computational resource sharing from individual nodal member system has been governed by NetAlter. Thus, the distributed grid supercomputing is essentially means for personal super computing wherein users are being conferred with supercomputing capabilities at its end.

The clusters in NetAlter distributed grid supercomputing is partitioned on the basis of logical divisions in terms of

### 1. Field

### 2. Location

### 3. Network

### 4. Domain

### 5. Sub-domain

### 6. Entity and

### 7. Attribute

In the global perspective logically what we deal with in general is the subject matter represented by “Field”, the same subject matter may represent multiple variety of “locations”, such that within any location there exists multiple networks dealing with multiple variety of subjects which again forms a part of other “fields”, in addition within a network there can be multiple domain and likewise domain constitutes of multiple sub-domains wherein there can be users with in such a sub-domain representing “Entity”, having multiple attributes of its own managed on a specific computing platform with the help of NetAlter Service Subscriber

This logical segregation and integration in turn is carried out with the help of NetAlter Service browser which provides every entity with certain flexible and varying attributes e.g. attributes can be like a entity can subscribe to certain services as to job, dating, business, matrimonial etc. so accordingly bears attributes as age, qualification, experience, field of business, & income or annual turn over etc. respectively. To exemplify cluster feature further, consider a following indicative illustration:

### Field: HR (Human Resource)

### Location: India

### Network: Jobs

### Domain: Job_Provider_One

### Sub-domain: Job_Provider_Branch_One

Entity: Mr. ABC

### Attributes: Job_Seeker_Resume

Similarly, multiple fields are distributes in multiple locations and yet further into multiple domain and/or sub-domains representing different, multiple individuals being part networks at large. Wherein an entity can always be traced down to its roots with the help of namespace thus generated. FIGS. 20, 21 & 22 shows a logical block diagram of NetAlter Framework's Visual Map for management and Namespace to identify each item of NetAlter; whereas FIG. 23 shows a logical block diagram of Logical relationship of all NetAlter Framework's Channel nodes; the logical clustering is illustrated in FIG. 24 represents a logical block diagram of NetAlter computing, info or data or service, application, peer to peer and Grid cluster logic.

With reference to FIG. 20 which is showing derivation and representation of NetAlter Namespace. The NetAlter Namespace is an unique identifier to identify each user within the NetAlter Framework and this identity made up of different optional parameters. There are different types NetAlter Namespace some of the example are (20M.1) For NetAlter Service Provider & Subscriber, (20M.2) For NetAlter Service Developer, (20M.3) For NetAlter Service Module Publisher & Distributor and (20M.4) For NetAlter Service Publisher & Distributor. All these NetAlter Namespaces consist of one or more optional parameter.

In an illustration to derive NetAlter Namespace represents initial Namespace parameters for (20M.1) NetAlter Service Providers & Subscribers which starts with Root the first which indicate the top most node i.e. (20A) NetAlter itself. The second parameter in NetAlter Namespace is Field which indicate the Subject Area say (20B) HR (Human Resource). The third parameter in the NetAlter Namespace is Location i.e. geographical area say (20C) USA. The fourth parameter in the NetAlter Namespace is Network i.e. topic of subject area say (20D) Job is topic for HR subject area. The fifth parameter in the NetAlter Namespace is Domain i.e. name to identify Service Provider say (20E) Domain B. The sixth parameter in the NetAlter Namespace is Sub Domain i.e. name to identify Service Provider's Sub-Domain say (20F) Sub Domain W. The seventh parameter in the NetAlter Namespace is Branch i.e. name to identify bottom most node in the Domain say (20G) Branch 100. The eighth parameter in the NetAlter Namespace is Service Module i.e. name to identify Service Module say (20H) Resume Tracking. The ninth parameter in the NetAlter Namespace is Service i.e. name to identify Service which is used or subscribed by the user i.e. NetAlter Service Subscriber say (20I) Permanent Job. The tenth parameter in the NetAlter Namespace is Entity or Item i.e. name to identify NetAlter Service Subscriber who is using or subscribing the services say (20J) Employer. The eleventh parameter in the NetAlter Namespace is Attribute i.e. name to identify NetAlter Service Subscriber's requirements who is using or subscribing the services say Employer's require service for (20K) Job Posting. The twelveth parameter in the NetAlter Namespace is Information used to indicate the information regarding NetAlter Service Subscriber's requirements who is using or subscribing the services say Employer's provides (20L) Information for Job which they are Posting.

On statistical ground the distributed grid supercomputing strength (power) depending on processing cycles available for operations (computation) in the network wherein computing capability is in direct proportion with no. of computers and can increase and/or decrease as per grid development to any extent in equal proportion. Variably, supercomputing capability being a function of no. of computers in the grid and hence in turn of processing power (cycles of operation per second) and other resources (memory) to that matter.

On the similar lines, the present invention of distributed grid supercomputing, explores computing resource utilization options in grid rendered by means of different ways namely reservation, sponsoring, on demand, balancing, private, available and dynamic resources etc.

The automation in NetAlter distributed supercomputing grid in addition offers certain features as to self configuring, healing, optimizing & protecting, auto-accounting, secure, reliable, democratic, and scalability attainment.

In an another significant embodiment in relation to security aspect of the present invention, reliable communication framework is insured wherein reliability is gained by means of tested identity and reputation of every entity, every party being verified & certified, higher level data authenticity being maintained, censored contents, virus immunized, duplication deterrent, updated by means of junk data deterrent, information being revised & verified.

On the similar line, the credibility factor is most soughed after information access demand feature till date the world over and same not being address in concrete terms to supplement cyber laws in data corruption and similar other problem areas in existing networks. In an NetAlter framework same insured wherein credibility is ensured at all levels of operation by means of namespace resolver feature which helps track and monitor the source of data all the time by means of Active rights supplemented therein.

In an holistic terms security in all regards is ensured by various technological advances as well as framework logic wherein the security is being imparted by means of activity specific browser which imparts the activity specific administrative rights whereby insuring the user's secure operation over the system both online as well as offline operation mode, certified & authenticated means for utilization also by means of virus deterrence, spam free operation, encrypted data transfer format and every channel node member being completely identified on the network insures secure operations.

In an another significant embodiment of the present invention, the NetAlter framework is interoperable communication framework wherein the all kinds of browsers are being provided with cross layer communication whereby enabling internetwork & intranetwork, interlayer & intralayer, interdomain & intradomain, interfield & intrafield, and interlocation & intralocation operability as per user preference.

In another important embodiment of the present invention, the very requirement of the today's information society which demanding knowledge oriented contents is fulfilled by NetAlter framework. The very flaw with interne framework been is garbage data contents and hence the tedious searching is over come herewith much researched authorized and ranked data contents by means of all NetAlter Service Providers being certified by NetAlter. The information & data contents are value added to meet the NetAlter quality standards causing the system to provide researched contents to users at large.

Thus, in an integrative embodiment of the NetAlter framework the system is presented as federal, collaborative & syndicative and democratic communication framework wherein the system framework being logically obtained to represent global community in specific user respect whereby forming a communication network with NetAlter as a supreme governing authority and bestowing rights to collaborate, syndicate in a democratic way on the part of other channel node members.

The activities over the NetAlter network are carried out at all levels by means of respective NetAlter service browser activated according to functionalities bestowed therein by means of product key from NetAlter which provides explorer for all operations of the system wherein the said service browser is functionality specific and comprises plurality of control and administrative abilities including NetAlter Active, Developer Active, Provider Active, Subscriber active, Service Module Publisher & Distributor Active, and Service Publisher and Distributor Active service browsers.

NetAlter being supreme central administrative authority bears functionality referred to as NetAlter Active wherein all operations of NetAlter are carried out by means of explorer of the same which comprises of management functionalities in relation to other NetAlter channel node members to confer it tracking rights for administration of every piece of activity over the network by means of division of activities from top up to the channel node member of interest likewise maintains updates of every single parameter change in the NetAlter system Framework at large including data related to Global NetAlter Service Providers, Global NetAlter Module Developers, Global NetAlter Service Module Publishers, Global NetAlter Service module Distributors, Global NetAlter Service Publishers, Global NetAlter Service Distributors, and Global NetAlter Service Subscribers.

Similarly, the Provider, developer, Subscriber, Service & Service Module Publisher & Distributors active browsers has limited administration functionality (rights) referred to as respective functionality browser application wherein all operations of NetAlter Service Provider are carried out by means of explorer of the same which comprises of management functionalities in relation to other NetAlter channel node members to confer it tracking rights for administration of every piece of activity over the network by means of division of activities from top up to the channel node member of interest likewise maintains updates of every single parameter change in the NetAlter system Framework at large including data related to Global NetAlter Service Providers, Global NetAlter Module Developers, Global NetAlter Service Module Publishers, Global NetAlter Service module Distributors, Global NetAlter Service Publishers, Global NetAlter Service Distributors, and Global NetAlter Service Subscribers.

With NetAlter system & Method users are conferred with all chances to implement the same logic and technology to devise and apply new dimensions to all existing business practices wherein the said system traces all untapped and unutilized resources and optimizes the usage of the same.

In another preferred embodiment of the present invention, with reference to DR. Collin Evans, director system software lab, Intel, the future technologies are aimed at developing digital & software application wherein the Powerful PCs are deemed to become users' digital world therein.

The present invention of NetAlter take into reality the above said concept wherein the said system operates on all smart devices including all communication devices, household appliances, logistic applications etc. by means of embedded framework for interaction involved therein. The embedded component engraved therein is a light weight customized application, that makes the NetAlter system to install on any of the electronic gadget whereby allowing users to access the NetAlter services as per electronic virtues and capability of the instruments including the devices like medical devices, robotics, office & industrial automation, television, Set-Top-Box, retail point of delivery, palm top, mobile phone, game platform, network devices, Gateway/media store, kiosk/ATM, LOB thin client, camera, watch, fridge, audio-video devices, hand held computers, etc. Also the communication logic insures bridging of the user devices and servers, so as to carry out the remote functions at user terminal device by means of embedded functionality provided therein.

Thus, the embedded functionality to enable communication at user electronics devices in real sense illustrates the NetAlter commitment to communication and computation convergence.

The method and system for alternative communication being based on distributed technology with granularity involved therein at least with two computing and/or communication platform to N nos. of the same whereby applicable in all issues involved and therein the life and communities and/or group of the same at large e.g. Village or City, Club, Association, Trust, Friend, Political, Government, Religion, Employer/vendor/Recruiter, Job Seeker, Dating or Matrimonial, Business, Services or Professional, Customer, Student, Knowledge Management (KM) etc.

To summarize the global distributed supercomputing grid infrastructure's advantages, following are some of accomplishments NetAlter achieving to score over prevailing unorganized infrastructures

(1) Highly organize, Personalized, Direct Search & Grid Computing
(2) Identity-Trust-Matching & brokering services

### (3) Personal Portal

### (4) Service Portal

(5) Full features & growth supported
(6) Each step standard, security, automation & reduction (SM Factory)
(7) Redesign Internet, Business practices, Software development architecture, and Social networking including relationships etc.
(8) Universal Resource Planning/Universal application
(9) Fast Search & Matching, E-Commerce, social networking, application on demand etc.

### (10) Network of Network's Network (TFHLN)

(11) overcomes Digital divide
(12) Attract Non-Net, illiterate & village users (offline centers with smart solution and E-Commerce)
(13) Visual e-commerce

### (14) Community Resource Planning

### (15) People Relationship Management (PRM)

### BRIEF DESCRIPTION OF THE DRAWINGS

Further aspects of the present invention will become apparent from the following description which is given by way of example only and with reference to the accompanying drawings in which:

FIG. 1 shows a schematic block diagram of a preferred embodiment of NetAlter part of the present invention;

FIG. 2 shows a schematic block diagram of a preferred embodiment of NetAlter Service Module Developers (NSMD), NetAlter Service Module Publishers (NSMP), NetAlter Service Module Distributors (NSMDI) and NetAlter Service Publishers (NSP) and NetAlter Service Distributors (NSD) part of the present invention;

FIG. 3 shows a schematic block diagram of a preferred embodiment of NetAlter Service Providers (NSP) Network part of the present invention.

FIG. 4 shows a schematic block diagram of a preferred embodiment of NetAlter Service Browser (Subscriber Active) part of the present invention.

FIG. 5 shows a schematic block diagram of a preferred embodiment of NetAlter Service Browser (Provider Active) part of the present invention;

FIG. 6 shows a logical block diagram of NetAlter Framework part of the present invention;

FIG. 7 shows a logical block diagram of examples of NetAlter Provider Network Topology, Models and Levels;

FIG. 8 shows a logical block diagram of NetAlter Service Module Developers (NSMD), NetAlter Service Module Suppliers consist of NetAlter Service Module Publisher (NSMP) & NetAlter Service Module Distributor (NSMDI) as well as NetAlter Service Module Users consists of NetAlter Service Provider (NSP) & NetAlter Service Subscriber (NSS) which all in turn lead to the generation/creation of NetAlter Network Factory;

FIG. 9 shows a logical block diagram of NetAlter Service Provider (NSP), NetAlter Service Suppliers consist of NetAlter Service Publisher (NSPB) & NetAlter Service Distributor (NSD) as well as NetAlter Service Users consists of NetAlter Service Provider (NSP) & NetAlter Service Subscriber (NSS) and all of them interact using the NetAlter Service Browser.

FIG. 10 shows a logical block diagram of Auto Match Architecture (AMA) and Search Engine of the present invention;

FIG. 11 shows a logical block diagram of NetAlter Service Browser (NSB) (NetAlter Active);

FIG. 12 shows a logical block diagram of extended view of FIG. 11.

FIG. 13 shows a logical block diagram of extended view of FIG. 11.

FIG. 14 shows a logical block diagram of NetAlter Service Browser (NSB) (Developer Active).

FIG. 15 shows a logical block diagram of NetAlter Service Browser (NSB) (Provider Active).

FIG. 16 shows a logical block diagram of NetAlter Service Browser (NSB) (Subscriber Active).

FIG. 17 shows a logical block diagram of NetAlter Service Browser (NSB) (Service & Service Module Publisher & Distributor Active);

FIG. 18 shows a logical block diagram of NetAlter Framework all possible combinations of Peer-to-Peer Files sharing and/or Data Sharing & Sync. and/or communication among all NetAlter channel nodes.

FIG. 19 shows a logical block diagram of NetAlter Framework maximum possible combinations of Peer-to-Peer Files sharing and/or Data Sharing & Sync. and/or communication among all NetAlter channel nodes.

FIGS. 20,21,22 shows a logical block diagram of NetAlter Framework's Visual Map for management and Namespace to identify each item of NetAlter;

FIG. 23 shows a logical block diagram of Logical relationship of all NetAlter Framework's Channel nodes.

FIG. 24 shows a logical block diagram of NetAlter computing, info or data or service, application, peer to peer and Grid cluster logic.

FIG. 25 shows a logical block diagram of Information, computing, application grid automation as per grid topology models.

FIG. 26 showing graphical user interface (GUI) for NetAlter service browser explorer illustrating NetAlter search engine interface therein.

FIG. 27 illustrates layered diagram of NetAlter convergence platform describing plurality of technologies integration with functionalities and communication standards.

### DETAILED DESCRIPTION OF THE PREFERRED EMBODIMENTS

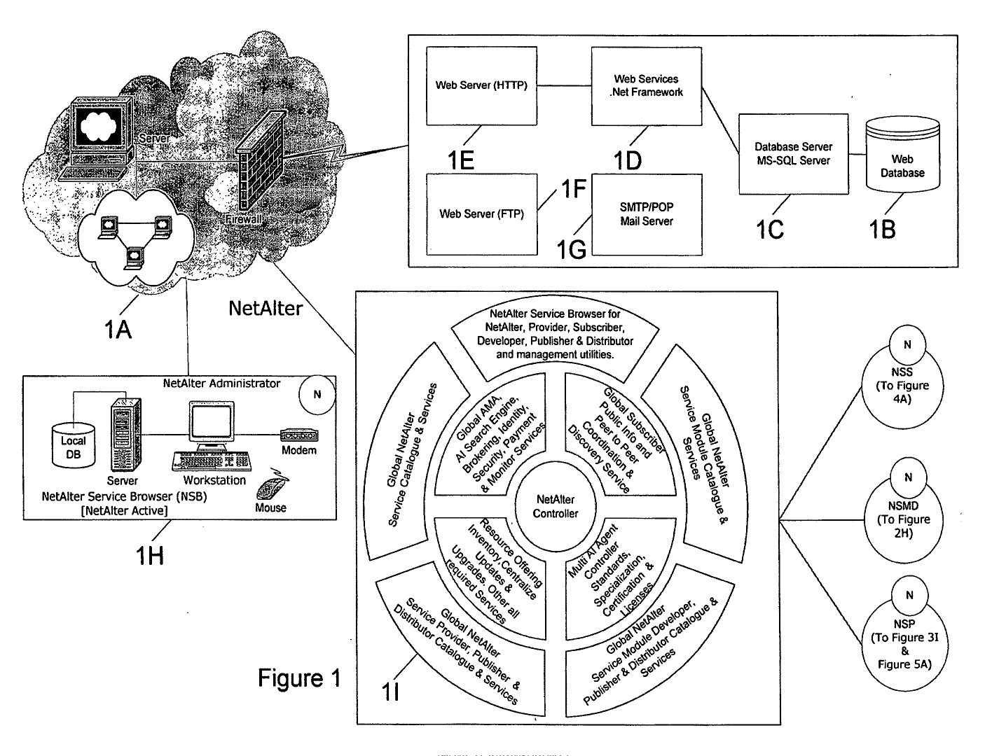

FIG. 1 shows a schematic block diagram of NetAlter providing broad view of working of NetAlter & its functionality.

(1A) shows a host computer, in the form of web server containing a cluster of servers and peer to peer coordination & discovery server, for (1B) hosting database e.g. (1C) MS SQL Server communicate via protocol e.g. (1E) HTTP using business logic which are in the form of web services e.g. (1D) .Net web service.

1I shows the broad overview of the functionality of NetAlter Controller which include i) NetAlter Service Browser for NetAlter Controller, Provider, Subscriber, Developer, Publisher & Distributor and management & other utilities, ii) maintain Global NetAlter Service Module Catalogue and provide related services, iii) maintain Global NetAlter Service Catalogue and provide related services, iv) maintain Global NetAlter Service Module Developer, Publisher & Distributor Catalogue and provide related services, v) maintain Global NetAlter Service Provider, Publisher & Distributor Catalogue and provide related services, vi) provide Global Auto Match Architecture (AMA), Search Engine, Brokering, Identity & Monitor Services, vii) published Global Subscriber Public Information, viii) provide Standards and Specialization for module development, ix) provide Certification & Licenses to modules developers for modules development, x) Provides Peer to Peer Coordination & Discovery Service to facilitate Peer to Peer File & Data transfer and communication xi) provide Centralize downloads for NetAlter Browser and its Updates & Upgrades via (1F) FTP web server, communicate to the all related parties i.e. developers, providers, publishers, distributors, subscribers & other 3^{rd} parties via (1G) Mail Server and all other required services to facilitate smooth functions of NetAlter & involved channel nodes.

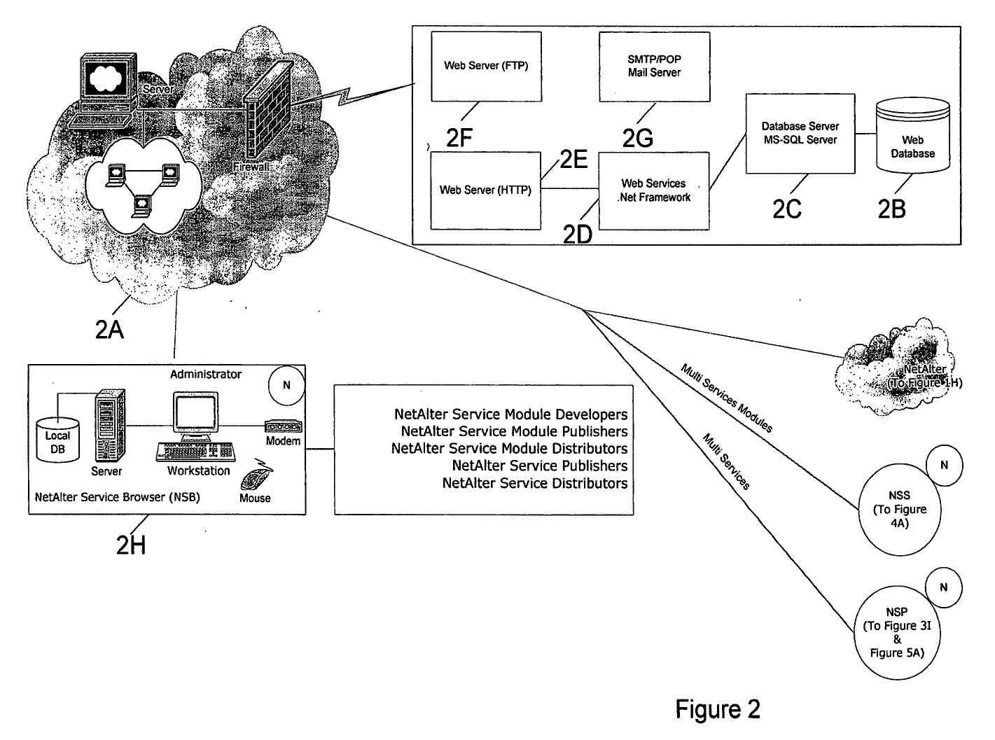

FIG. 2 illustrates a schematic block diagram of a preferred embodiment of NetAlter Service Module Developers (NSMD), NetAlter Service Module Publishers (NSMP), NetAlter Service Module Distributors (NSMDI), NetAlter Service Publishers (NSP) and NetAlter Service Distributors (NSD) along with preferred component of present web server so as to establish connection relationship between NetAlter members and internet framework.

(2A) shows a host computer, for i) NetAlter Service Module Developers, ii) NetAlter Service Module Publishers, iii) NetAlter Service Module Distributors, iv) NetAlter Service Publishers and v) NetAlter Service Distributors, in the form of web server containing a cluster of servers and peer to peer coordination & discovery server, for (2B) hosting database e.g. (2C) MS SQL Server communicate via protocol e.g. (2E) HTTP using business logic which are in the form of web services e.g. (2D) .Net web service for providing related services to the related parties and provide Centralize downloads or upload for modules, demo & like so and its Updates & Upgrades via (2F) FTP web server, communicate to the all related parties i.e. developers, providers, publishers, distributors, subscribers & other 3^{rd} parties via (2G) Mail Server and all other required services

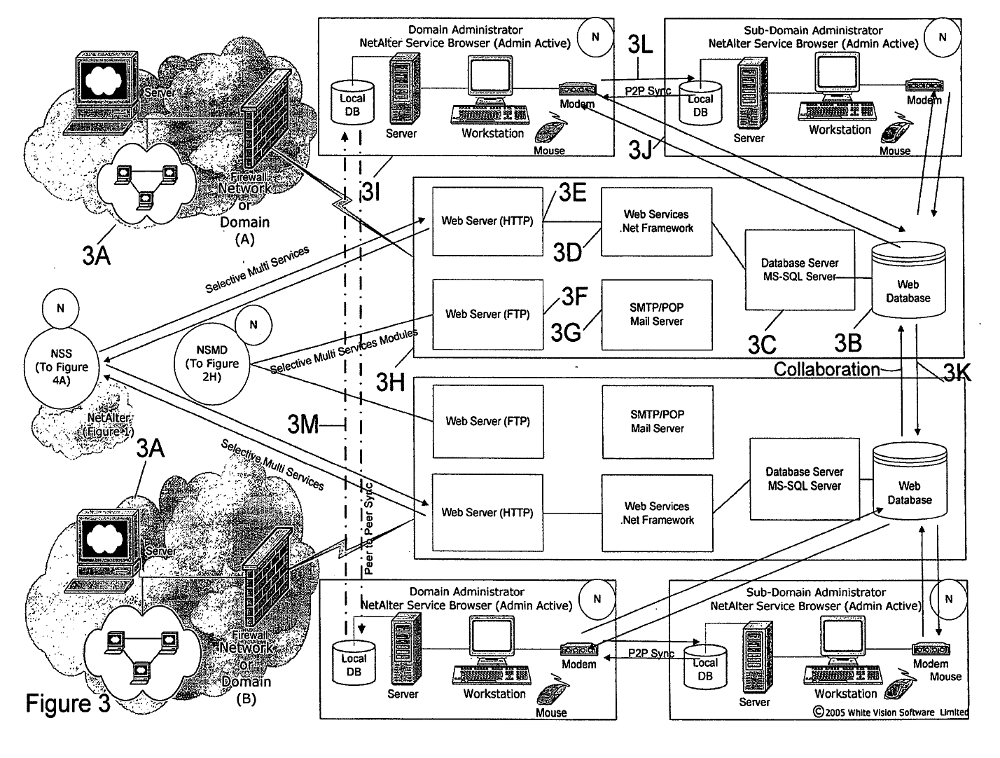

FIG. 3 illustrates a schematic block diagram of part of NetAlter providing broad view of working of NetAlter Service Provider.

(3A) illustrates a host computer, for NetAlter Service Provider, in the form of web server containing a cluster of servers for (3B) hosting database e.g. (3C) MS SQL Server provide service to the subscriber via protocol e.g. (3E) HTTP using business logic which are in the form of web services e.g. (3D). Net web service for providing related services to the related parties and downloads modules, demo & like and its Updates & Upgrades via (3F) FTP web server, communicate to the all related parties i.e. developers, providers, publishers, distributors, subscribers & other 3^{rd} parties via (3G) Mail Server and use (3L) peer to peer for data sharing & synchronization, files sharing and communication.

(3I) illustrates a computer for Domain administrator having full control over a data belonging to domain & share its data with (3J) sub-domain via (3B) web server and (3K) collaborates with other domain via (3K) web server or via (3M) peer to peer. Also illustrates the connection channel flow with Subscriber shown in the following illustration.

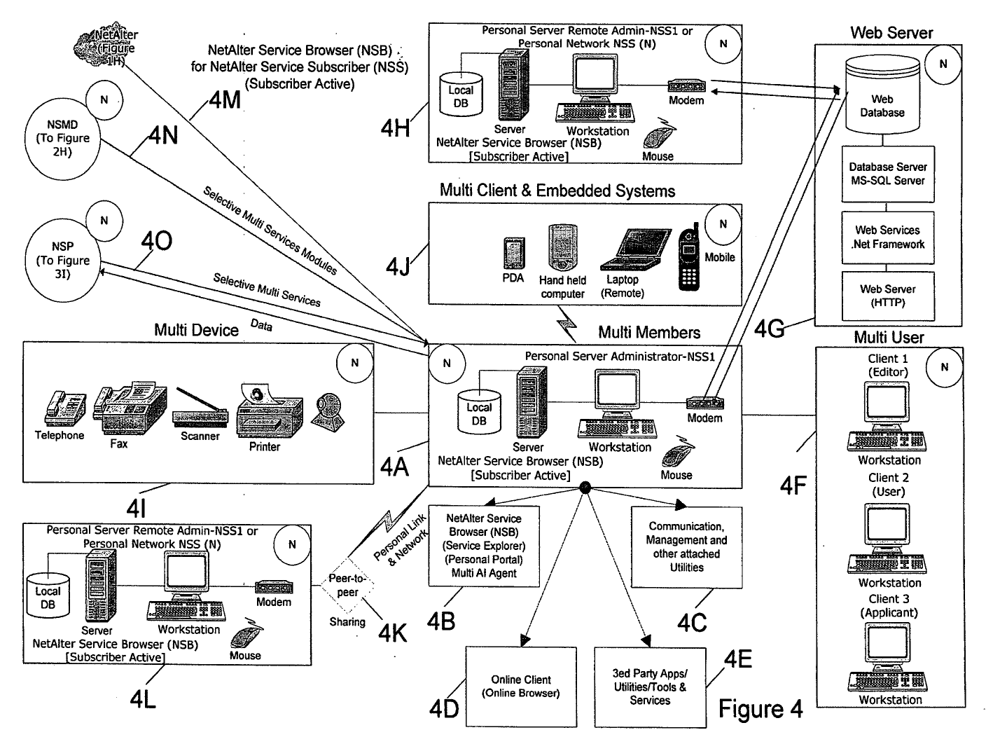

FIGS. 4 & 5 illustrates functional protocol based relationships of NetAlter Service Subscriber & Providers with other member parties in the NetAlter framework.

FIG. 4 illustrates a schematic block diagram of NetAlter Service Browser (Subscriber Active) providing broad view of working of NetAlter Service Browser for NetAlter Service Subscriber.

(4A) illustrates a computer for NetAlter Service Subscriber on which (4B)

NetAlter Service Browser (Subscriber Active) and (4C) communication, management & other utilities are installed to provide Personal Server Admin capability to the subscriber to facilitate building Personal Portal using selective service modules from selective (4N) service module developers and selective services from selective (4O) service providers, using (4J) Multi client e.g. PDA, Mobile etc, (4D) online client or using (4E) 3^{rd} parties application, utilities, tools & services as well as to create (4L) Personal Network.

(4A) illustrates a computer for NetAlter Service Subscriber, could have multiple members and (4F) Multi User & Admin levels capability, could share & synchronized data, share files and communicate via (4G) web server remotely with (4H) Remote Server and/or via (4K) peer to peer with (4L) Remote Server or with other members and/or share & synchronized data within the modules and use connected (4I) Multi Devices for the same.

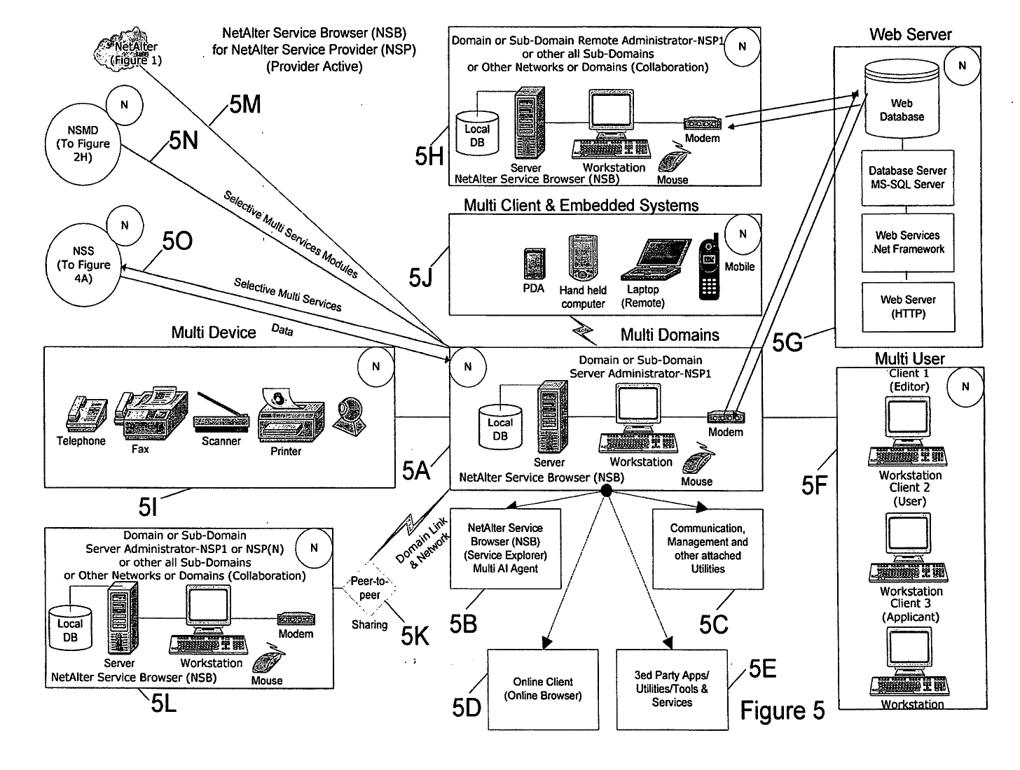

FIG. 5 illustrates a schematic block diagram of NetAlter Service Browser (Provider Active) providing broad view of working of NetAlter Service Browser for NetAlter Service Provider.

(5A) illustrates a computer for NetAlter Service Provider on which (5B) NetAlter Service Browser (Provider Active) and (5C) communication, management & other utilities are installed to provide Domain or Sub-Domain Server Admin capability to the provider to facilitate building Trusted Flexible Hierarchal Layered (TFHL) Network using selective service modules from selective (5N) service module developers and provides services to the (5O) service subscribers.

(5A) illustrates a computer for NetAlter Service Provider, could have multiple domains or network and (5F) Multi User & Admin levels capability, could share & synchronized data, share files and communicate via (5G) web server remotely with (5H) Remote Server and/or with other Domain or Sub-Domain Server for Collaboration.

(5A) illustrates a computer for NetAlter Service Provider, could have multiple domains or network and (5F) Multi User & Admin levels capability, could share & synchronized data, share files and communicate via (5K) peer to peer with (5L) Remote Server and/or with other Domain or Sub-Domain Server for collaboration or with other (5J) Multiple Client e.g. PDA, Mobile etc (5D) online client or using (5E) 3^{rd} parties application, utilities, tools & services and/or share & synchronized data within the modules and use connected (SI) Multi Devices for the same.

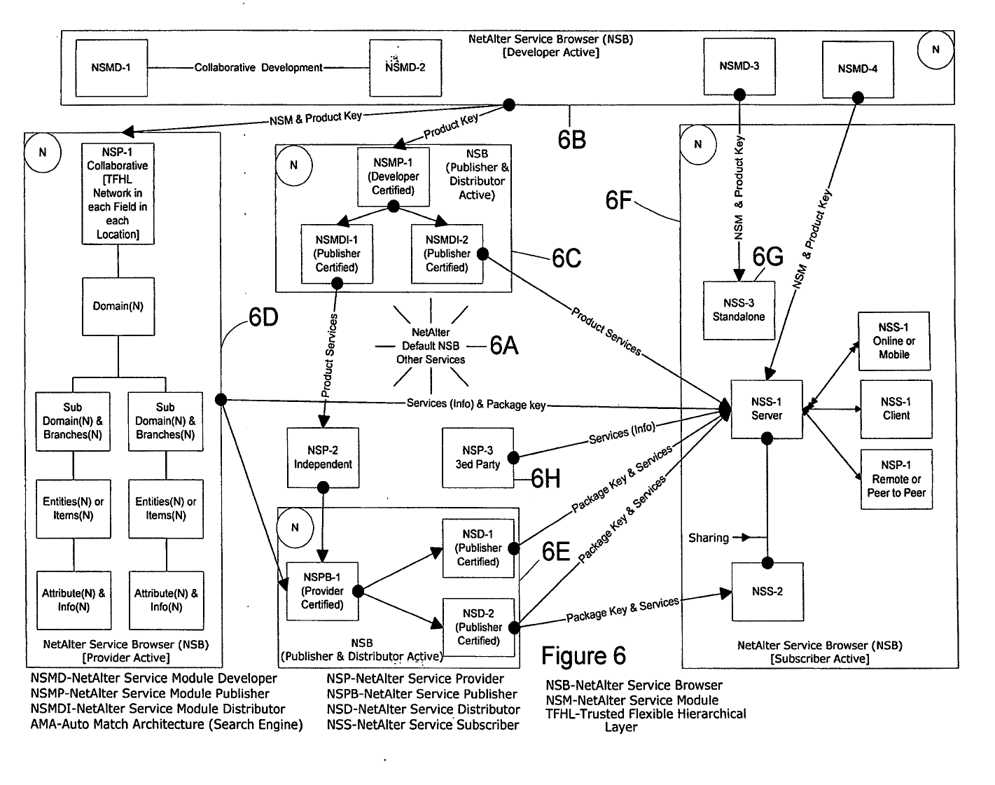

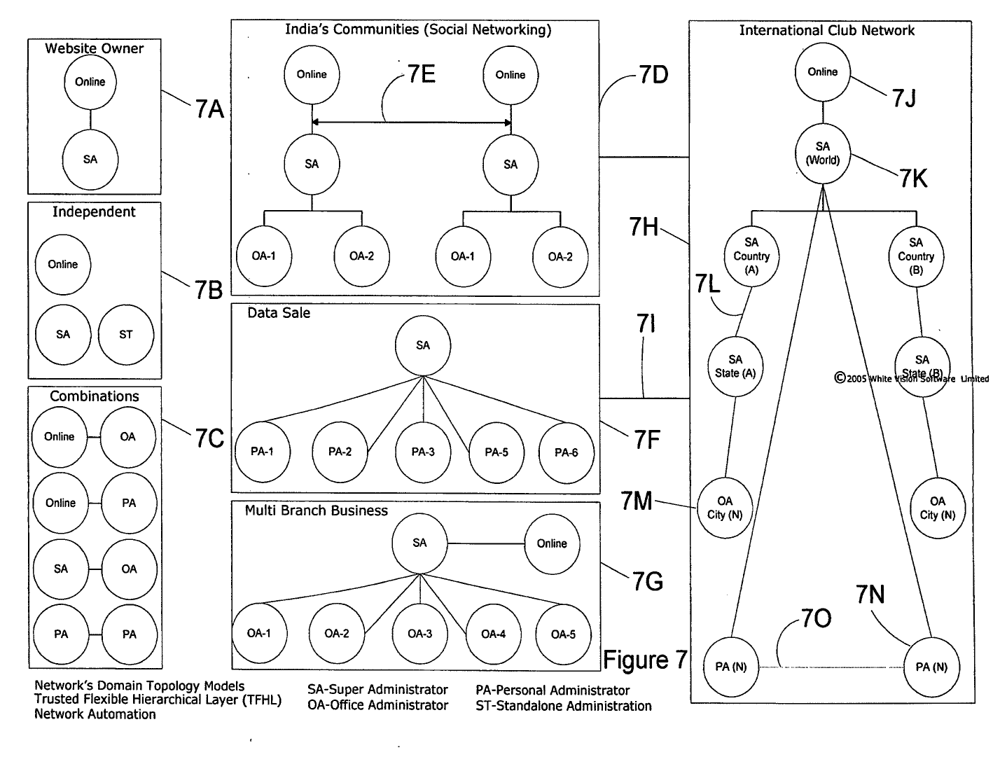

FIG. 6 illustrates a logical block diagram of NetAlter Framework and all the involved parties i.e. NetAlter Controller, NetAlter Service Module Developer (NSMD), NetAlter Service Module Publisher (NSMP), NetAlter Service Module Distributor (NSMDI), NetAlter Service Provider (NSP), NetAlter Service Publisher (NSPB), NetAlter Service Distributor (NSD), NetAlter Service Subscriber (NSS) providing broad view of working & interaction with interrelational map of all the involved parties.

(6A) illustrates the NetAlter Controller, the top most authority in NetAlter Framework, that provides NetAlter Service Browser to the related parties (channel node) & other services like upgrade, update, consultancy, NetAlter users & service catalogues, licensing for development of modules etc.

(6B) illustrates the NetAlter Service Module Developers, licensed by NetAlter Controller, engaged in developments of NetAlter Service Modules independently or collaboratively which are mainly used by the (6G) NetAlter Service Subscriber, (6D) NetAlter Service Provider via product key obtained from (6B) NetAlter Service Module Developer and/or (6C) NetAlter Service Module Distributor authorized by NetAlter Service Module Publisher in turn authorized by (6B) NetAlter Service Module Developer.

(6F) illustrates NetAlter Service Subscriber node which used the NetAlter Service Module provided by (6B) NSMD to access the services provided by the (6D) NetAlter Service Provider via Package Key obtained from (6D)(6H) NetAlter Service Provider or (6E) NetAlter Service Distributor authorized by NetAlter Service Publisher which in turn authorized by (6D) NetAlter Service Provider.

(6F) illustrates NetAlter Service Subscriber node which could work in standalone or have client-server methodology and link with other client like online or mobile to exchange & Share data or link peer to peer to share files and share & synchronized data, communication remotely or with other members with restricted permission.

FIG. 7 illustrates a schematic block diagram of NetAlter Network's Domain Topology Models i.e. hierarchy of nodes within a domain, Network Relationship i.e. the way nodes of domain are interconnected or two or more domains are interconnected, Trusted Flexible Hierarchical Layer (TFHL) i.e. a standards devised to establish alternative communication methodology to internet as well as enterprise communication framework which are use to communicate and manage information in secured manner preferentially identified as NetAlter framework and Network Automation which is possible by means of product & package key features which is provided into the explorer of browser application to successfully build, manage, and collaborate by means of licensing certificates and permissions transferred therein to networks and connected domains.

(7A), (7B), (7C), (7D), (7F), (7G), (7H) illustrates the some examples of different topology models of NetAlter Network's Domains, (7E) shows the collaboration between two domains and also indicate other possible collaboration like Intra & Inter Domain, Intra & Inter Network and Inter Subscriber, while (7H) show the TFHL and the Network's Domain Relationship between channel nodes of a domain, (7K)(7J) shows the top most authority in the domain while (7M) shows the bottom authority in the domain, (7N) shows the final users of data flow via the domain channel Nodes while (7O) indicates the possibility of sharing data between two subscribers i.e. Inter Subscriber Collaboration.

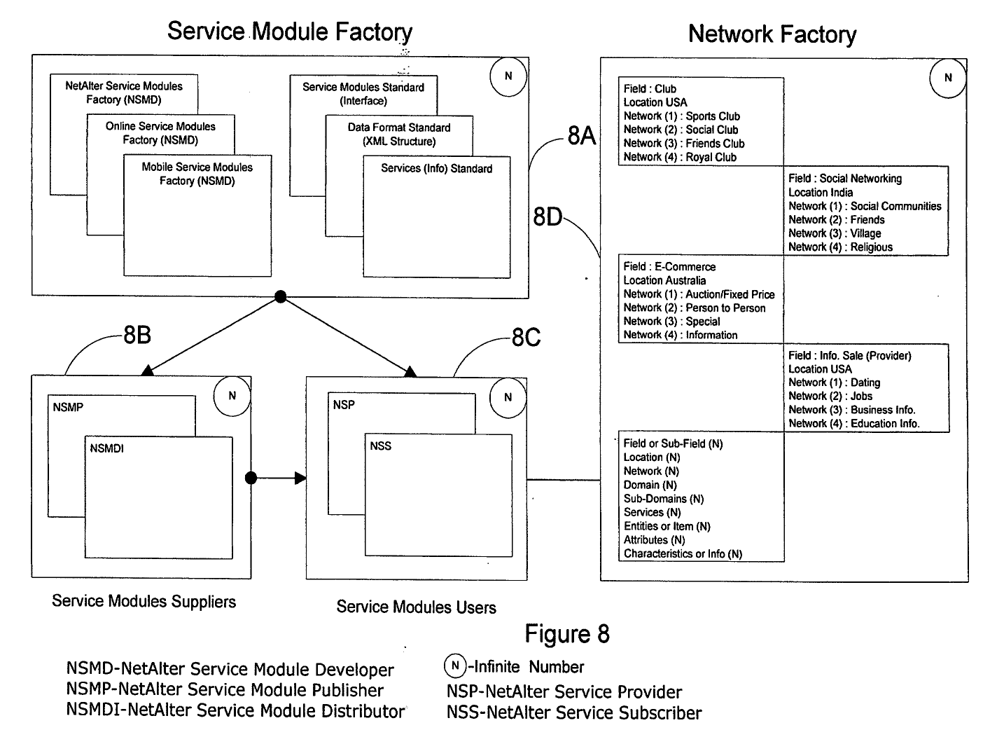

FIG. 8 illustrates a schematic block diagram of Service Module Factory and Network Factory.

(8A) shows the Service Module Factory, comprise of NetAlter Service Modules Factory, Online Service Modules Factory and Mobile Service Modules Factory, which are engaged in development of service modules by following Service Module Standard for Interface (Front-end), Data Format Standard for Database (Back-end) and Service Standard, Modules developed by Service Module Factories are sale directly or distributed via (8B) NetAlter Service Module Distributors authorized by NetAlter Service Module Publishers termed as Service Module Suppliers to (8C) NetAlter Service Provider & NetAlter Service Subscribe termed as Service Modules Users who formed the different domains based of different attributes like fields, location etc. which together in turn leads to creation of different Networks termed as (8D) Network Factory which support End to End automation of Full Features Multi Client (e.g. Offline, Online, Mobile) Service Modules or applications or related utilities, Development via Multiple Developers, Centralize Updates, Upgrades, New Versions, Research, Customization as per NetAlter Service Module, Service, Data Format Standard supplies via Service Module Distributors and Publisher to Service Providers and Subscribers as per requirement (business or social organized network) or general need (internet alternate) facilitate network topology, models, automation, management, collaboration, Scalability, Specialization, business model, Services.

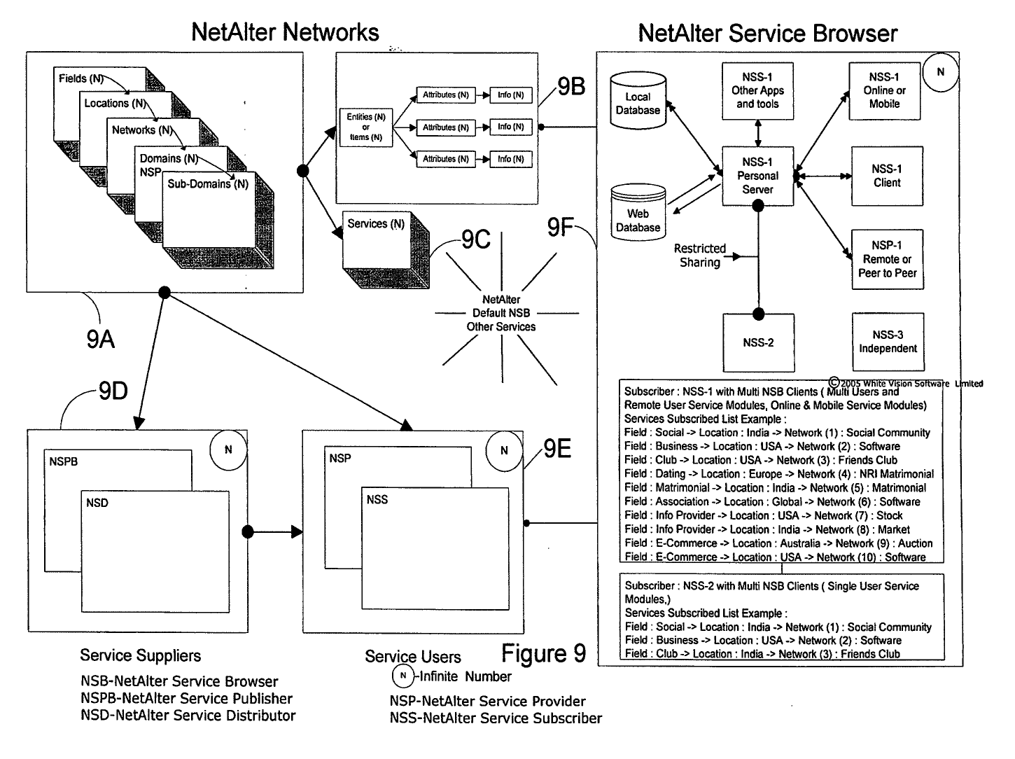

FIG. 9 illustrates a relationship & functionalities logical block diagram of NetAlter Service Provider (NSP), NetAlter Service Suppliers consist of NetAlter Publisher (NSPB) & NetAlter Service Distributor (NSD) as well as NetAlter Service Users consists of NetAlter Service Provider (NSP) & NetAlter Service Subscriber (NSS) and all of them interact using the NetAlter Service browser.

(9A) illustrates the hierarchy of nodes in a service network, at the top most node essentially Field Node will be there i.e. subject of network say Social, down to the Field Node next node is Location Node i.e. place of the network say India, down to the Location Node next node is Network Node i.e. the actual network say Social Community Network which comprise of multiple Domains down to it and Sub-Domains down to the domain, such domains or sub-domains could provide multiple (9C) Services to the NetAlter Subscriber and such service are based on (9B) Entities or Item having (9B) N number of Attributes which in turn have (9B) N number of Information wherein An network means a group or organization with a membership who all have a common aim or interest such as political, academic or engineering institutes, sporting bodies and so forth said organization network entities may be forced by group of individuals, entities, possessing one or more common entity attributes, Entities includes any individual, family, personal or organized network, organization, club, society, company, partnership, religion, or entity that exists as a particular and discrete unit and attributes include information regarding personal details, factors or interests; friends; relations; school alumni; employment factors; business colleagues; professional acquaintances; persuasions, or proclivities; sporting interests; entertainment, artistic, creative or leisure interests; travel interests, commercial, religious, political, theological or ideological belief or opinions; academic, scientific, or engineering disciplines; humanitarian, social, security/military or economic fields and any combination of same and Information include details about the particular entities & its attributes.

(9D) illustrates the NetAlter Service Publisher authorized by the NetAlter Service Provider to publish their services and NetAlter Service Distributor authorized by the NetAlter Service Publisher to distribute the package keys for service & other services, NetAlter Service Publishers & Distributors both are termed as Service Suppliers to supply service to the (9E) NetAlter Service Subscribers.

(9E) illustrates the NetAlter Service Subscribers, using the services provided by the NetAlter Service Provider via NetAlter Service Browser, could be standalone or in the form of personal server could have multiple client, could access the data via online, mobile, peer to peer or other communication tools and could share the file, share & synchronized data and communicate with other subscribe with restricted permission.

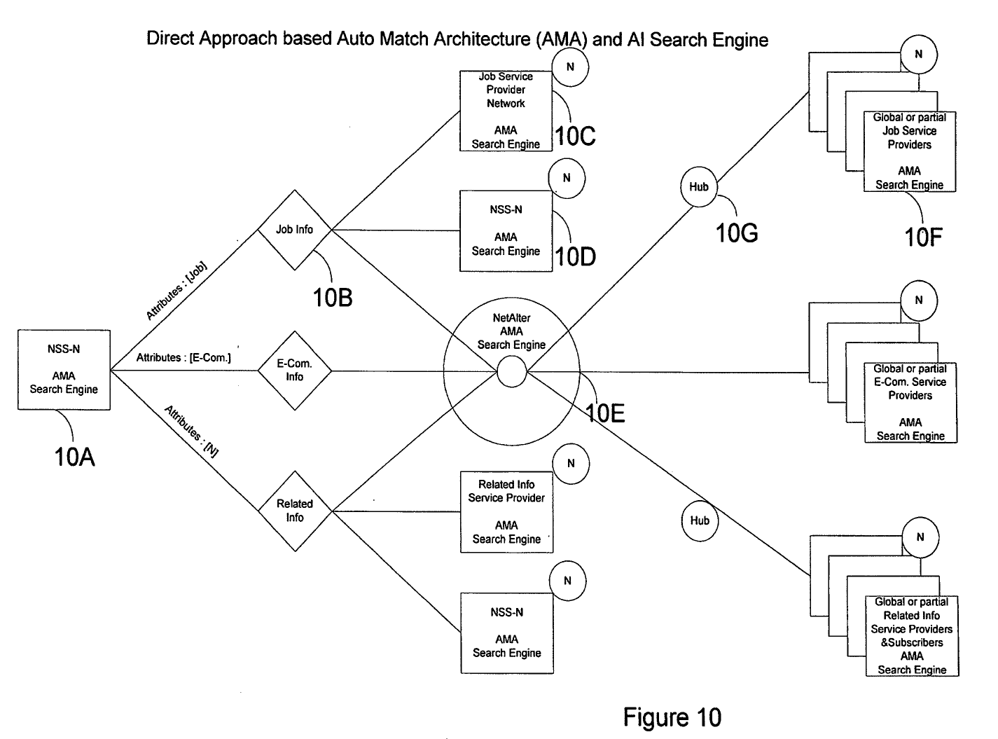

FIG. 10 illustrates the Auto Match Architecture (AMA) & Search Engine for the NetAlter.

(10A) illustrates the user, use the Auto Match Architecture (AMA) (capable to find information as per the predefined preference for the particular attributes automatically) & Search Engine (capable to find the information as per request of the user) of the NetAlter for searching the required information paid or free.

(10A) illustrates the user, use the Auto Match Architecture (AMA) & Search Engine of the NetAlter by sending the (10B) required information (say jobs information i.e. resume) as per related attribute (say Job) for searching the required information (say job vacancies) to (10E) the NetAlter Search Engine or AMA which in turn find the requested information from different related domains OR to the subscribed service (10C)(10D) provider's server via AMA or Search Engine which in turn find the requested information from the provider's server. (10G) illustrates a hub meant for local caching of the searched & matched results to make local availability of data so as to save upon time and NetAlter frameworks' computing resources.

In a methodological embodiment of NetAlter, illustration 11 through 17 represents the organizational framework and control & management utilities for continues regulation & governance by each entity as per hierarchical importance and functionalities attached therewith.

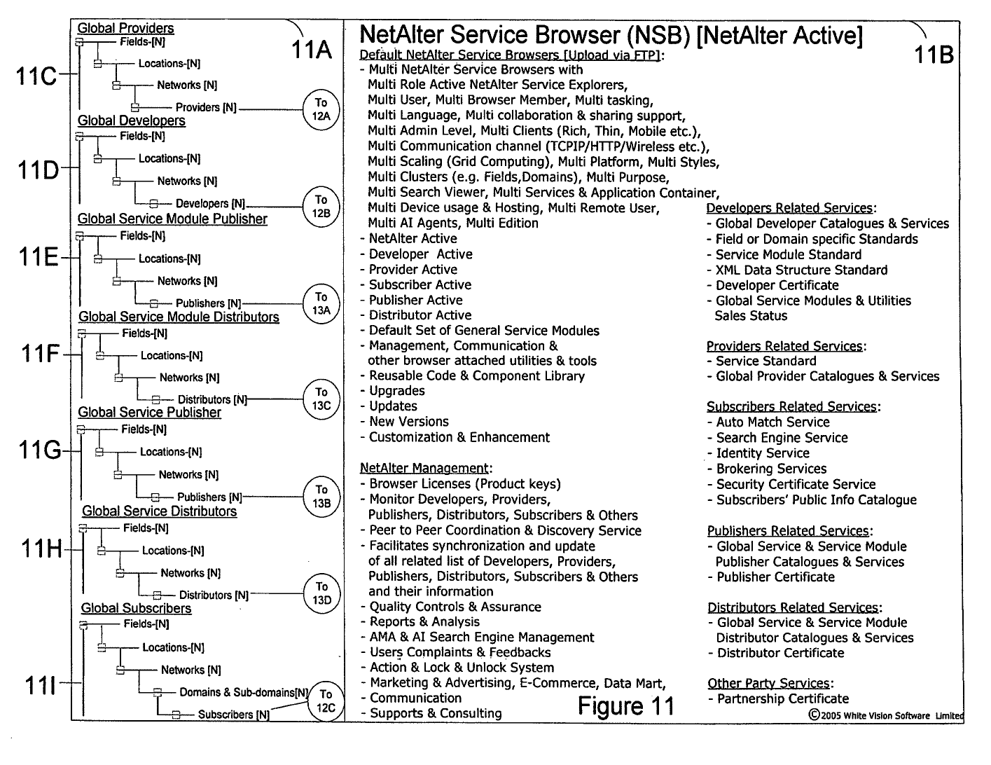

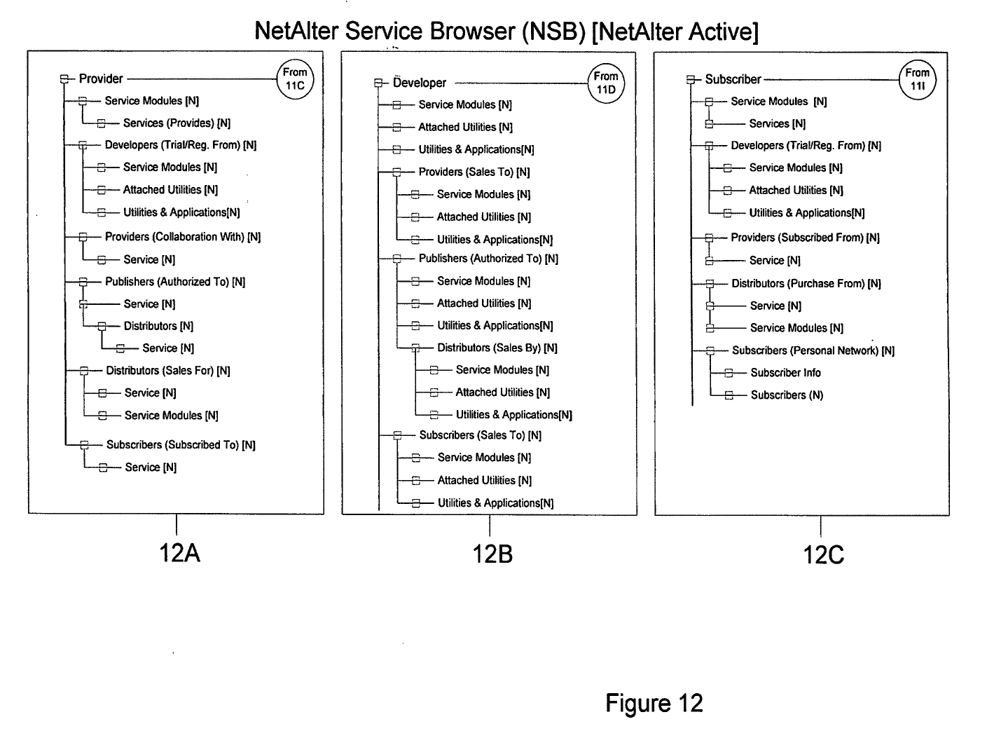

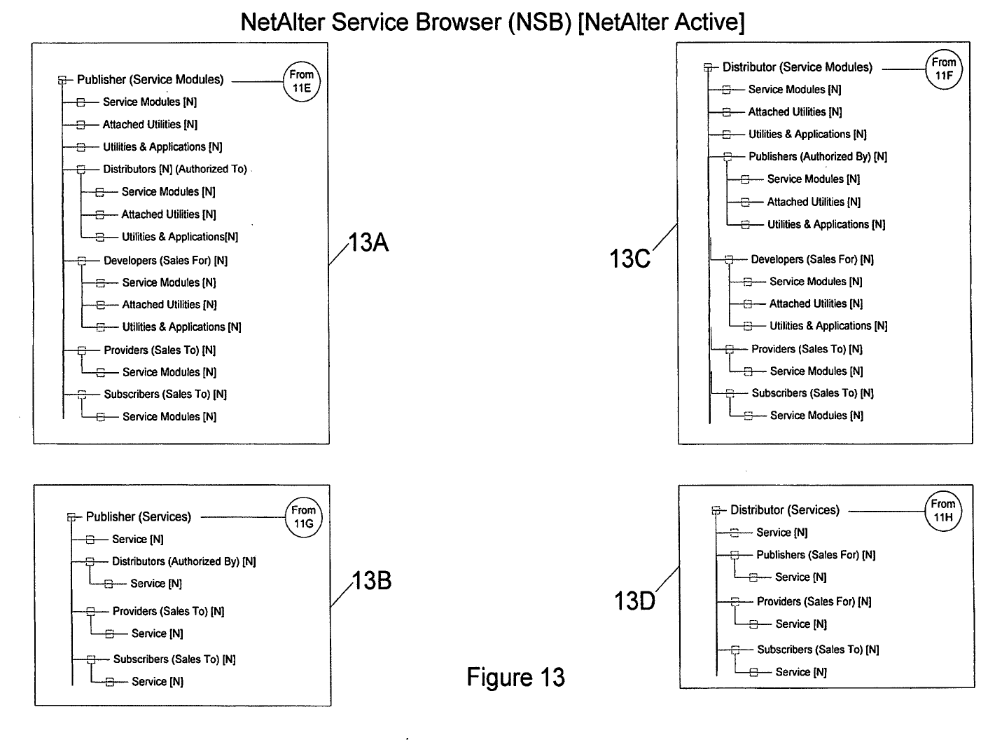

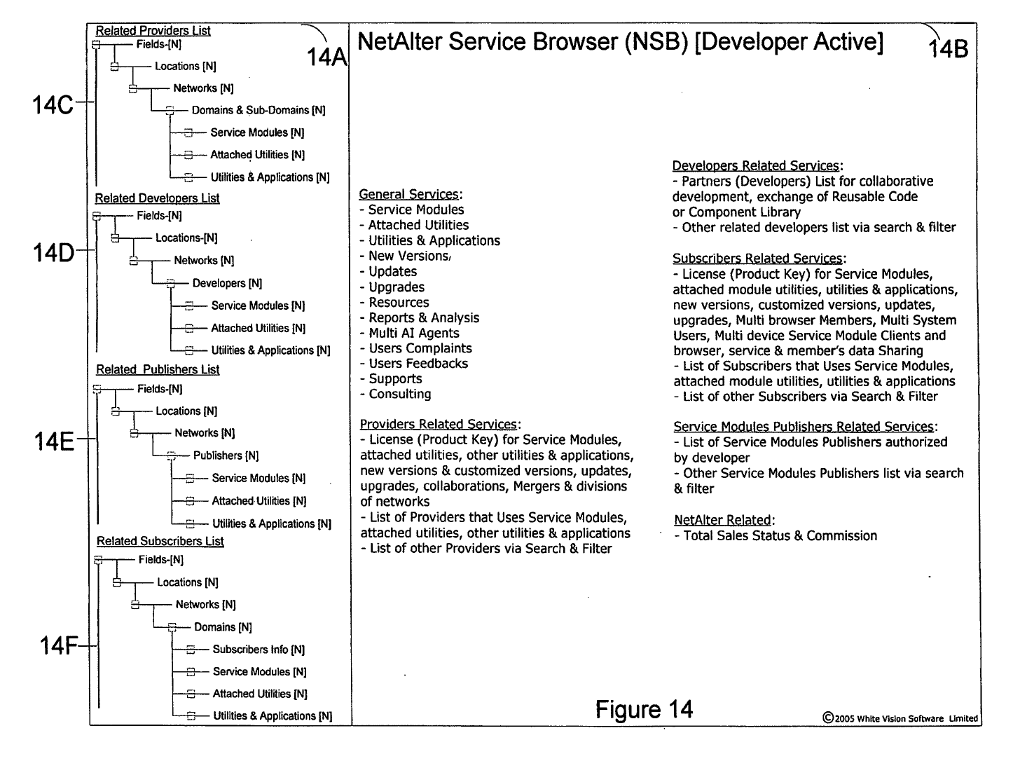

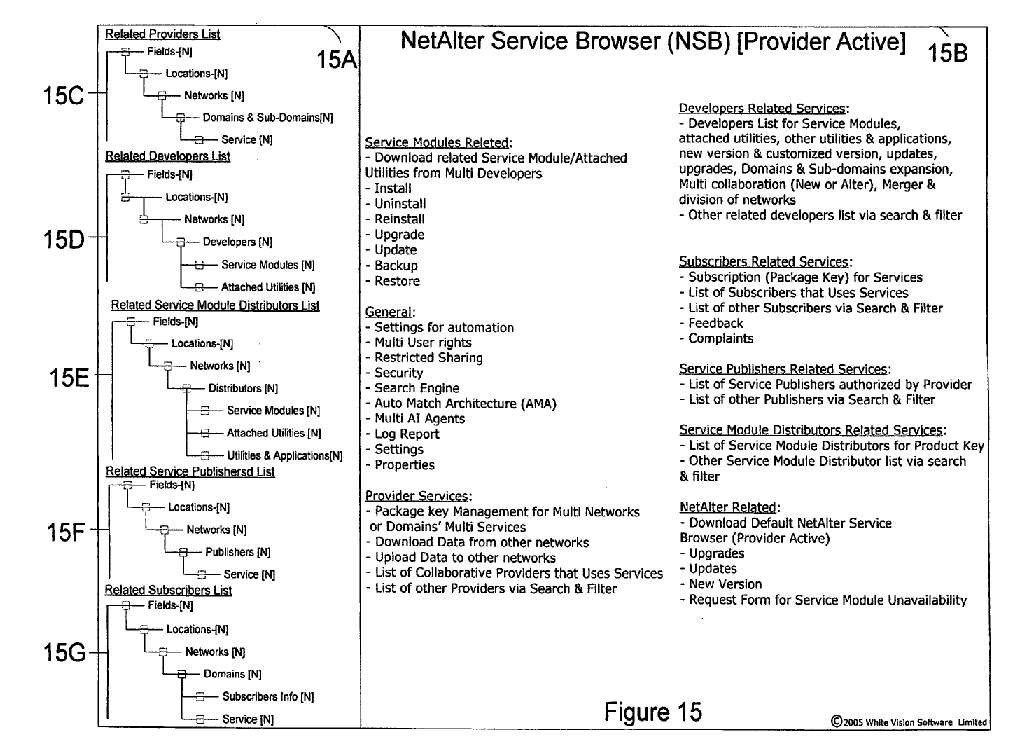

FIGS. 11, 12 & 13 illustrates a schematic block diagram of NetAlter Service Browser (NetAlter Active) and its functionality.

(11A) illustrates the Explorer part of NetAlter Service Browser (NetAlter Active) which list the in depth details of all the parties related to the NetAlter Controller i.e. Developers, Providers, Subscribers, Distributors & 3^{rd} parties

(11C) illustrates the Explorer part of NetAlter Service Browser (NetAlter Active) which lists the in-depth details related to the NetAlter Service Providers that show the list of providers & its details in tree format the same be devised so that each higher attribute encircles the following one in a concentric encircled map. The explorer tree represents Fields followed by Location followed by Networks followed by Providers (Domains, sub-domains, branches). The explorer tree show (12A) a) details of Service Modules purchased by a specific provider to provide Services, b) details of Developers from whom Service Modules, Attached Utilities, Other Utilities and Application purchased by a specific provider, c) details of Service Publishers authorized by a specific provider for publishing a services provided by such provider and the list of Service Distributors appointed by authorized Service Publisher to sale the services provided by a specific provider d) details of Service Distributors from whom the a specific provider purchase the Package Key/s & Module Distributors from whom a specific provider purchase the Product Key/s and e) details of subscribers and the services used by them.

(11D) illustrates the Explorer aspect of NetAlter Service Browser (NetAlter Active) which list the in depth details related to the NetAlter Service Developers which show the list of developers & its details in tree format the same being devised so that each higher attribute encircles the following one in a concentric encircled map. The explorer tree represents Fields followed by Location followed by Networks followed by Developers. The explorer tree show (12B) a) details of Service Modules developed by a specific developer, b) details of providers to whom Service Modules, Attached Utilities, Other Utilities and Applications sold by a specific developer, c) details of Service Module Publishers authorized by a specific developer for publishing module developed by such developer and the list of Service Module Distributors appointed by authorized Service Module Publisher to sale the Module develop by a specific developer and e) details of subscribers to whom Service Modules, Attached Utilities, Other Utilities and Applications sold by a specific developer or via service module distributors.

(11E) illustrates the Explorer aspect of NetAlter Service Browser (NetAlter Active) which list the in depth details related to the NetAlter Service Module Publishers which show the list of Service Module Publishers & its details in tree format the same being devised so that each higher attribute encircles the following one in a concentric encircled map. The explorer tree represents Fields followed by Location followed by Networks followed by Module Publishers. The explorer tree show (13A) a) details of Service Modules, Attached Utilities, Other Utilities and Applications published by a specific Publishers, b) details of providers to whom Service Modules, Attached Utilities, Other Utilities and Applications sold by a specific Publishers via appointed distributors, c) details of Service Module Developer who authorized to the Publishers for publishing Service modules, Attached Utilities, Other Utilities and Applications developed by such developer and d) the list of Service Module Distributors appointed by Service Module Publisher to sale the Module, Attached Utilities, Other Utilities and Applications develop by a specific developer and e) details of subscribers to whom Service Modules, Attached Utilities, Other Utilities and Applications sold via service module distributors.

(11F) illustrates the Explorer aspect of NetAlter Service Browser (NetAlter Active) which list the in depth details related to the NetAlter Service Module Distributors which show the list of Service Module Distributors & its details in tree format the same be devised so that each higher attribute encircles the following one in a concentric encircled map. The explorer tree represents Fields followed by Location followed by Networks followed by Service Module Distributors. The explorer tree show (13C) a) details of Service Modules, Attached Utilities, Other Utilities and Applications distributed by a specific Distributor, b) details of providers to whom Service Modules, Attached Utilities, Other Utilities and Applications sold by a specific distributors, c) details of Service Module Developer who authorized to the Publishers for publishing Service modules, Attached Utilities, Other Utilities and Applications developed by such developer via distributor and d) the list of Service Module Publisher who to Service Module Distributors appointed to sale the Module, Attached Utilities, Other Utilities and Applications develop by a developer and e) details of subscribers to whom Service Modules, Attached Utilities, Other Utilities and Applications sold by service module distributors.

(11G) illustrates the Explorer aspect of NetAlter Service Browser (NetAlter Active) which list the in depth details related to the NetAlter Service Publishers which show the list of Service Publishers & its details in tree format the same be devised so that each higher attribute encircles the following one in a concentric encircled map. The explorer tree represents Fields followed by Location followed by Networks followed by Service Publishers. The explorer tree show (13B) a) details of Services published by a specific Publishers, b) details of providers for whom services published by a specific Publishers via appointed distributors, c) details of Service Provider who authorized to the Publishers for publishing Service provided by such provider and d) details of subscribers to whom Services are sold via service distributors.

(11H) illustrates the Explorer aspect of NetAlter Service Browser (NetAlter Active) which list the in depth details related to the NetAlter Service Distributors which show the list of Service Distributors & its details in tree format the same be devised so that each higher attribute encircles the following one in a concentric encircled map. The explorer tree represents Fields followed by Location followed by Networks followed by Service Distributors. The explorer tree show (13D) a) details of Service distributed by a specific Service Distributor, b) details of providers for whom Service distributed by a specific Service Distributor c) the list of Service Publisher who authorized to Service Distributors to sale the services provided by a service provider and e) details of subscribers to whom Service are sold by a Service Distributors.

(11I) illustrates the Explorer aspect of NetAlter Service Browser (NetAlter Active) which list the in depth details related to the NetAlter Service Subscribers which show the list of Subscribers & its details in tree format the same being devised so that each higher attribute encircles the following one in a concentric encircled map. The explorer tree represents Fields followed by Location followed by Networks followed by Service Subscribers. The explorer tree show (12C) a) details of Service Modules, Attached Utilities, Other Utilities and Applications distributed by a specific Distributor, b) details of providers to whom Service Modules, Attached Utilities, Other Utilities and Applications sold by a specific distributors, c) details of Service Module Developer who authorized to the Publishers for publishing Service modules, Attached Utilities, Other Utilities and Applications developed by such developer via distributor and d) the list of Service Module Publisher who to Service Module Distributors appointed to sale the Module, Attached Utilities, Other Utilities and Applications develop by a developer and e) details of subscribers to whom Service Modules, Attached Utilities, Other Utilities and Applications sold by service module distributors.

(11J) illustrates the Explorer aspect of NetAlter Service Browser (NetAlter Active) which list the in depth details related to the NetAlter functionality and administrative rights.

(14A) illustrates the Explorer aspect of NetAlter Service Browser (Developer Active) which list the in depth details of all the parties related to the NetAlter Module Developer i.e. Related Developers, Providers, Subscribers & 3^{rd} parties.

(14C) illustrates the Explorer aspect of NetAlter Service Browser (Developer Active) which lists the in-depth details related to the NetAlter Service Providers that show the list of providers & its details in tree format the same be devised so that each higher attribute encircles the following one in a concentric encircled map. The explorer tree represents Fields followed by Location followed by Networks followed by Providers (Domains, sub-domains, branches). The explorer tree shows the details of Service Modules purchased by a NetAlter Service Provider to provide Services.

(14D) illustrates the Explorer aspect of NetAlter Service Browser (Developer Active) which lists the in-depth details related to the NetAlter Service Module Developers that show the list of Developers & its details in tree format the same be devised so that each higher attribute encircles the following one in a concentric encircled map. The explorer tree represents Fields followed by Location followed by Networks followed by Developers. The explorer tree shows the details of Developers with whom Service Modules, Attached Utilities, Other Utilities and Application are develop collaboratively.

(14E) illustrates the Explorer aspect of NetAlter Service Browser (Developer Active) which lists the in-depth details related to the NetAlter Service Module Publishers that show the list of authorized Module Publishers & its details in tree format the same be devised so that each higher attribute encircles the following one in a concentric encircled map. The explorer tree represents Fields followed by Location followed by Networks followed by Module publishers. The explorer tree shows the details of Service Module Publishers authorized by a developer for publishing a service modules developed by a developer

(14F) illustrates the Explorer aspect of NetAlter Service Browser (Developer Active) which lists the in-depth details related to the NetAlter Service Subscriber that show the list of Subscribers & its details in tree format the same be devised so that each higher attribute encircles the following one in a concentric encircled map. The explorer tree represents Fields followed by Location followed by Networks followed by Subscribers. The explorer tree shows the details of subscribers and the Service Modules, Attached Utilities, Other Utilities and Application are used by them.

(14B) illustrates the categorized functionality of NetAlter Service Browser (Developer Active) i.e. a) General Services which includes Service Modules, Attached Utilities, Utilities & Applications, New Versions, Update, Upgrades and Resources to be upload via FTP, produce Reports & Analysis like sales made, purchase by whom, from where, amount of commission given to the publishers, publisher wise sales, location wise sales etc. . . . , handle users complaints & Feedbacks, provide supports & consultancy to the related parties, b) Provider Related Services which includes to issue licenses i.e. product keys to the NetAlter Service Providers for Service Modules, Attached Utilities, Other utilities & Applications, New Versions & Customized Versions, Updates, Upgrades, Collaborations, Mergers & Divisions of networks, List of Providers that Uses Service Modules, attached utilities, other utilities & applications, List of other Providers via Search & Filter and more, c) Developers Related Services which includes Partners i.e. Other Developers List for collaborative development, exchange of Reusable Code or Component Library, Other related developers list via search & filter and more, d) Subscribers Related Services which includes to issue Licenses i.e. Product Keys to the NetAlter Service Subscriber for Service Modules, attached module utilities, utilities & applications, new versions, customized versions, updates, upgrades, Multi browser Members, Multi System Users, Multi device Service Module Clients and browser, service & member's data Sharing, List of subscribers that Uses Service Modules, attached module utilities, utilities & applications develop by the specific developer, List of other Subscribers via Search & Filter, e) Service Modules Publishers Related Services includes List of Service Modules Publishers authorized by developer, Other Service Modules Publishers list via search & filter and f) NetAlter Related includes Total Sales Status made by developer & Commission required to be given to the NetAlter Controller etc. . . .

(15A) illustrates the Explorer aspect of NetAlter Service Browser (Provider Active) which lists the in depth details of all the parties related to the Provider i.e. other Providers, Subscribers, Distributors & NetAlter Controller.

(15C) illustrates the Explorer aspect of NetAlter Service Browser (Provider Active) which lists the in-depth details related to the NetAlter Service Providers that show the list of providers & its details in tree format the same be devised so that each higher attribute encircles the following one in a concentric encircled map. The explorer tree represents Fields followed by Location followed by Networks followed by Providers (Domains, sub-domains, branches). The explorer tree shows the details of Service provided by a NetAlter Service Provider itself, list of other providers with whom a provider work collaboratively to provide services, list of other related service provider found with the help of search & Filter and more.

(15D) illustrates the Explorer aspect of NetAlter Service Browser (Provider Active) which lists the in-depth details related to the NetAlter Service Module Developers that show the list of Developers & its details in tree format the same be devised so that each higher attribute encircles the following one in a concentric encircled map. The explorer tree represents Fields followed by Location followed by Networks followed by Developers. The explorer tree shows the details of Developers from whom Service Modules, Attached Utilities, Other Utilities and Application are purchase by a service providers, list of other related service module developers found with the help of search & Filter and more.

(15E) illustrates the Explorer aspect of NetAlter Service Browser (Provider Active) which lists the in-depth details related to the NetAlter Service Module Distributors that show the list of Service Module Distributors & its details in tree format the same be devised so that each higher attribute encircles the following one in a concentric encircled map. The explorer tree represents Fields followed by Location followed by Networks followed by Service Module Distributors. The explorer tree shows the details of Service Module Distributors from whom the service modules (Product Keys) are purchase by a provider, list of other related service module distributors found with the help of search & Filter and more.

(15F) illustrates the Explorer aspect of NetAlter Service Browser (Provider Active) which lists the in-depth details related to the NetAlter Service Publishers that show the list of Service Publishers & its details in tree format the same be devised so that each higher attribute encircles the following one in a concentric encircled map. The explorer tree represents Fields followed by Location followed by Networks followed by Service Publishers. The explorer tree shows the details of Service Publishers authorized by a provider for publishing a service provide by a provider, list of other related Service Publishers found with the help of search & Filter and more.

(15G) illustrates the Explorer aspect of NetAlter Service Browser (Provider Active) which lists the in-depth details related to the NetAlter Service Subscriber that show the list of Subscribers & its details in tree format the same be devised so that each higher attribute encircles the following one in a concentric encircled map. The explorer tree represents Fields followed by Location followed by Networks followed by Subscribers. The explorer tree shows the details of subscribers who subscribed the services of providers, details of services subscribed by subscriber and list of other prospective service subscribers found with the help of search & Filter and more.

(15B) illustrates the categorized functionality of NetAlter Service Browser (Provider Active) i.e. a) Service Module Related which includes Service Modules, Attached Utilities, Utilities & Applications, New Versions, Update, Upgrades and Resources to downloaded via FTP from multiple developers, details of Service Modules, Attached Utilities, Utilities & Applications, New Versions installed, reinstalled or uninstalled and more b) General which includes setting for automation, allowing sharing of data to the other providers with restricted sharing permission, assigning admin rights to different users, use AMA & Search engine for searching & filtering required information, viewing the activity log reports of its subordinates, setting the security parameters and more, c) Provider related services includes generating package keys for the services provided, details of package keys issue to the publishers & subscribers, download data from & upload data to other providers' networks, list & details of other provider with whom services are used collaboratively, maintain list of other providers found with the help of search & Filter and more d) Developers Related Services include List Modules Developers from whom Service Modules, Attached Utilities, Other Utilities & Applications, New version & Customized Version, Updates & Upgrades are purchased and product keys obtained for the Domains & Sub-domains expansion, Multi collaboration (New or Alter), Merger & Division of networks and Other related developers list found via search & filter, e) Subscribers Related Services include list & details of Subscription i.e. Package Keys issue to the subscriber for subscribing the Services provided by provider, List of other Subscribers via Search & Filter, handling Feedback & Complaints from the subscribers, f) Service Publishers Related Services which includes the List of Service Publishers authorized by Provider to publish the services, List of other Publishers found via Search & Filter, g) Service Module Distributors related services includes List of Service Module Distributors from whom Product Keys are obtained to use the service modules, Other Service Module Distributor list found via search & filter and h) NetAlter Related services which include Download Default NetAlter Service Browser (Provider Active), Upgrades & Updates it, look for New Version and use Request Form to request for new Service Modules which are unavailable and more.

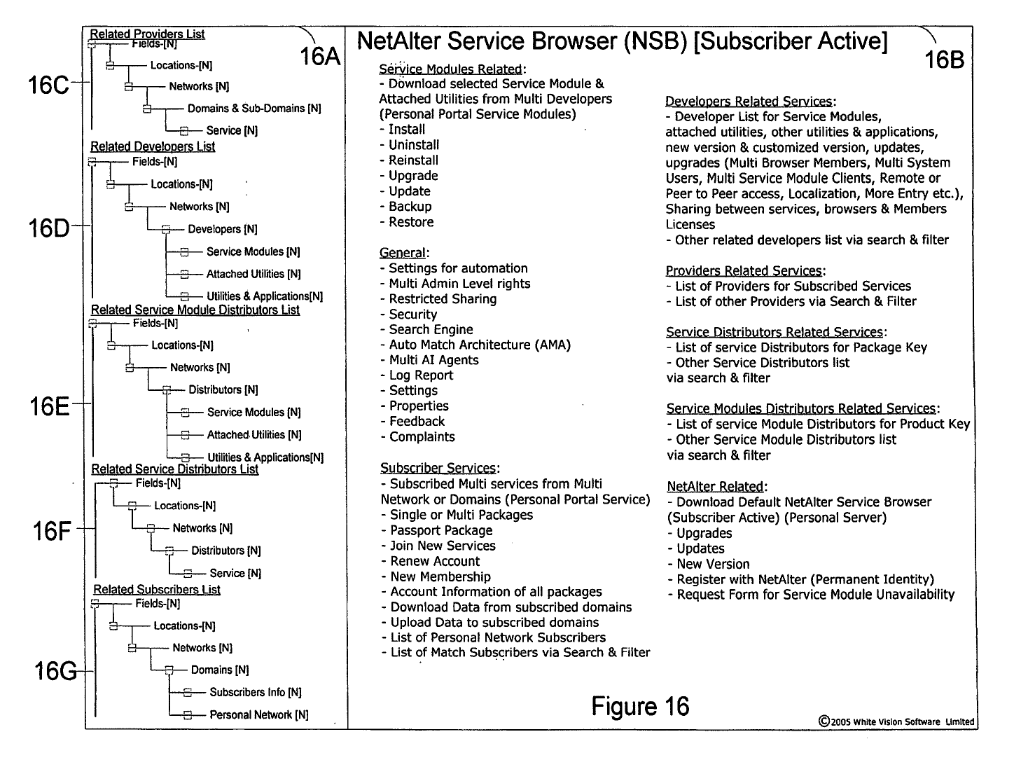

FIG. 16 shows a schematic block diagram of NetAlter Service Browser (Subscriber Active) and its functionality.

(16A) illustrates the Explorer aspect of NetAlter Service Browser (Subscriber Active) which list the in depth details of all the parties related to the Subscriber i.e. Providers, Developers, Subscribers, Distributors & NetAlter Controller.

(16C) shows the Explorer aspect of NetAlter Service Browser (Subscriber Active) which lists the in-depth details related to the NetAlter Service Providers that show the list of providers & its details in tree format the same be devised so that each higher attribute encircles the following one in a concentric encircled map. The explorer tree represents Fields followed by Location followed by Networks followed by Providers (Domains, sub-domains, branches). The explorer tree shows the details of Service provided by a NetAlter Service Provider to the subscriber, list of other related service provider found with the help of search & Filter.

(16D) illustrates the Explorer aspect of NetAlter Service Browser (Subscriber Active) which lists the in-depth details related to the NetAlter Service Module Developers that show the list of Developers & its details in tree format the same be devised so that each higher attribute encircles the following one in a concentric encircled map. The explorer tree represents Fields followed by Location followed by Networks followed by Developers. The explorer tree shows the details of Developers whose Service Modules, Attached Utilities, Other Utilities and Application are used by a service Subscriber, list of other related service module developers found with the help of search & Filter and more.

(16E) illustrates the Explorer aspect of NetAlter Service Browser (Subscriber Active) which lists the in-depth details related to the NetAlter Service Module Distributors that show the list of Service Module Distributors & its details in tree format the same be devised so that each higher attribute encircles the following one in a concentric encircled map. The explorer tree represents Fields followed by Location followed by Networks followed by Service Module Distributors. The explorer tree shows the details of Service Module Distributors from whom the service modules (Product Keys) are purchase by a Subscriber, list of other related service module distributors found with the help of search & Filter.

(16F) illustrates the Explorer aspect of NetAlter Service Browser (Subscriber Active) which lists the in-depth details related to the NetAlter Service Distributors that show the list of Service Distributors & its details in tree format the same be devised so that each higher attribute encircles the following one in a concentric encircled map. The explorer tree represents Fields followed by Location followed by Networks followed by Service Distributors. The explorer tree shows the details of Service Distributors from whom the services (Package Keys) are purchase by a Subscriber, list of other related service distributors found with the help of search & Filter.

(16G) illustrates the Explorer aspect of NetAlter Service Browser (Provider Active) which lists the in-depth details related to the NetAlter Service Subscriber that show the list of Subscribers & its details in tree format the same be devised so that each higher attribute encircles the following one in a concentric encircled map. The explorer tree represents Fields followed by Location followed by Networks followed by Subscribers. The explorer. tree shows the details of subscribers, details of services subscribed by subscriber, list of subscribers in the personal networks and list of subscribers found with the help of search & Filter.

(16B) illustrates the categorized functionality of NetAlter Service Browser (Subscriber Active) i.e. a) Service Module Related which includes Service Modules, Attached Utilities, Utilities & Applications, New Versions, Update, Upgrades and Resources to downloaded via FTP from multiple developers, details of Service Modules, Attached Utilities, Utilities & Applications, New Versions installed, reinstalled or uninstalled and more b) General which includes setting for automation, allowing sharing of data to the other with Subscriber restricted sharing permission, assigning admin rights to different users, use AMA & Search engine for searching & filtering required information, viewing the activity log reports of its subordinates, setting the security parameters and more, c) Subscriber Related Services includes list of services subscribed from the service provider, details of packages single or multiple & passport packages purchased, subscribed new services, renew current services, become member of new services, download data from & upload data to subscriber's personal network, list & details of other personal network with whom data are shared, maintain list of other personal network found with the help of search & Filter and more d) Developers Related Services which includes List of Service Module Developers whose Service Modules, Attached Utilities, Other Utilities & Applications, New Version & Customized version, Updates, Upgrades (Multi Browser Members, Multi System Users, Multi Service Module Clients, Remote or Peer to Peer access, Localization, More Entry etc.) are used by the subscriber, Obtain Licenses for Sharing between services, browsers & Members and Other related developers list via search & filter e) Providers Related Services includes List of Providers for Subscribed Services and List of other Providers via Search & Filter f) Service Distributors Related Services include List of service Distributors from whom Service Package Keys are purchased to subscribes the services and Other Service Distributors list via search & filter g) Service Modules Distributors Related Services include List of service Module Distributors from whom Product Keys are purchased to used the services modules and Other Service Module Distributors list via search & filter h) NetAlter Related include Download Default NetAlter Service Browser (Subscriber Active), obtain permission to create Personal Server, download Upgrades & Updates for browser, download New Version, Register with NetAlter for unique Permanent Identity, Use Request Form for the availability of New Services Modules which are Unavailable and more.

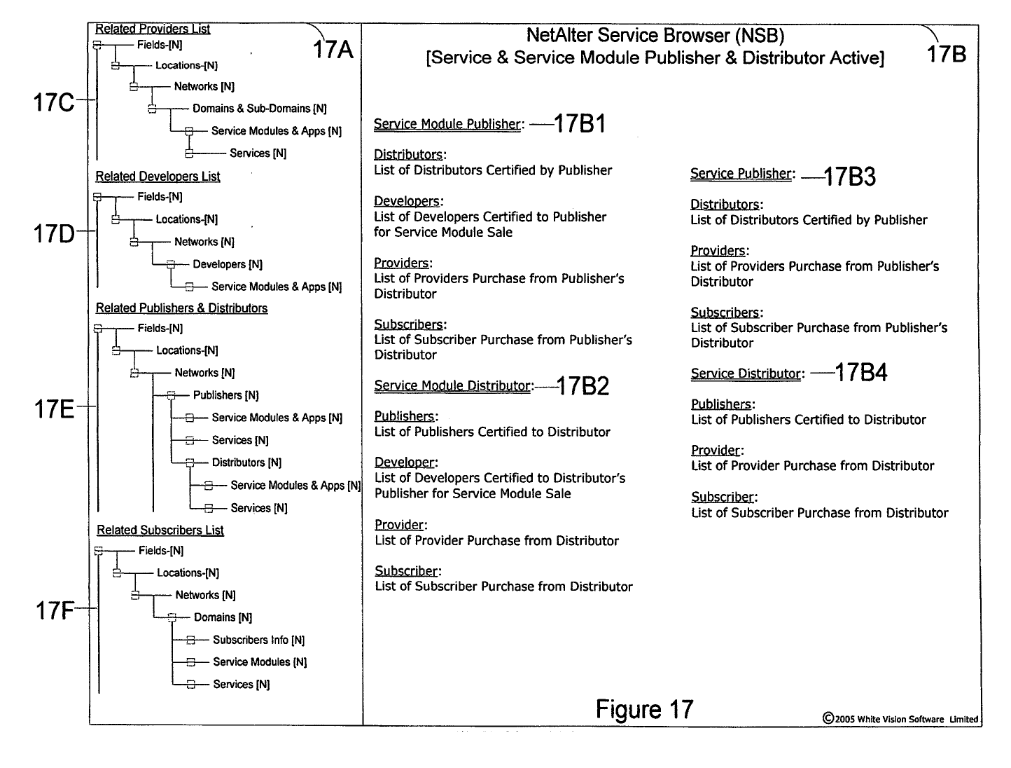

FIG. 17 shows a schematic block diagram of NetAlter Service Browser (Service & Service Module Publisher & Distributor Active) and its functionality.

(17A) illustrates the Explorer aspect of NetAlter Service Browser (Service & Service Module Publisher & Distributor Active) which list the in depth details of all the parties related to the Service & Service Module Publisher & Distributor i.e. Providers, Developers, Subscribers, Publishers, Distributors & NetAlter Controller.

(17C) illustrates the Explorer aspect of NetAlter Service Browser (Service & Service Module Publisher & Distributor Active) which lists the in-depth details related to the NetAlter Service Providers, which show list of providers, & its details in tree format the same be devised so that each higher attribute encircles the following one in a concentric encircled map. The explorer tree represents Fields followed by Location followed by Networks followed by Providers (Domains, sub-domains, branches). The explorer tree shows the details of Service provided by the providers whose services are published by the service publishers & distributed by the service distributors, list of providers to whom Services Modules, Utilities & Application (Product Keys) are sold by Module Distributors or Services (Package Keys) are sold by Service distributors, list of other related service provider found with the help of search & Filter.

(17D) illustrates the Explorer aspect of NetAlter Service Browser (Service & Service Module Publisher & Distributor Active) which lists the in-depth details related to the NetAlter Service Module Developers, which show the list of Developers, & its details in tree format the same be devised so that each higher attribute encircles the following one in a concentric encircled map. The explorer tree represents Fields followed by Location followed by Networks followed by Developers. The explorer tree show the details of Developers whose Service Modules, Attached Utilities, Other Utilities and Application are published by the Service Module Publishers & distributed by the Service Module Distributor, list of other related service module developers found with the help of search & Filter and more.

(17E) illustrates the Explorer aspect of NetAlter Service Browser (Service & Service Module Publisher & Distributor Active) which lists the in-depth details related to the NetAlter Service & Services Modules Publishers & Distributors which show the list of Service & Services Modules Publishers & Distributors & its details in tree format the same being devised so that each higher attribute encircles the following one in a concentric encircled map. The explorer tree represents Fields followed by Location followed by Networks followed by Service or Service Module Publishers followed by Service or Service Module Distributors. The explorer tree shows the details of Service Module Publishers authorized by a developer for publishing a service module developed by a developer or list of Service Publishers authorized by Service Providers to publish the services, list of other related services or service modules publishers found with the help of search & Filter, list of Service Module Distributors authorized by Service Module Publishers for distributing service modules developed by a developer or list of Service Distributors authorized by Service Publishers to publish the services, list of other related Service Distributors found with the help of search & Filter and more

(16G) illustrates the Explorer aspect of NetAlter Service Browser (Service & Service Module Publisher & Distributor Active) which lists the in-depth details related to the NetAlter Service Subscriber, which show the list of Subscribers, & its details in tree format the same be devised so that each higher attribute encircles the following one in a concentric encircled map. The explorer tree represents Fields followed by Location followed by Networks followed by Subscribers. The explorer tree shows the details of subscribers, services subscribed by subscribers, service modules purchased by the subscribers and list of subscribers found with the help of search & Filter.

(17B) illustrates the categorized functionality of NetAlter Service Browser (Service & Service Module Publisher & Distributor Active) i.e. related to Service Module Publishers, Service Module Distributors, Service Publishers and Service Distributors.

(17B1) illustrates the categorized functionality of NetAlter Service Browser for Service Module Publishers (Service Module Publisher Active) like related to Service Module Distributors which shows List of Service Module Distributors Certified by Service Module Publisher, related to Developers shows List of Service Module Developers who Certified to the Service Module Publishers for Service Module Sale, related to Providers which show the List of Providers who purchase product keys from Publisher's Distributor, related to Subscribers shows the List of Subscriber who purchase product keys from Service Module Publisher's Distributor

(17B2) show the categorized functionality of NetAlter Service Browser for Service Module Distributors (Service Module Distributor Active) like related to Publishers shows the List of Service Module Publishers who certified to Distributor, related to developer show the List of Service Module Developers who Certified to distributor's Publishers for Service Module Sale, related to Providers show the list of Providers who Purchased product keys from Service Module Distributor, related to Subscriber show the list of Subscriber who Purchased product keys from Service Module Distributor.

(17B3) illustrates the categorized functionality of NetAlter Service Browser for Service Publishers (Service Publisher Active) like related to Service Distributors which shows List of Service Distributors Certified by Service Publisher, related to Service Providers which show the List of Service Providers who purchase product keys from Service Publisher's Distributor, related to Subscribers shows the List of Subscriber who purchase product keys from Service Publisher's Distributors.

(17B4) illustrates the categorized functionality of NetAlter Service Browser for Service Distributors (Service Distributor Active) like related to Service Publishers shows the List of Service Publishers who certified to Service Distributor, related to Subscriber show the list of Subscriber who Purchased product keys from Service Distributor.

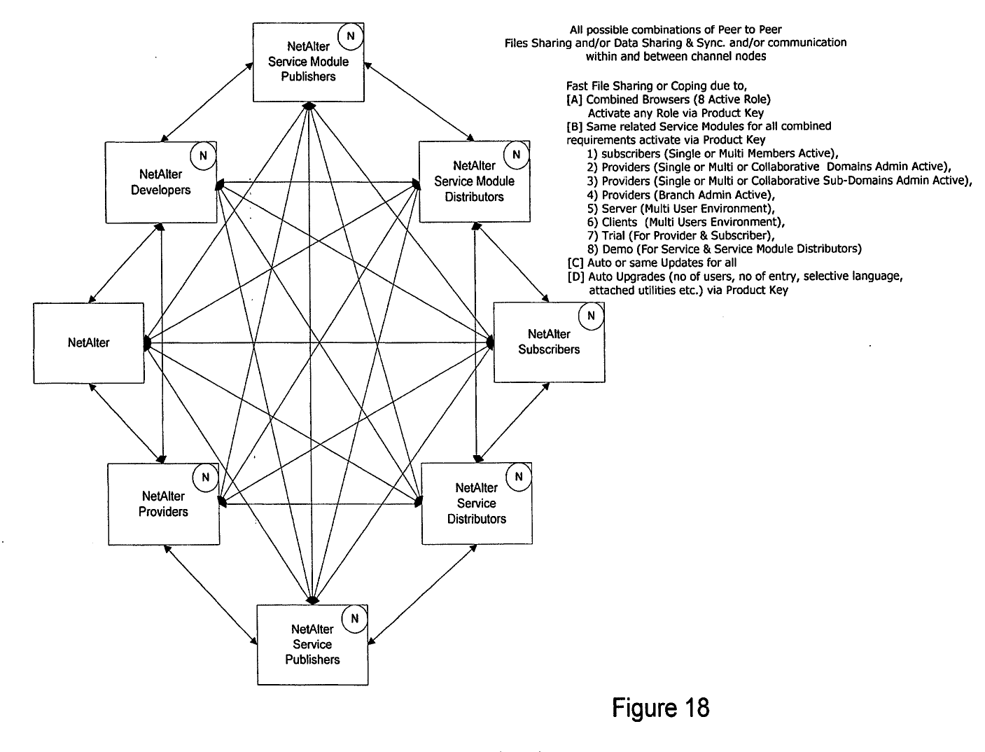

FIG. 18 show All possible combinations for Peer to Peer Files Sharing, Data Sharing & Synchronization, communications between all the parties of the NetAlter i.e. NetAlter Controller, Developer, Service Modules Publishers, Service Modules Distributors, Providers, Service Publishers, Service Distributors and Subscribers. Beside combination it also show the advantages Peer to Peer Files Sharing, Data Sharing & Synchronization, communications for the NetAlter Framework like it facilitates fast copying & sharing for a) combined browser having all the active roles, namely NetAlter Active, Developer Active, Service Module Publisher Active, Service Module Distributor Active, Provider Active, Service Publisher Active, Service Distributor Active and Subscriber Active, of NetAlter parties & which can be activated by product key.

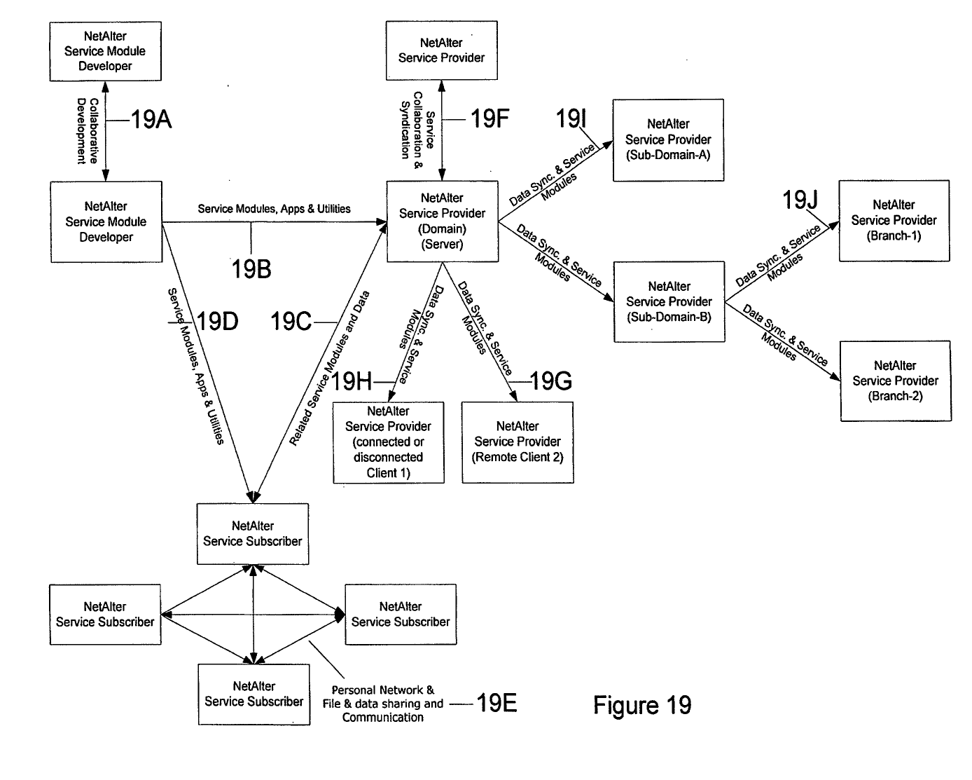

FIG. 19 show example of Peer to Peer Files Sharing, Data Sharing & Synchronization, communications between all the parties of the NetAlter namely NetAlter Controller, Developer, Service Modules Publishers, Service Modules Distributors, Providers, Service Publishers, Service Distributors and Subscribers. (19A) shows the peer to peer sharing & synchronization of data & files between the developers for collaborative development of service modules, utilities & Applications. (19B) show the peer to peer transfer of files i.e. Service Modules, Utilities & Applications from developer to Service Providers. (19C) show the peer to peer sharing & synchronization of data and sharing of files i.e. Service Modules, Utilities & Applications from Service Provider to Service Subscribers & Vice versa. (19D) show the peer to peer transfer of files i.e. Service Modules, Utilities & Applications from developer to Service Subscribers. (19E) show peer to peer sharing & synchronization of data and sharing of files i.e. Service Modules, Utilities & Applications between Service subscribers or between the members of Personal Network. (19F) show the peer to peer sharing & synchronization of data and sharing of files i.e. Service Modules, Utilities & Applications between Service Providers for service collaboration & syndication. (19G) show the peer to peer sharing & synchronization of data and sharing of files i.e. Service Modules, Utilities & Applications between Service Providers and its remote client for accessing data & files remotely. 19H) show the peer to peer sharing & synchronization of data and sharing of files i.e. Service Modules, Utilities & Applications between Service Providers and its local client connected or disconnected. (19I) show the peer to peer sharing & synchronization of data and sharing of files i.e. Service Modules, Utilities & Applications between Service Providers and its sub domains (19I) show the peer to peer sharing & synchronization of data and sharing of files i.e. Service Modules, Utilities & Applications between Service Provider's sub domain and its branches.

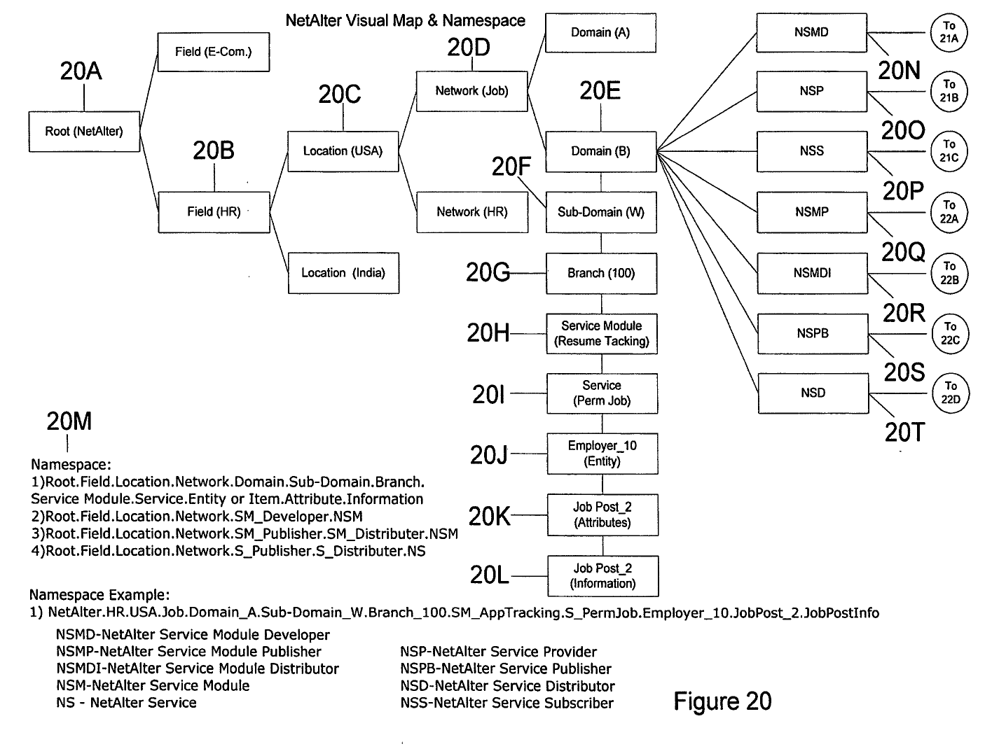

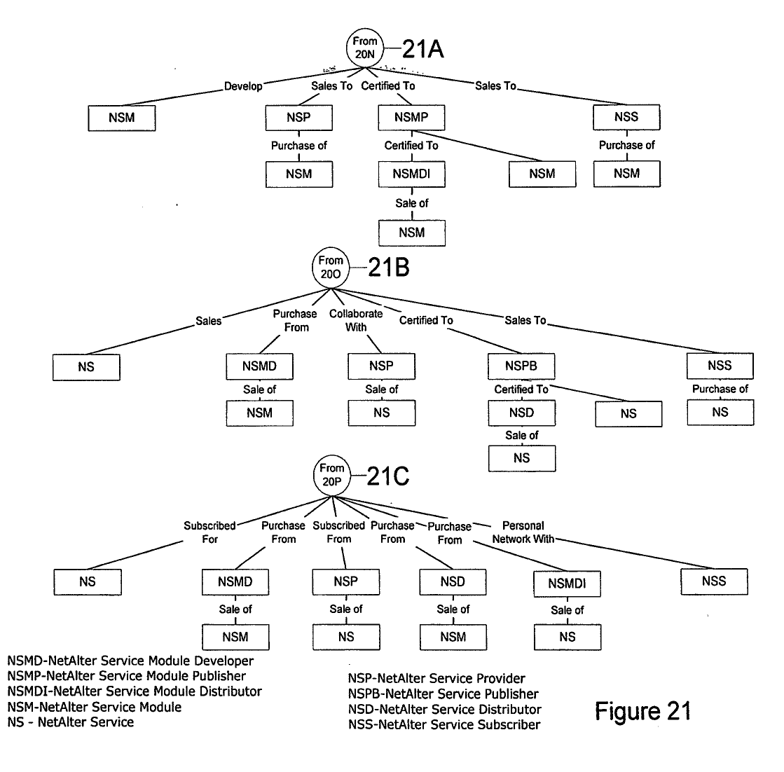

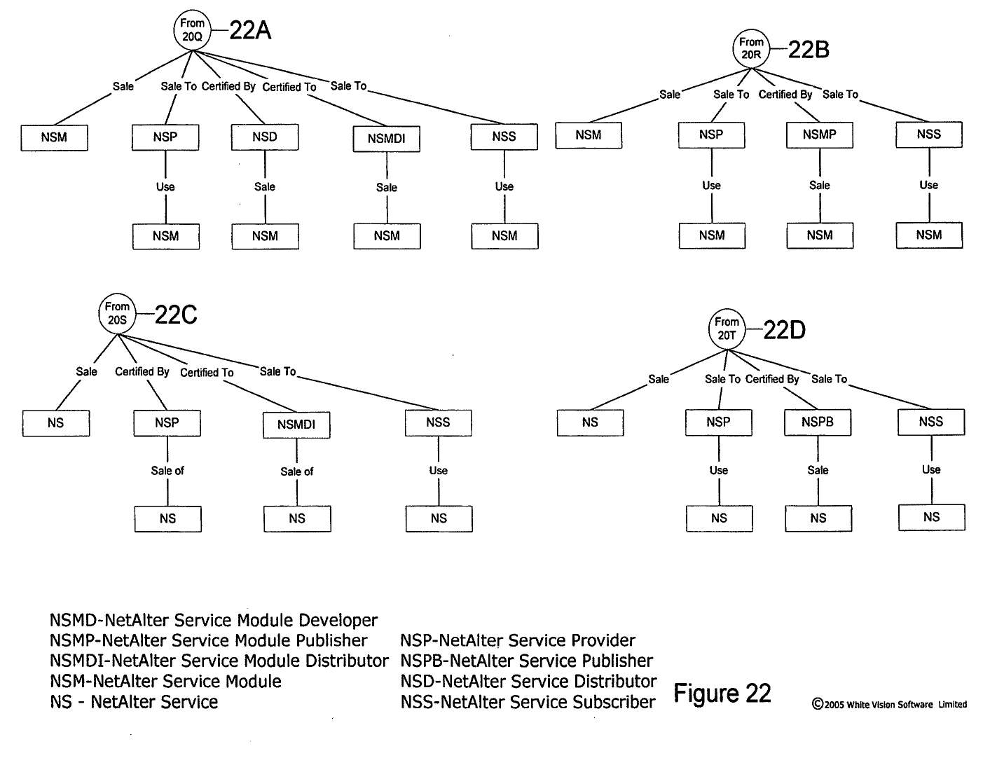

FIG. 20 illustrates the graphical overview of the NetAlter Visual Map and the method & example of (20M) NetAlter Namespace. The NetAlter Namespace is an unique identifier to identify each user within the NetAlter Framework and this identity made up of different optional parameters. There are different types NetAlter Namespace some of the example are (20M.1) For Provider & Subscriber, (20M.2) For Developer, (20M.3) For Service Module Publishers & Distributors and (20M.4) For Service Publishers & Distributors. All these NetAlter Namespaces consist of one or more optional parameter.

The first example of NetAlter Namespace shows NetAlter Namespace parameters for (20M.1) Providers & Subscribers are start with Root the first which indicate the top most node i.e. (20A) NetAlter itself The second parameter in NetAlter Namespace is Field which indicate the Subject Area say (20B) HR (Human Resource). The third parameter in the NetAlter Namespace is Location i.e. geographical area say (20C) USA. The fourth parameter in the NetAlter Namespace is Network i.e. topic of subject area say (20D) Job is topic for HR subject area. The fifth parameter in the NetAlter Namespace is Domain i.e. name to identify Service Provider say (20E) Domain B. The sixth parameter in the NetAlter Namespace is Sub Domain i.e. name to identify Service Provider's Sub-Domain say (20F) Sub Domain W. The seventh parameter in the NetAlter Namespace is Branch i.e. name to identify bottom most node in the Domain say (20G) Branch 100. The eighth parameter in the NetAlter Namespace is Service Module i.e. name to identify Service Module say (20H) Resume Tracking. The ninth parameter in the NetAlter Namespace is Service i.e. name to identify Service which is used or subscribed by the user i.e. subscriber say (20I) Permanent Job. The tenth parameter in the NetAlter Namespace is Entity or Item i.e. name to identify Service Subscriber who is using or subscribing the services say (20J) Employer. The eleventh parameter in the NetAlter Namespace is Attribute i.e. name to identify Service Subscriber's requirements who is using or subscribing the services say Employer's require service for (20K) Job Posting. The 12^{th} parameter in the NetAlter Namespace is Information used to indicate the information regarding Service Subscriber's requirements who is using or subscribing the services say Employer's provides (20L) Information for Job which they are Posting.

The second example of NetAlter Namespace shows NetAlter Namespace parameters for (20M.2) Developers are start with Root the first which indicate the top most node i.e. (20A) NetAlter itself. The second parameter in NetAlter Namespace is Field which indicate the Subject Area say (20B) HR (Human Resource). The third parameter in the NetAlter Namespace is Location i.e. geographical area say (20C) USA. The fourth parameter in the NetAlter Namespace is SM_Developer i.e. name or identity to identified service module developer. The fifth parameter in the NetAlter Namespace is ASM i.e. name or identity to identified NetAlter Service Module developed by service module developer.

The third example of NetAlter Namespace shows parameters for (20M.3) Service Module Publishers & Distributors are start with Root the first which indicate the top most node i.e. (20A) NetAlter itself The second parameter in NetAlter Namespace is Field which indicate the Subject Area say (20B) HR (Human Resource). The third parameter in the NetAlter Namespace is Location i.e. geographical area say (20C) USA. The fourth parameter in the NetAlter Namespace is (20Q) SM_Publishers i.e. name or identity to identified Service Module Publishers. The fifth parameter in the NetAlter Namespace is (20R) SM_Distributors i.e. name or identity to identified Service Module Distributors authorized by the Service Module Publishers to distribute the service modules. The sixth parameter in the NetAlter Namespace is (20H) ASM i.e. name or identity to identified (20H) NetAlter Service Module developed by service module developer.

The fourth example of NetAlter Namespace shows parameters for (20M.4) Service Publishers & Distributors are start with Root the first which indicate the top most node i.e. (20A) NetAlter itself The second parameter in NetAlter Namespace is Field which indicate the Subject Area say (20B) HR (Human Resource). The third parameter in the NetAlter Namespace is Location i.e. geographical area say (20C) USA. The fourth parameter in the NetAlter Namespace is (20S) S_Publishers i.e. name or identity to identified Service Publishers authorized by the (20O) Service Providers to publish the services. The fifth parameter in the NetAlter Namespace is (20T) S_Distributors i.e. name or identity to identified Service Distributors authorized by the Service Publishers to distribute the services. The sixth parameter in the NetAlter Namespace is AS i.e. name or identity to identified (20I)

NetAlter Service provided by service provider.

FIGS. 20,21,22 illustrates a logical block diagram of NetAlter Framework's Visual Map for management and Namespace to identify each item of NetAlter framework; the visual map a self stimulatory and also divulges relationships aspects of NetAlter members

FIGS. 21 & 22 illustrates the visual relationship map in different Namespace of NetAlter information and services flow, both illustrations form extension of information and services flow diagram from FIG. 20 which derives a namespace for a model NetAlter representation. The namespace derivation kick starts at the root (20A) i.e. NetAlter with further expanded collaterals based on NetAlter logical layer technology segregating the users in an organized manner. The similar visual relationship map forms a part of NetAlter service browsers so as to provide visual access to physical entities in the framework. FIGS. 21 & 22 specifically highlights protocol based relationship and transactional flow involved therein.

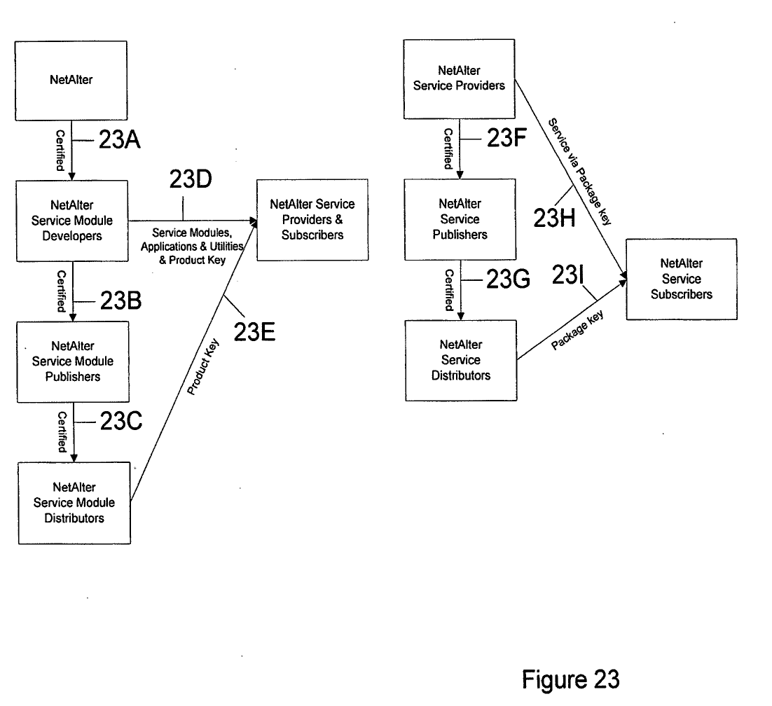

FIG. 23 illustrate a block diagrammatic representation of protocols being followed in the NetAlter framework building up process, 23A, 23B, 23C,23F, and 23G represents a protocol transferring entity by means of certification grant whereas 23D, 23E, 23H, 23I represents either product or package key delivery flow wherein rights being conferred on to the respective parties for successful service access.

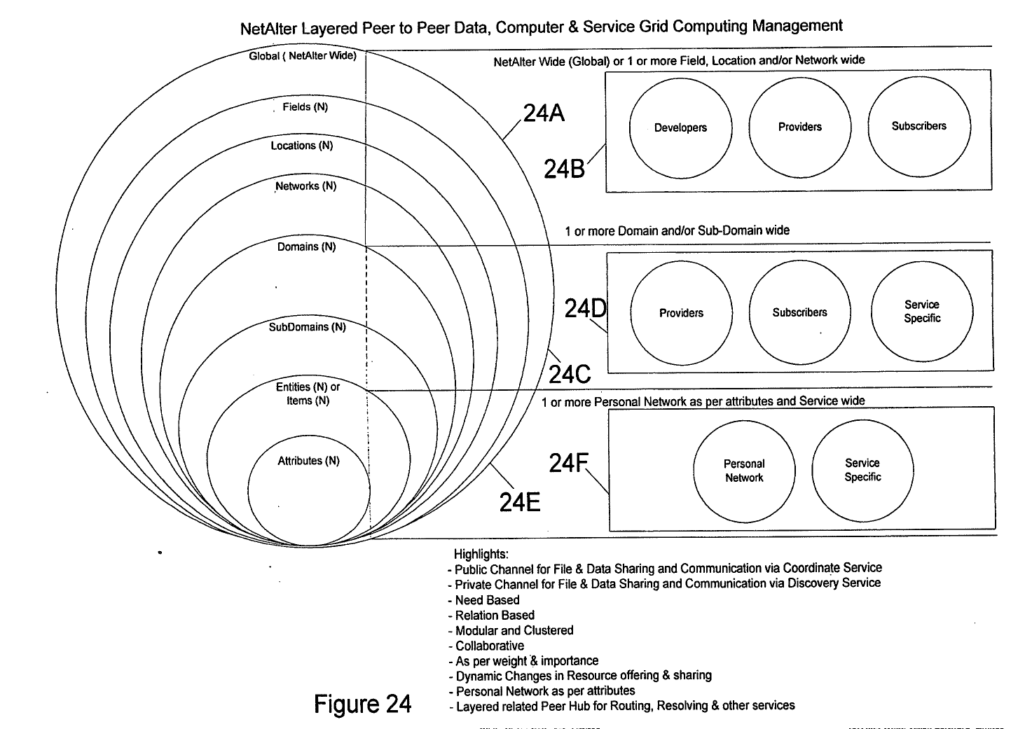

In an exceptionally significant embodiment of the present invention FIG. 24 illustrates a NetAlter layered, clustering based distributed grid logical picture. The layer approach has been explained in concentrically circular manner with one encircling the other, with layers following ranges from broader to narrower aspect in the grid, i.e. from global master controller NetAlter to subsequent further granular divisions till defining attributes of the entity helps derive NetAlter namespace in the nutshell.

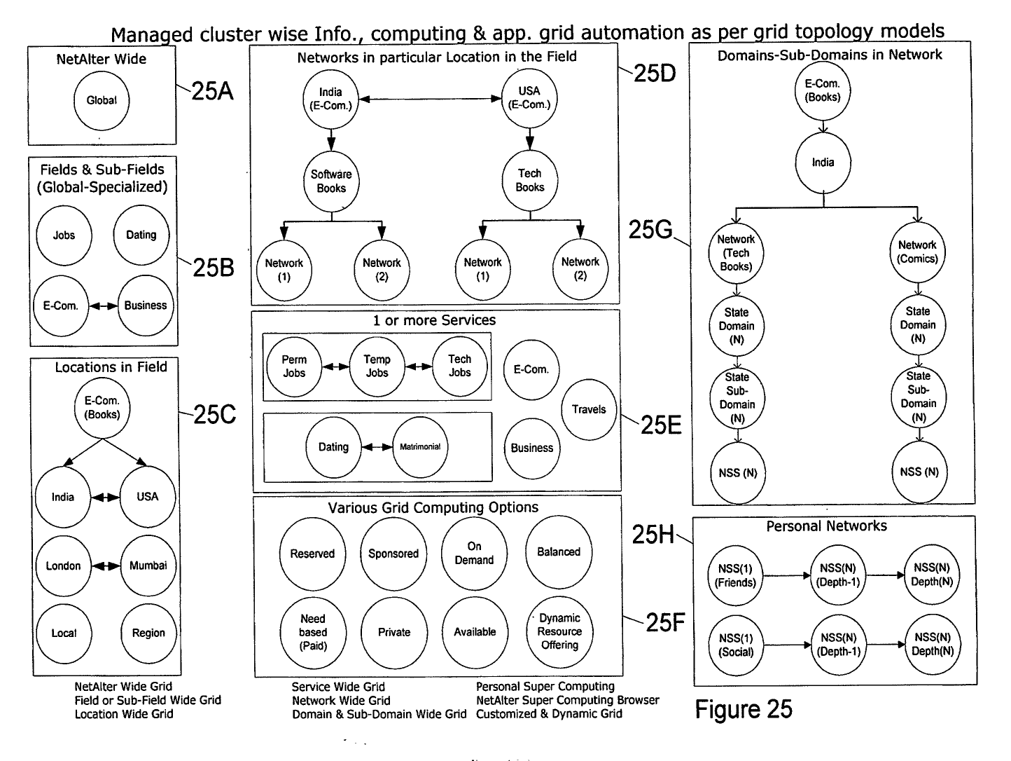

The computing grid framework and various options to render the same in practice are illustrated in FIG. 25, wherein at interlevel, intralevel, operations are relationship aspect is depicted along with grid formation topologies and models.

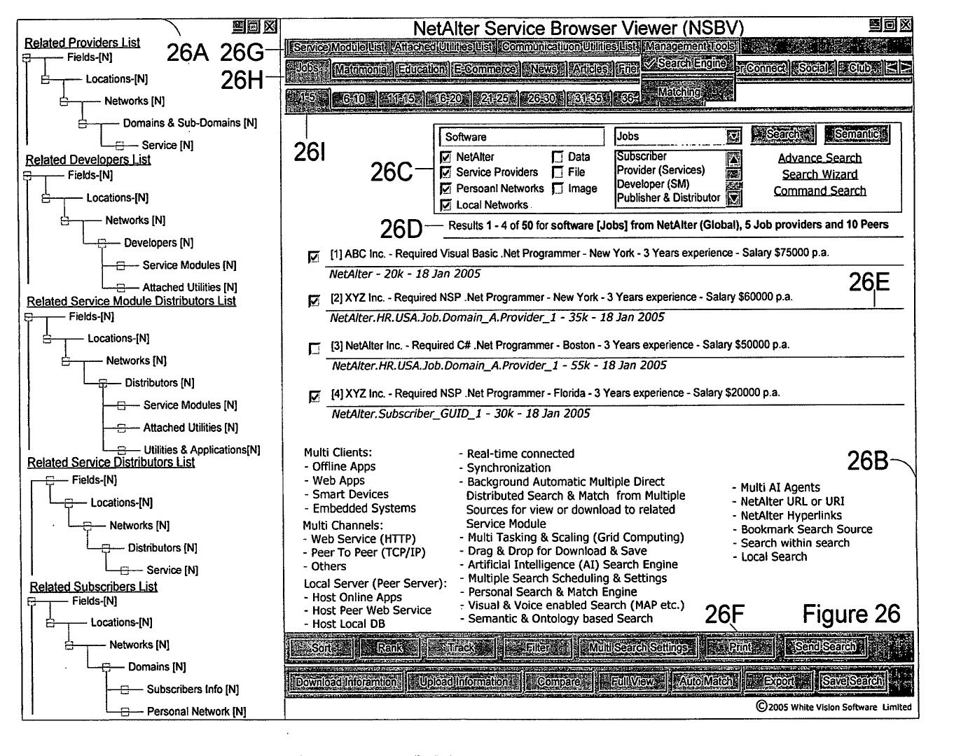

FIG. 26 showing graphical user interface (GUI) for NetAlter service browser viewer (NSBV) illustrating NetAlter search engine interface therein, GUI of NetAlter search engine being fully customizable as per requirements FIG. 26 showing plurality of functions the said search engine can perform. Section 26A shows the regular active rights specific explorer navigation tree structures, while section 26B shows the NetAlter service browser viewer containing search engine. NetAlter search engine employing plurality of search techniques to retrieval relevance and precision optimization conducting basic search, search wizard, advanced search, and command based search. 26G showing NetAlter Service Browser menu containing plurality of functions whereas 26H showing the subject specific search engines having selection enabled through plurality of tabs provided therein and same can be customized as per service subscribed by the user.

Section 26C of the search engine GUI illustrating basic search engines enabling selection of various searched parameters based on conditional search by means of plurality of Booleans logical combinations to improve upon search specificity in particular domain thus saving on time and network resources employed therein. Search can be conducted at four different granular levels including NetAlter, Service provider, personal Networks and local Networks, restricting search to specific domain, also plurality of information type is also specified therein i.e. data, file & image etc. As NetAlter employs cluster approach for improving on service orientation ground, same tool of clusters is used to limit the search to specific cluster of operation. The NetAlter search engine is enabled for tracking operations for plurality of channel nodes based on predefined specified criterions, expressed in terms of plurality of keywords with combinational Booleans logic involved therein. Also the said search engine employs subject specific semantic ontologies to improve upon precision and relevance of searched information into the NetAlter framework.

Further the search results are illustrated in Search engine GUI with 26I, 26D and 26E showing predefined (changeable) range of results, search status bar showing description of search result and actual annotated results, with its namespace appended therein respectively. The search engine GUI being designed handsomely functional illustrates plurality of functional buttons in section 26F to manipulate the search results thus obtained comprise of sort, rank, track, filter, multi search settings, print, send search, download information, upload information, compare, full view, auto match, export and save search options but not restricting to these functions only.

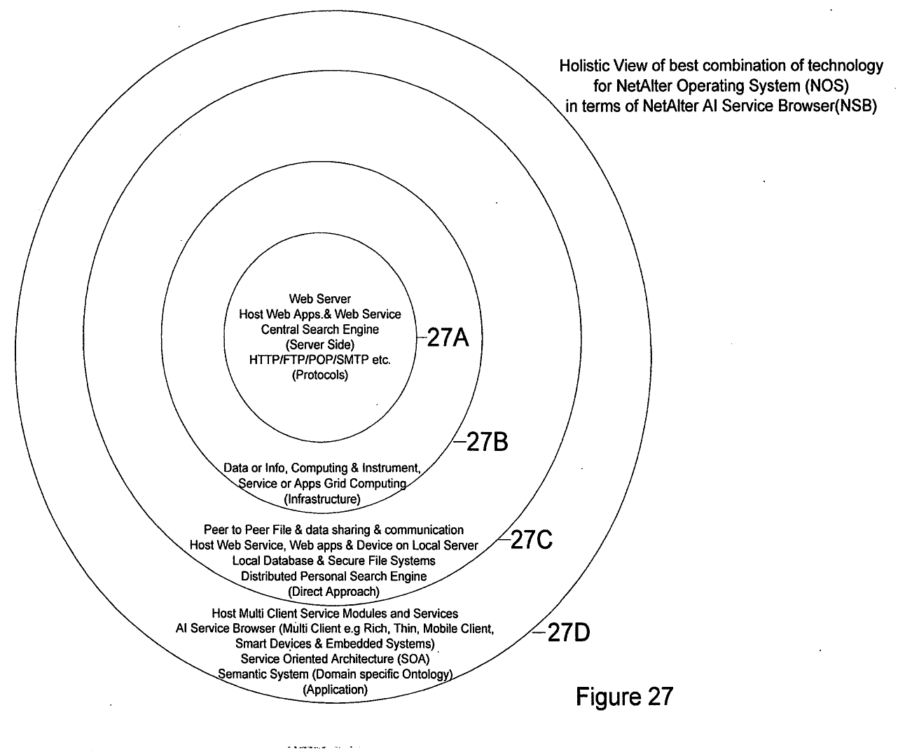

FIG. 27 illustrates layered diagram of NetAlter convergence platform. The four layers describing plurality of technologies integration with functionalities and communication standards. 27A being an innermost layer forms the base of NetAlter functioning includes plurality of communication standards, protocols and methods necessary for information transfer forming a unique operating platform for integration of all existing communication standards, protocols and methodologies and server side web apps, web services, & central search engine Computation being attracting significant concern the world-over, NetAlter devices a computational Grid formation acting as primary infrastructure layer illustrated by 27B. The Grid browser application when installed on client computer enable predefined percentage of computational resource utilization to NetAlter Grid members i.e. service browser subscribers, the computational locations being dynamically selected by means of algorithm used therein from the NetAlter framework. Third integrated layer 27C illustrates peer to peer enability of NetAlter for file & data sharing & communication, host web services, web apps and devices on local server, local databases and secure file system, distributed personal search engine. Fourth layer 27D being functional in nature applies to preceding communicating layers, the functions includes service browser application with multi-client (Rich, Thin, mobile, etc.) service modules and services running on smart devices and embedded systems providing semantically organized service oriented architecture.

We claim:

1. A method of customize, dynamic and unified social networking comprising:
registering users and store users profile and connections among users;
allow user to search, match & select one or more applications and services from presented list and attach, install or subscribe one or more applications and services from plurality of sources;
presenting privacy settings, presentation settings and configuration settings for said each attached, installed or subscribed one or more applications and services;
allowing to select and invite one or more connected users for creating social or personal network based on said each attached, installed or subscribed applications and services;
allowing said each selected or connected users of user for said each attached, installed or subscribed applications and services to select, attach, install or subscribe said each applications and services and join with related social or personal network;
creating social or personal network or join user to said social or personal network based on said each selected, attached, installed or subscribed application and service;
allowing each members of said each social or personal networks to communicate and share user data with each other based on said one or more selected, attached, installed or subscribed applications and services;
storing, indexing and processing said each application data of social or personal network of each user at the central unit; and
allowing users to submit one or more search query for searching one or more applications data of social or personal network of one or more connected users of user based on privacy settings.

2. The method according to claim 1, wherein allowing user to search applications and services from plurality of sources based on one or more search criteria.

3. The method according to claim 1, wherein said presenting list comprising: presenting survey to user for providing preferences and details and presenting list of applications and services from plurality of sources based on said survey data to user.

4. The method according to claim 1, wherein user can connect or disconnect from said one or more social or personal networks.

5. The method according to claim 1, wherein user can invite or block one or more other connected and related users of the social or personal network(s).

6. The method according to claim 1, wherein allow user to install, uninstall, subscribe, unsubscribe, update, upgrade, apply sharing privacy settings to one or more installed applications and subscribed services, share application or social or personal network data, logs, create, remove and join one or more personal or social networks, block one or more members of one or more personal or social networks, search, match and sort, filter, track, rank, save, share, synchronize, and compare one or more applications or social or personal network specific data of one or more connected users of user.

7. A system of customize, dynamic and unified social networking comprising:
a user, wherein said user is configure to register with and store user profile and user connections to central unit, to search, match & select one or more applications and services from presented list and attach, install or subscribe one or more applications and services from plurality of sources, to set, update & apply privacy settings, presentation settings and configuration settings for said each attached, installed or subscribed one or more applications and services, to select and invite one or more connected users for creating social or personal network based on said each attached, installed or subscribed applications and services;
a central unit, wherein the central unit is configure to register users and store users profile and connections among users, to present privacy settings, presentation settings and configuration settings for said each attached, installed or subscribed one or more applications and services, to create social or personal network or join user to said social or personal network based on said each selected, attached, installed or subscribed application and service, to allow each members of said each social or personal networks to communicate and share user data with each other based on said one or more selected, attached, installed or subscribed applications and services, to store, index and process said each application data of social or personal network of each user at the central unit, to allow users to submit one or more search query for searching one or more applications data of social or personal network of one or more connected users of user based on privacy settings; and
connected users of said user, wherein the connected users are configured to select, attach, install or subscribe said user attached, installed or subscribed each applications and services and join with related social or personal network.

8. The system according to claim 7, wherein user is enabled to search applications and services from plurality of sources based on one or more search criteria.

9. The system according to claim 7, wherein said presented list comprising: present survey to user for providing preferences and details and present list of applications and services from plurality of sources based on said survey data to user.

10. The system according to claim 7, wherein user is configured to connect or disconnect from said one or more social or personal networks.

11. The system according to claim 7, wherein user is adapted to invite or block one or more other connected and related users of the social or personal network(s).

12. The system according to claim 7, wherein user is configured to install, uninstall, subscribe, unsubscribe, update, upgrade, apply sharing privacy settings to one or more installed applications and subscribed services, share application or social or personal network data, logs, create, remove and join one or more personal or social networks, block one or more members of one or more personal or social networks, search, match and sort, filter, track, rank, save, share, synchronize, and compare one or more applications or social or personal network specific data of one or more connected users of user.
